(19) United States
(12) Patent Application Publication
(10) Pub. No.: US 2008/0165313 A1
(43) Pub. Date: Jul. 10, 2008

(54) Method For Producing Cellulose Acylate Film, Cellulose Acylate Film, Retardation Film, Polarizing Plate and Liquid Crystal Display

(75) Inventors: Hidenori Hayashi, Kanagawa (JP); Keiichi Taguchi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/885,753

(22) PCT Filed: Mar. 10, 2006
(86) PCT No.: PCT/JP2006/305297

§ 371 Date: Sep. 6, 2007

(30) Foreign Application Priority Data
Mar. 10, 2005 (JP) 2005-067904
Aug. 4, 2005 (JP) 2005-226791
Dec. 19, 2005 (JP) 2005-365123

(51) Int. Cl. G02B 1/04; B29D 11/00; G02F 1/1335

(52) U.S. Cl. 349/117; 264/1.34; 428/1.31

(57) ABSTRACT

A method for producing a cellulose acylate film is provided and includes: casting a cellulose acylate solution onto a support to form a cellulose acylate film; peeling the cellulose acylate film from the support; and stretching the cellulose acylate film, the cellulose acylate film in the stretching having a temperature of 140 to 250° C.

### TECHNICAL FIELD

The present invention relates to a method for producing a cellulose acylate film, a cellulose acylate film, a retardation film, a polarizing plate and a liquid crystal display.

### BACKGROUND ART

A liquid crystal display is being widely used in monitors for personal computers and mobile devices and in TV sets due to its various advantages such as that it can be driven at a low voltage with a low consumptive electric power and that it permits reduction of size and thickness of them. As such liquid crystal display, various mode devices have been proposed which are different in the alignment state of liquid crystal within a liquid crystal cell. A TN-mode liquid crystal has conventionally been mainly employed wherein the liquid crystal is in an alignment of being twisted about 90° in the direction of from the lower side substrate toward the upper side substrate of a liquid crystal cell.

Generally, a liquid crystal display includes a liquid crystal cell, an optical compensatory sheet and a polarizer. The optical compensatory sheet is used for removing coloration of image and for enlarging the viewing angle, and a stretched birefringent film or transparent film having coated thereon liquid crystal is used as the optical compensatory sheet. For example, Japanese Patent No. 2587398 discloses a technique of enlarging the viewing angle by applying to a liquid crystal cell of TN mode an optical compensatory sheet prepared by coating discotic liquid crystal on a triacetyl cellulose film, orienting and fixing the oriented alignment of the liquid crystal. However, a liquid crystal display for use in a large-sized TV set which is desired to be viewed at various angles is required to have such a small dependence upon viewing angle that even the above-mentioned technique fails to meet the requirement. Thus, liquid crystal displays of modes different from the TN mode, such as IPS (In-Plane Switching) mode, OCB (Optically Compensatory Bend) mode and VA (Vertically Aligned) mode, have been investigated. In particular, VA mode liquid crystal displays capable of providing a high contrast and permitting to produce with a comparatively high yield have been noted as liquid crystal displays for a TV set.

In comparison with other polymer films, a cellulose acetate film has a characteristic of having a high optical isotropy (a low retardation value). Therefore, the cellulose acetate film is commonly used for uses requiring optical isotropy, such as a polarizing plate. JP-A-2000-131524 discloses a process for producing a cellulose acetate film having a less amount of insolubles and having a high transparency by specifying the relation between the viscosity-average polymerization degree of cellulose acetate and the viscosity of a dope obtained by dissolving it in a solvent. Also, JP-A-2001-129838 discloses a preferred relation among thickness d of a cellulose acetate film, concentration y(%) of solid components in the solution for forming a cellulose acetate film and viscosity ρ of the solution in order to dissolve surface troubles called die streak.

On the other hand, an optical compensatory sheet (retardation film) for a liquid crystal display conversely requires an optical anisotropy (a high retardation value). In particular, an optical compensatory sheet for VA mode requires a in-plane retardation (Re) of from 30 to 200 nm and a retardation in the thickness direction (Rth) of from 70 to 400 nm. Thus, as the optical compensatory sheet, synthetic polymer films having a high retardation value, such as a polycarbonate film or a polysulfone film, have been commonly used.

As is described above, in the technical field of optical materials, it has been a general principle that, in the case where an optical anisotropy (high retardation value, (Re and Rth)) is required for a polymer, a synthetic polymer is used whereas, when an optical isotropy (low retardation values) is required, a cellulose acetate film is used.

EP-A-911656 discloses a cellulose acetate film having an enough high retardation value to be used for uses requiring an optical anisotropy, with exploding the conventional general principle. In the patent, an aromatic compound having at least 2 aromatic rings, particularly a 1,3,5-triazine rings is added, and the formed film is stretched, thus realizing a high retardation value with a cellulose triacetate film.

It is generally known that cellulose triacetate is a high polymer material which is difficult to stretch and that a high birefringent index is difficult to obtain. However, it has been made possible to enhance birefringent index by simultaneously orienting the additive upon stretching treatment, thus realizing high retardation values (Re, Rth). Since this film can also function as a protective film for a polarizing plate, it has the advantage of providing an inexpensive and thin liquid crystal display. Thus, the method described in the above-mentioned documents is advantageous in that it can provide an inexpensive and thin liquid crystal display.

On the other hand, with further reduction in thickness of a liquid crystal display, members constituting a polarizing plate are required to have a smaller thickness. Also, it is required to further reduce the production cost of the members constituting the polarizing plate. In order to meet these requirements, a film having an increased retardation has been required. In order to increase retardation, there can be considered means such as increasing the amount of a retardation increasing agent or raising stretching ratio. However, use of an increased amount of a retardation increasing agent would lead to precipitation of the retardation increasing agent from the resulting film or to an increased production cost. The other means to raise stretching ratio requires to raise the stretching temperature. However, when the stretching temperature is raised, there arises such a large influence of thermal relaxation that the retardation increasing properties are reduced. Thus, it has been difficult to reduce the thickness of the film while maintaining retardation at a definite level.

Further, liquid crystal displays are being often used in various environments and, under some environment, the cellulose ester film obtained according to the above-mentioned technique involves the problem that it suffers change in its optical compensatory function.

Also, there has been involved the problem that, when the cellulose acetate film has a high haze value, there arises disappearance of polarization, leading to reduction in frontal contrast of the liquid crystal display.

Thus, dissolution of these problems has been demanded.

### DISCLOSURE OF THE INVENTION

An object of the present invention is to provide a method for producing a cellulose acylate film, which permits reduction in thickness of the film, has excellent optical characteristics and a low haze value, and undergoes less change in optical characteristics when environmental humidity changes; to provide a cellulose acylate film obtained by employing the method, a retardation film using the film and a polarizing plate using the film; and to provide a retardation film undergoing less change in tint, a polarizing plate and a liquid crystal display using them.

1) A method for producing a cellulose acylate film, comprising: casting a cellulose acylate solution onto a support to form a cellulose acylate film; peeling the cellulose acylate film from the support; and stretching the cellulose acylate film, wherein the cellulose acylate film in the stretching has a temperature of 140 to 250° C.
2) The method for producing a cellulose acylate film as described in 1), wherein an amount of a solvent remaining in the cellulose acylate film upon initiation of the stretching is from 0 to 30 mass % (weight %).
3) The process for producing a cellulose acylate film as described in 1) or 2), wherein the stretching is performed at a stretch ratio of from 1.01:1 to 3:1.
4) A cellulose acylate film produced by a method for producing a cellulose acylate film described in any one of 1) to 3).
5) The cellulose acylate film as described in 4), which satisfies:

40≦Re₍₅₉₀₎≦200; and

70≦Rth₍₅₉₀₎≦350,

wherein Re_{(λ)} represents a retardation in a plane of the cellulose acylate film (i.e., an in-plane retardation) at wavelength λ; Rth_{(λ)} represents a retardation in a direction perpendicular to the plane (i.e., a retardation in the thickness direction) at wavelength λ.
6) The cellulose acylate film as described in 4) or 5), which has a water content of from 0 to 2.8 mass % after being conditioned at 25° C. and 80% RH for 2 hours.
7) The cellulose acylate film as described in any one of 4) to 6), which satisfies formulae (V) and (VI):

0<(Re₍₅₉₀₎10% RH−Re₍₅₉₀₎80% RH)×100/Re₍₅₉₀₎60% RH<20 (V)

0<(Rth₍₅₉₀₎10% RH−Rth₍₅₉₀₎80% RH)×100/Rth₍₅₉₀₎60% RH<20 (VI)

wherein Re₍₅₉₀₎10% RH, Re₍₅₉₀₎60% RH and Re₍₅₉₀₎80% RH represent Re₍₅₉₀₎ at 25° C. and 10% RH, Re₍₅₉₀₎ at 25° C. and 60% RH and Re₍₅₉₀₎ at 25° C. and 80% RH, respectively; Rth₍₅₉₀₎10% RH, Rth₍₅₉₀₎60% RH and Rth₍₅₉₀₎80% RH represent Rth₍₅₉₀₎ at 25° C. and 10% RH, Rth₍₅₉₀₎ at 25° C. and 60% RH and Rth₍₅₉₀₎ at 25° C. and 80% RH, respectively; and Re_{(λ)} represents a retardation in a plane of the cellulose acylate film at wavelength λ, and Rth_{(λ)} represents a retardation in a direction perpendicular to the plane at wavelength λ.
8). The cellulose acylate film as described in any one of 4) to 7), which has a haze value of from 0 to 1.0%.
9) The cellulose acylate film as described in any one of 4) to 8), which comprises a mixed fatty acid ester of cellulose in which a hydroxyl group of the cellulose is substituted with an acetyl group or an acyl group containing 3 or more carbon atoms, the cellulose acylate film satisfying formulae (I) and (II):

2.0≦A+B≦3.0 (I)

0≦B (II)

wherein A represents a substitution degree of the hydroxyl group by the acetyl group, and B represents a substitution degree of the hydroxyl group by the acetyl group containing 3 or more carbon atoms.
10) The cellulose acylate film as described in 9), wherein the acyl group is a butanoyl group.
11) The cellulose acylate film as described in 9), wherein the acyl group is a propionyl group, and wherein the substitution degree B is 0.6 or more.
12) The cellulose acylate film as described in 9), which comprises cellulose acylate in which a hydroxyl group of a glucose unit in the cellulose acylate is substituted with an acyl group containing 2 or more carbon atoms, the cellulose acylate film satisfying formulae (III) and (IV):

2.0≦DS2+DS3+DS6≦2.85 (III)

DS6/(DS2+DS3+DS6)≧0.315 (IV)

wherein DS2 represents a substitution degree of the hydroxyl group at 2-position of the glucose unit by the acyl group, DS3 represents the substitution degree of hydroxyl group at 3-position of the glucose unit by the acyl group, and DS6 represents a substitution degree of the hydroxyl group at 6-position of the glucose unit by the acyl group.
13) The cellulose acylate film as described in any one of 4) to 11), which contains at least one retardation increasing agent.
14) The cellulose acylate film as described in any one of 4) to 13), which has a content of the retardation increasing agent of from 0 mass % to 10 mass % with respect to the cellulose acylate of 100 mass %.
15) The cellulose acylate film as described in any one of 4) to 14), which contains at least one of a plasticizer, a UV absorber and a peeling accelerator.
16) The cellulose acylate film as described in any one of 4) to 15), which has a thickness of from 20 to 110 μm.
17) A retardation film comprising a cellulose acylate film described in any one of 4) to 16).
18) A polarizing plate, wherein at least one cellulose acylate film described in any one of 4) to 16) is used as a protective film for a polarizer.
19) The polarizing plate as described in 18), comprising at least one layer of a hard coat layer, a glare-reducing layer and an antireflection layer, the at least layer being between the protective film and a liquid crystal cell.
20) The polarizing plate as described in 18) or 19), which is packaged in a moisture-proofed bag having an inner humidity of 43% RH to 70% RH at 25° C.
21) The polarizing plate as described in any one of 18) to 20), which is packaged in a moisture-proofed bag having an inner humidity within 15% RH with respect to an ambient humidity in sticking the polarizing plate to a liquid crystal panel.
22) A liquid crystal display comprising at least one cellulose acylate film described in any one of 4) to 16) or at least one polarizing plate described in any one of 18) to 21).
23) A liquid crystal display of VA mode comprising at least one cellulose acylate film described in any one of 4) to 16) or at least one polarizing plate described in any one of 18) to 21).
24) A liquid crystal display of VA mode comprising only one cellulose acylate film described in any one of 4) to 16) or only one polarizing plate described in any one of 18) to 21).
25) A liquid crystal display of VA mode comprising at least one cellulose acylate film described in any one of 4) to 16) or at least one polarizing plate described in any one of 18) to 21) between a liquid crystal cell and a backlight.

The invention can provide a method for producing a cellulose acylate film, which permits reduction in thickness of the film, has excellent optical characteristics and a low haze value, and undergoes less change in optical characteristics when environmental humidity changes; to provide a cellulose acylate film obtained by employing the method, a retardation film using the film and a polarizing plate using the film; and to provide a retardation film undergoing less change in tint, a polarizing plate and a liquid crystal display using them.

### BRIEF DESCRIPTION OF THE DRAWINGS

FIG. 1 is a schematic view showing an illustrative, non-limiting embodiment of the method of sticking a cellulose acylate film in producing a polarizing plate of the invention.

FIG. 2 is a cross-sectional view schematically showing the cross-sectional structure of an illustrative, non-limiting embodiment of a polarizing plate of the invention.

FIG. 3 is a cross-sectional view schematically showing the cross-sectional structure of an illustrative, non-limiting embodiment of a liquid crystal display of the invention.

### DETAILED DESCRIPTION OF THE INVENTION

Exemplary embodiments of the invention will be described in detail below.

In the invention, a cellulose acylate solution is cast onto a support to form a cellulose acylate film, and the cellulose acylate film peeled from the support is stretched, with the film temperature in the stretching step being adjusted to be 140 to 250° C.

Retardation of the cellulose acylate film can be adjusted by the stretching treatment according to the invention. Further, there are methods of positively stretching in the transverse direction as described in, for example, JP-A-62-115035, JP-A-4-152125, JP-A-4-284211, JP-A-4-298310 and JP-A-11-48271.

Also, stretching of the film may be uniaxial stretching in the longitudinal or transverse direction or may be simultaneous or sequential biaxial stretching. Stretching is performed at a stretching ratio of from 1.01:1 to 3:1, more preferably from 1.15:1 to 2.8:1, particularly preferably from 1.30:1 to 2.6:1. Stretching at a stretching ratio of 3:1 or more involves the danger of film breakage even when stretching is conducted at an elevated temperature, thus not being preferred. Stretching treatment may be performed in the course of the film-forming step, or a raw film formed and wound may be stretched. Preferably, stretching is performed in the course of the film-forming step.

The invention is characterized in that stretching of a cellulose acylate film is performed at a temperature of the cellulose acylate film of from 140° C. to 250° C., preferably from 140° C. to 230° C., more preferably from 140° C. to 220° C. A temperature of 140° C. or lower is too low as a stretching temperature to conduct stretching at a high stretching ratio, thus a high retardation not being obtained and reduction in film thickness being impossible. Also, stretching at a temperature of 250° C. or higher would cause progress of decomposition of cellulose acylate and additives, thus not being preferred.

Usually, stretching at a high temperature as in a method of the invention causes thermal relaxation of cellulose acylate chain, which can result in reduction of retardation. However, when the cellulose acylate film is in a state wherein many knot points exist, cellulose acylate chains are fixed to each other and the film is difficulty affected by thermal relaxation, thus reduction of retardation being avoided. The knot point is a fine crystalline portion contained in the cellulose acylate film, where cellulose acylate chains gather.

As a method for increasing the number of knot points in the film, various methods may be employed which can realize a state wherein cellulose acylate chains gather. For example, there may be illustrated a method of changing stretching conditions, for example, adjusting the residual amount of a solvent upon initiation of stretching; a method of changing the molecular structure of cellulose acylate; and a method of adding an additive. Of these, a method of stretching in the region where the residual amount of a solvent is small is preferred. Stretching can be conducted when the residual amount of a solvent upon initiation of stretching is preferably from 0 to 30 mass %, more preferably from 0 to 25 mass %, particularly preferably from 0 to 15 mass %. The residual amount of a solvent contained in the film upon initiation of stretching can be changed by adjusting the process conditions such as temperature, humidity and amount of air upon casting the cellulose acylate solution.

Further, it is preferred to more stretch the film in the transverse direction because a polarizing plate can be processed in a roll-to-roll manner.

### (Optical Properties of Cellulose Acylate Film)

Optical properties, i.e., Re retardation value and Rth retardation value, of a cellulose acylate film of the invention satisfy the following formulae (V) and (VI):

40 nm≦Re₍₅₉₀₎≦200 nm (V)

70 nm≦Rth₍₅₉₀₎≦350 nm (VI)

wherein Re_{(λ)} represents an in-plane retardation (unit: nm) at a wavelength of λnm, and Rth_{(λ)} represents a retardation in the thickness thickness (unit: nm) at a wavelength of λnm.

The retardation value Re_{(λ)} can be measured by irradiating with an incident light of λnm in wavelength in the normal direction of the film using KOBRA 21ADH (manufactured by Ohji Measurement Co., Ltd.). Also, Rth_{(λ)} can be calculated by KOBRA 21ADH based on retardation values measured in three directions, i.e., the aforementioned Re_{(λ)} a retardation value measured by irradiating with an incident light of λnm in wavelength in the direction inclined at an angle of +40° from the normal line of the film with taking the slow axis in plane (determined by KOBRA 21ADH) as an inclination axis (rotation axis), and a retardation value measured by irradiating with an incident light of λnm in wavelength in the direction inclined at an angle of −40° from the normal line of the film with taking the slow axis in plane as an inclination axis. Re_{(λ)} and Rth_{(λ)} were calculated by imputing an assumed value of average refractive index of 1.48 and the thickness of the film.

More preferably, the retardation values satisfy the following formulae (VII) and (VII):

50 nm≦Re₍₅₉₀₎≦100 nm (VII)

160 nm≦Rth₍₅₉₀₎≦300 nm (VIII)

A cellulose acylate film having such Re and Rth can improve displaying performance of a liquid crystal display.

Fluctuation of the Re value in the transverse direction is preferably ±5 nm, more preferably ±3 nm. Also, fluctuation of the Rth value is preferably ±10 nm, more preferably ±5 nm. Further, fluctuation of the Re value and the Rth value in the longitudinal direction is preferably within the fluctuation in the transverse direction.

Change in displaying performance of a liquid crystal display accompanying change in humidity depends upon change in Re and Rth accompanying change in the water content of a film on the cell side rather than a polarizer. In order to depress the change in displaying performance, reduction of the water content was successfully realized, which leads to reduction in change of Re and Rth accompanying change in the water content.

A cellulose acylate film of the invention has many knot points in the film, because it has been stretched at a high temperature in a state of containing a less amount of volatile components. The increased knot points in the film serve to strengthen knot between cellulose acylate chains, leading to reduction in the amount of water invading between the cellulose acylate chains. The water content of the film is preferably from 0 to 2.8 mass %, more preferably from 0 to 2.4 mass %, particularly preferably from 0 to 1.5 mass %.

Although a cellulose acylate film suffers change in Re and Rth values according to change in humidity, the change is preferably depressed at a level as small as possible. In order to reduce change in optical characteristics by humidity, there is a technique of using cellulose acylate having a large acyl substitution degree at 6-position and various hydrophobic additives (e.g., a plasticizer, a retardation increasing agent and a UV absorber) other than to increase the number of knot points. A cellulose acylate film of the invention preferably satisfies the following formulae (A) and (B);

0<(Re₍₅₉₀₎10% RH−Re₍₅₉₀₎80% RH)×100/Re₍₅₉₀₎60% RH<20; (A)

0<(Rth₍₅₉₀₎10% RH−Rth₍₅₉₀₎80% RH)×100/Rth₍₅₉₀₎60% RH<20 (B)

(wherein Re₍₅₉₀₎10% RH, Re₍₅₉₀₎60% RH and Re₍₅₉₀₎80% RH represent Re₍₅₉₀₎ at 25° C. and 10% RH, Re₍₅₉₀₎ at 25° C. and 60% RH and Re₍₅₉₀₎ at 25° C. and 80% RH, respectively, and Rth₍₅₉₀₎10% RH, Rth₍₅₉₀₎60% RH and Rth₍₅₉₀₎80% RH represent Rth₍₅₉₀₎ at 25° C. and 10% RH, Rth₍₅₉₀₎ at 25° C. and 60% RH and Rth₍₅₉₀₎ at 25° C. and 80% RH, respectively).

More preferably, the cellulose acylate film of the invention satisfies the following formulae (C) and (D);

0<(Re₍₅₉₀₎10% RH−Re₍₅₉₀₎80% RH)×100/Re₍₅₉₀₎60% RH<15; (C)

0<(Rth₍₅₉₀₎10% RH−Rth₍₅₉₀₎80% RH)×100/Rth₍₅₉₀₎60% RH<15. (D)

Most preferably, the cellulose acylate film of the invention satisfies the following formulae (E) and (F);

0<(Re₍₅₉₀₎10% RH−Re₍₅₉₀₎80% RH)×100/Re₍₅₉₀₎60% RH<10; (E)

0<(Rth₍₅₉₀₎10% RH−Rth₍₅₉₀₎80% RH)×100/Rth₍₅₉₀₎60% RH<10. (F)

In order to reduce change in the optical characteristics by humidity, cellulose acylate having a large substitution degree at 6-position and hydrophobic various additives (e.g., a plasticizer, a retardation increasing agent and a UV absorber) are used as well as to increase the number of knot points.

In order to increase the frontal contrast of a liquid crystal display, it is effective to reduce haze of the cellulose acylate film. The haze of the cellulose acylate film can be reduced by adjusting the amount of volatile components upon stretching to the region described in the invention.

An increased haze value is caused by generation of microscopic crazes (cracks) of the cellulose acylate film formed by stretching. Crazes generate due to disappearance of twining between cellulose acylate chains. In the region where the amount of volatile components is at a low level, many knot points exist in the film. Hence, twining between cellulose acylate chains is so strong that it does not disappear upon stretching, thus formation of the crazes being reduced.

As a specific value, the haze value is preferably from 0 to 1.0%, more preferably from 0 to 0.8%, particularly preferably from 0 to 0.6%. Also, in order to reduce the haze value by means other than depression of crazes, there may be employed a technique of sufficiently dispersing an added fine particulate matting agent to reduce the number of aggregated particles. It is also effective to remove insolubles contained in cellulose acylate or the additives.

### (Cellulose Acylate)

First, a particular cellulose acylate to be used in the invention will be described in detail below. In the invention, two or more different kinds of cellulose acylates may be used in combination thereof.

The cellulose acylate to be used in the invention is preferably a mixed fatty acid ester of cellulose obtained by substituting hydroxyl groups of cellulose by an acetyl group and an acyl group containing 3 or more carbon atoms, with the substitution degree of the hydroxyl groups of cellulose satisfying the following formulae (I) and (II):

2.0≦A+B≦3.0 Formula (I)

0≦B Formula (II)

(wherein A and B each represents a substitution degree of hydroxyl groups of cellulose substituted by an acyl group, with A being a substitution degree of acetyl group and B being a substitution degree of acyl group containing 3 or more carbon atoms).

Glucose units connecting to each other through β-1,4 bond to constitute cellulose have free hydroxyl groups at 2-, 3- and 6-positions. Cellulose acylate is a polymer obtained by esterifying part of or the whole hydroxyl groups with an acyl group. The acyl substitution degree means the ratio of esterification of cellulose (100% esterification being substitution 1) for each of hydroxyl groups at 2-, 3- and 6-positions.

In the invention, sum (A+B) of the substitution degrees of A and B of the hydroxyl groups is preferably from 2.0 to 3.0, more preferably from 2.2 to 2.9, particularly preferably from 2.40 to 2.85, as is shown in the above formula (I). Also, the substitution degree B is 0 or more as is shown in the above formula (II).

In case when A+B is less than 2.0, there results such a strong hydrophilicity that resultant cellulose acetate is susceptible to influence of ambient humidity.

When B>0, the sum of the substitution degrees of A and B of the hydroxyl group at 6-position of cellulose acylate is preferably 0.6 or more, more preferably 0.75 or more, particularly preferably 0.85 or more. Further, preferably 28% or more, more preferably 30% or more, still more preferably 31% or more, particularly 32% or more, of B is a substitution degree of the hydroxyl group at 6-position.

The acyl group containing 3 or more carbon atoms is not particularly limited and may be an aliphatic acyl group or an arylacyl group. Examples of cellulose acylate to be used in the invention include alkylcarbonyl esters, alkenylcarbonyl esters, aromatic carbonyl esters and aromatic alkylcarbonyl esters of cellulose, which may further have a substituent. Preferred examples of the acyl group include propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl. Of these, a propionyl group, a butanoyl group, a dodecanoyl group, an octadecanoyl, a t-butanoyl, an oleoyl group, a benzoyl group, a naphthylcarbonyl group and a cinnamoyl group are preferred, with a propionyl group and a butanoyl group being particularly preferred.

Also, with a propionyl group, the substitution B is preferably 0.6 or more, more preferably 0.7 or more, particularly preferably 0.75 or more. Such cellulose acylate shows high retardation-giving properties, and permits to provide a film showing a high retardation value.

In the case where B=0, D6S/(DS2+DS3+DS6) is preferably 0.315 or more, particularly preferably 0.320 or more, wherein D2 represents a substitution degree of a hydroxyl group at 2-position of glucose unit by an acyl group (hereinafter also referred to as “acyl substitution degree at 2-position”), D3 represents a substitution degree of a hydroxyl group at 3-position of glucose unit by an acyl group (hereinafter also referred to as “acyl substitution degree at 3-position”), and D6 represents a substitution degree of a hydroxyl group at 6-position of glucose unit by an acyl group (hereinafter also referred to as “acyl substitution degree at 6-position”). Further, DS2+DS3+DS6 is preferably from 2.00 to 2.85, more preferably from 2.22 to 2.82, particularly preferably from 2.40 to 2.80. Such cellulose acylate has high retardation-giving properties and permits to form a film showing a high retardation value.

### (Method for Synthesizing Cellulose Acylate)

The fundamental principle of the synthesizing method of cellulose acylate is described in Migita, et al., Mokuzai Kagaku (Wood Chemistry), pp. 180-190, KYORITSU SHUPPAN CO., LTD. (1968). A representative synthesizing method is a liquid phase acetylation method by carboxylic anhydride-acetic acid-a sulfuric acid catalyst. Specifically, cellulose materials of cotton linter and wood pulp are pre-treated with an appropriate amount of acetic acid, put into a previously cooled carboxylated mixed solution for esterification to thereby synthesize complete cellulose acylate (the total of the acyl substitution degree at the 2-position, 3-position and 6-position is almost 3.00). The carboxylated mixed solution generally contains acetic acid as a solvent, carboxylic anhydride as an esterifying agent and a sulfuric acid as a catalyst. It is usual to use carboxylic anhydride in excess amount stoichiometrically than the total amount of cellulose to be reacted with the carboxylic anhydride and the moisture present in the system. After completion of acylation reaction, an aqueous solution of a neutralizer (e.g., carbonate, acetate or oxide of calcium, magnesium, iron, aluminum or zinc) is added to hydrolyze excessive carboxylic acid remaining in the system and to neutralize a part of the esterification catalyst. In the next place, the obtained complete cellulose acylate is subjected to ripening by saponification in the presence of a small amount of acetylation reaction catalyst (generally the remaining sulfuric acid) while maintaining the temperature at 50 to 90° C. to be changed to cellulose acylate having a desired acyl substitution degree and polymerization degree. At a point of time when a desired cellulose acylate is obtained, the catalyst remaining in the system is completely neutralized with a neutralizer as above, or, without neutralization, cellulose acylate is separated by agglomeration and precipitation by putting the cellulose acylate solution into water or a dilute sulfuric acid (or putting water or a dilute sulfuric acid into the cellulose acylate solution), washing and stabilizing treatment to thereby obtain cellulose acylate.

The cellulose acylate film of the invention preferably comprises cellulose acylate wherein the polymer component constituting the film substantially has the above-described definition. The term “substantially” as used herein means 55 mass % or more of the polymer component (preferably 70 mass % or more, more preferably 80 mass % or more). As the starting material for producing a film, cellulose acylate particles are preferably used. 90 mass % or more of particles to be used preferably have a particle size of from 0.5 to 5 mm. Also, 50 mass % or more of particles to be used preferably have a particle size of from 1 to 4 mm. The cellulose acylate particles preferably have a shape as spherical as possible. The bulk specific gravity (apparent density) of the thus-formed particles is preferably from 0.3 to 0.8 kg/L. Particles with a smaller bulk specific gravity would tend to cause bridging upon throwing them from a silo to a dissolving tank, whereas particles with a larger bulk specific density would have a reduced solubility. Therefore, a more preferred bulk specific gravity is from 0.4 to 0.6. Adjustment of the particle size or bulk specific gravity is performed by controlling the stirring speed or aggregation speed upon aggregative precipitation.

The polymerization degree of cellulose acylate to be preferably used in the invention is from 200 to 700 in terms of viscosity-average polymerization degree, preferably from 250 to 550, more preferably from 250 to 400, particularly preferably from 265 to 380. The average polymerization degree can be measured according to the limiting viscosity method by Uda et al. (Kazuo Uda and Hideo Saito; Sen'i Gakkaishi, vol. 18, No. 1, pp. 105-120 (1962)). Further, detailed descriptions thereon are given in JP-A-9-95538. The viscosity-average polymerization degree is determined according to the following formula using the intrinsic viscosity (η) of cellulose acylate measured by means of an Ostwald's viscometer.

Viscosity−average polymerization degree DP=(η)/Km

In the above formula, (η) represents an intrinsic viscosity of cellulose acylate, and Km is a constant of 6×10⁻⁴.

Also, the cellulose acylate to be used in the invention preferably has a narrow molecular weight distribution represented by Mw/Mn (wherein Mw represents a weight-average molecular weight, and Mn represents a number-average molecular weight) determined by gel permeation chromatography. A specific Mw/Mn value is preferably from 0.8 to 2, more preferably from 1 to 1.8. When low molecular components are removed, the average molecular weight (polymerization degree) increases, whereas viscosity becomes smaller than that of usual cellulose acylate, thus removal of the low molecular components being preferred. Cellulose acylate containing a small amount of low molecular components can be obtained by removing the low molecular components from cellulose acylate synthesized according to the common process. Removal of the low molecular components can be conducted by washing cellulose acylate with a proper organic solvent. Additionally, in the case of producing cellulose acylate containing a small amount of low molecular components, it is preferred to adjust the amount of sulfuric acid catalyst in the acetylation reaction to 0.5 to 25 parts by mass per 100 parts by mass of cellulose. Adjustment of the amount of the sulfuric acid catalyst to a level within the above-mentioned range permits to synthesize cellulose acylate also preferred in view of molecular weight distribution (having a uniform molecular weight distribution).

Starting cotton and process for producing these cellulose acylates of the invention are described in detail in Journal of Technical Disclosure issued by Japan Institute of Invention and Innovation (Journal of Technical Disclosure No. 2001-1745 issued on Mar. 15, 2001, Japan Institute of Invention and Innovation).

### (Additives)

To a cellulose acylate solution in the invention, various additives (e.g., plasticizers, UV inhibitors (UV absorbers), deterioration preventives, retardation (optical anisotropy) adjustors (retardation increasing agent), fine particles, peeling accelerators, infrared absorbers, etc.) can be added according to purposes in each preparation process, and these additives may be solid or oily substances. That is, the melting points and the boiling points of these additives are not especially restricted. For example, the mixture of UV absorbers of 20° C. or lower and 20° C. or higher, and the mixture of plasticizers are the examples and these things are disclosed in JP-A-2001-151901 and the like. As the examples of the peeling accelerators, citric acid ethyl esters are exemplified. Further, the examples of the infrared absorbers are disclosed in JP-A-2001-194522. These additives may be added any stage in the manufacturing process of a dope, but they may be added at the final of the preparation process of dope by providing an addition process of additives. The addition amount of each additive is not particularly limited so long as the function is exhibited. Further, when a cellulose acylate film is formed as a multilayer structure, the kinds and addition amounts of additives in each layer may be different. The examples thereof are disclosed in JP-A-2001-151902 and the like, and these are conventionally known techniques. It is preferred to adjust the glass transition temperature Tg of cellulose acylate film to 80 to 180° C. and the elastic modulus measured with a tensile strength tester to 1,500 to 3,000 MPa.

The details of these things are described in Journal of Technical Disclosure issued by Japan Institute of Invention and Innovation (Journal of Technical Disclosure No. 2001-1745 issued on Mar. 15, 2001, Japan Institute of Invention and Innovation), on and after page 6, and the materials described therein are preferably used.

### (Plasticizers)

It is preferred for a cellulose acylate film of the invention to contain a plasticizer. Usable plasticizers are not especially limited, but it is preferred to use more hydrophobic plasticizers than cellulose acylate, alone or in combination, such as phosphates, e.g., triphenyl phosphate, tricresyl phosphate, cresyl-diphenyl phosphate, octyldiphenyl phosphate, diphenyl-biphenyl phosphate, trioctyl phosphate and tributyl phosphate, phthalates, e.g., diethyl phthalate, dimethoxyethyl phthalate, dimethyl phthalate, dioctyl phthalate, dibutyl phthalate, and di-2-ethylhexyl phthalate, glycolates, e.g., triacetin, tributyrin, butylphthalylbutyl glycolate, ethylphthalylethyl glycolate, methylphthalylethyl glycolate and butylphthalyl-butyl glycolate are exemplified. If necessary, plasticizers may be used two or more in combination.

### Retardation Increasing Agent:

Use of a plasticizer permits to stretch a cellulose acylate film with a high stretching ratio. Also, use of a compound more hydrophobic than cellulose acylate permits to depress change in Re and Rth accompanying change in humidity.

### (Retardation Increasing Agent)

In order to obtain a high retardation value, a retardation increasing agent is preferably used in the invention. As the retardation increasing agent, a compound having at least two aromatic rings may be used. The retardation increasing agent is used in an amount of from 0 to 10 mass %, more preferably from 0 to 7 mass %, still more preferably from 0 to 5 mass %, most preferably from 0.1 to 4 mass %, per 100 mass % of the polymer. The invention enables one to reduce the amount of the retardation increasing agent to be used, which serves to reduce the production cost of the film. Addition of the retardation increasing agent in an amount of 10 mass % or more to cellulose acylate would cause precipitation of the retardation increasing agent upon forming the film, thus not being preferred. Two or more retardation increasing agents may be used in combination thereof.

The retardation increasing agent preferably has the maximum absorption in a wavelength reaction of from 250 to 400 nm, and preferably does not substantially have any absorption in the visible region.

In the specification of the invention, “aromatic rings” include aromatic heterocyclic rings in addition to aromatic hydrocarbon rings.

Aromatic hydrocarbon rings are especially preferably 6-membered rings (i.e., benzene rings).

Aromatic heterocyclic rings are generally unsaturated heterocyclic rings. Aromatic heterocyclic rings are preferably 5-, 6- or 7-membered rings, and more preferably 5- or 6-membered rings. Aromatic heterocyclic rings generally have possible most double bonds. As the hetero atoms, a nitrogen atom, an oxygen atom and a sulfur atom are preferred, and a nitrogen atom is most preferred. The examples of aromatic heterocyclic rings include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic rings, a benzene ring, a condensed benzene ring and biphenyls are preferred, and a 1,3,5-triazine ring is especially preferably used. Specifically, the compounds disclosed in JP-A-2001-166144 are preferably used.

The carbon atoms of the aromatic ring which retardation increasing agent have are preferably from 2 to 20, more preferably from 2 to 12, still more preferably from 2 to 8, and most preferably from 2 to 6.

The bonding relation of two aromatic rings can be classified to (a) a case of forming a condensed ring, (b) a case of direct bonding via a single bond, and (c) a case of bonding via a linking group (as they are aromatic rings, spiro bonding cannot be formed). The bonding relation may be any of (a) to (c).

The examples of (a) condensed rings (condensed rings of two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and thianthrene ring. Of these rings, a naphthalene ring, an azulene ring, an indole ring, a benzoxazole ring, a benzothiazole ring, a benzimidazole ring, a benzotriazole ring and a quinoline ring are preferred.

A single bond in (b) is preferably bonding of two aromatic rings between carbon atoms. Two aromatic rings may be bonded by two or more single bonds, and an aliphatic ring or an aromatic heterocyclic ring may be formed between the aromatic rings.

It is also preferred that a linking group in (c) is bonded to the carbon atoms of two aromatic rings. The linking groups are preferably an alkylene group, an alkenylene group, an alkynylene group, —CO—, —O—, —NH—, —S— or combinations of these groups. The examples of linking groups comprising combination are shown below. The relation of the left and right of the examples of the following linking groups may be reverse.

c1: —CO—O—
c2: —CO—NH—
c3: −Alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: −Alkylene-CO—O-alkylene-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic rings and linking groups may have a substituent.

The examples of the substituents include a halogen atom (F, Cl, Br, I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxyl group, an alkoxycarbonyl group, an alkoxycarbonylamino group, an alkylthio group, an alkylsulfonyl group, an aliphatic amido group, an aliphatic sulfonamido group, an aliphatic group-substituted amino group, an aliphatic group-substituted carbamoyl group, an aliphatic group-substituted sulfamoyl group, an aliphatic group-substituted ureido group and a non-aromatic heterocyclic group.

The alkyl group preferably has from 1 to 8 carbon atoms. Chain-like alkyl groups are preferred to cyclic alkyl groups, and straight chain alkyl groups are particularly preferred. The alkyl group may further have a substituent (e.g., a hydroxyl group, a carboxyl group, an alkoxyl group, an alkyl-substituted amino group). The examples of the alkyl groups (including substituted alkyl groups) include methyl, ethyl, n-butyl, n-hexyl, 2-hydroxyethyl, 4-carboxybutyl, 2-methoxyethyl and 2-diethylaminoethyl.

The alkenyl group preferably has from 2 to 8 carbon atoms. Chain-like alkenyl groups are preferred to cyclic alkenyl groups, and straight chain alkenyl groups are particularly preferred. The alkenyl group may further have a substituent. The examples of the alkenyl groups include a vinyl group, an allyl group and a 1-hexenyl group.

The alkynyl group preferably has from 2 to 8 carbon atoms. Chain-like alkynyl groups are preferred to cyclic alkynyl groups, and straight chain alkynyl groups are particularly preferred. The alkynyl group may further have a substituent. The examples of the alkynyl groups include an ethynyl group, a 1-butynyl group and a 1-hexynyl group.

The aliphatic acyl group preferably has from 1 to 10 carbon atoms. The examples of the aliphatic acyl groups include an acetyl group, a propanoyl group and a butanoyl group.

The aliphatic acyloxy group preferably has from 1 to 10 carbon atoms. The example of the aliphatic acyloxy group includes an acetoxy group.

The alkoxyl group preferably has from 1 to 8 carbon atoms. The alkoxyl group may further have a substituent (e.g., an alkoxyl group). The examples of the alkoxyl groups (including substituted alkoxyl groups) include a methoxy group, an ethoxy group, a butoxy group and a methoxyethoxy group.

The alkoxycarbonyl group preferably has from 2 to 10 carbon atoms. The examples of the alkoxycarbonyl groups include a methoxycarbonyl group and an ethoxycarbonyl group.

The alkoxycarbonylamino group preferably has from 2 to 10 carbon atoms. The examples of the alkoxycarbonylamino groups include a methoxycarbonylamino group and an ethoxy-carbonylamino group.

The alkylthio group preferably has from 1 to 12 carbon atoms. The examples of the alkylthio groups include a methylthio group, an ethylthio group and an octylthio group.

The alkylsulfonyl group preferably has from 1 to 8 carbon atoms. The examples of the alkylsulfonyl groups include a methanesulfonyl group and an ethanesulfonyl group.

The aliphatic amido group preferably has from 1 to 10 carbon atoms. The example of the aliphatic amido group includes an acetamido group.

The aliphatic sulfonamido group preferably has from 1 to 8 carbon atoms. The examples of the aliphatic sulfonamido groups include a methanesulfonamido group, a butanesulfon-amido group and an n-octanesulfonamido group.

The aliphatic group-substituted amino group preferably has from 1 to 10 carbon atoms. The examples of the aliphatic group-substituted amino groups include a dimethylamino group, a diethylamino group and a 2-carboxyethylamino group.

The aliphatic group-substituted carbamoyl group preferably has from 2 to 10 carbon atoms. The examples of the aliphatic group-substituted carbamoyl groups include a methylcarbamoyl group and a diethylcarbamoyl group.

The aliphatic group-substituted sulfamoyl group preferably has from 1 to 8 carbon atoms. The examples of the aliphatic group-substituted sulfamoyl groups include a methylsulfamoyl group and a diethylsulfamoyl group.

The aliphatic group-substituted ureido group preferably has from 2 to 10 carbon atoms. The example of the aliphatic group-substituted ureido group includes a methylureido group.

The examples of the non-aromatic heterocyclic groups include a piperidino group and a morpholino group.

The molecular weight of retardation increasing agents is preferably from 300 to 800.

Rod-like compounds having a linear molecular structure are also preferably used in the invention besides the compounds having a 1,3,5-triazine ring. A linear molecular structure means that the molecular structure of a rod-like compound is linear in a thermodynamically most stable structure. A thermodynamically most stable structure can be found by the analysis of crystal structure or the computation of molecular orbital. For example, the molecular structure by which the heat of formation of a compound is the smallest can be found from the computation of molecular orbital with the software of molecular orbital computation (e.g., WinMOPAC2000, manufactured by Fujitsu Limited). That a molecular structure is linear means the angle constituted by the main chains in a molecular structure is 140° or more in a thermodynamically most stable structure found by the computation as above.

As the rod-like compound having at least two aromatic rings, a compound represented by the following formula (1) is preferred.

Ar¹-L1-Ar² (1)

In the above formula (1), Ar¹ and Ar² each independently represents an aromatic group.

In the specification of the invention, the aromatic group includes an aryl group (an aromatic hydrocarbon group), a substituted aryl group, an aromatic heterocyclic group and a substituted aromatic heterocyclic group.

An aryl group and a substituted aryl group are preferred to an aromatic heterocyclic group and a substituted aromatic heterocyclic group. The hetero ring of an aromatic heterocyclic group is generally unsaturated. An aromatic heterocyclic group is preferably a 5-, 6- or 7-membered ring, more preferably a 5- or 6-membered ring. An aromatic heterocyclic group generally has possible most double bonds. The hetero atom is preferably a nitrogen atom, an oxygen atom or a sulfur atom, more preferably a nitrogen atom or a sulfur atom.

As the aromatic rings of the aromatic group, a benzene ring, a furan ring, a thiophene ring, a pyrrole ring, an oxazole ring, a thiazole ring, an imidazole ring, a triazole ring, a pyridine ring, a pyrimidine ring and a pyrazine ring are preferred, and a benzene ring is especially preferred.

As the examples of the substituents of the substituted aryl group and the substituted aromatic heterocyclic group, a halogen atom (e.g., F, Cl, Br, I), a hydroxyl group, a carboxyl group, a cyano group, an amino group, an alkylamino group (e.g., methylamino, ethylamino, butylamino, dimethylamino), a nitro group, a sulfo group, a carbamoyl group, an alkylcarbamoyl group (e.g., N-methylcarbamoyl, N-ethylcarbamoyl, N,N-dimethylcarbamoyl), a sulfamoyl group, an alkylsulfamoyl group (e.g., N-methylsulfamoyl, N-ethylsulfamoyl, N,N-dimethylsulfamoyl), a ureido group, an alkylureido group (e.g., N-methylureido, N,N-dimethylureido, N,N,N′-trimethylureido), an alkyl group (e.g., methyl, ethyl, propyl, butyl, pentyl, heptyl, octyl, isopropyl, s-butyl, t-amyl, cyclohexyl, cyclopentyl), an alkenyl group (e.g., vinyl, allyl, hexenyl), an alkynyl group (e.g., ethynyl, butynyl), an acyl group (e.g., formyl, acetyl, butyryl, hexanoyl, lauryl), an acyloxy group (e.g., acetoxy, butyryloxy, hexanoyloxy, lauroyloxy), an alkoxyl group (e.g., methoxy, ethoxy, propoxy, butoxy, pentyloxy, heptyloxy, octyloxy), an aryloxy group (e.g., phenoxy), an alkoxycarbonyl group (e.g., methoxycarbonyl, ethoxycarbonyl, propoxycarbonyl, butoxycarbonyl, pentyloxy-carbonyl, heptyloxycarbonyl), an aryloxycarbonyl group (e.g., phenoxycarbonyl), an alkoxycarbonylamino group (e.g., butoxy-carbonylamino, hexyloxycarbonylamino), an alkylthio group (e.g., methylthio, ethylthio, propylthio, butylthio, pentylthio, heptylthio, octylthio), an arylthio group (e.g., phenylthio), an alkylsulfonyl group (e.g., methylsulfonyl, ethylsulfonyl, propylsulfonyl, butylsulfonyl, pentylsulfonyl, heptylsulfanyl, octylsulfonyl), an amido group (e.g., acetamido, butylamido, hexylamino, laurylamide), and non-aromatic heterocyclic group (e.g., morpholino, pyrazinyl) are exemplified.

Above all, as preferred substituents, a halogen atom, a cyano group, a carboxyl group, a hydroxyl group, an amino group, an alkylamino group, an acyl group, an acyloxy group, an amido group, an alkoxycarbonyl group, an alkoxyl group, an alkylthio group and an alkyl group are exemplified.

The alkyl moiety of the alkylamino group, alkoxycarbonyl group, alkoxyl group, alkylthio group, and the alkyl group may further have a substituent. The examples of the substituents of the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxyl group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. As the substituents of the alkyl moiety and the alkyl group, a halogen atom, a hydroxyl group, an amino group, an alkylamino group, an acyl group, an acyloxy group, an acylamino group, an alkoxycarbonyl group, and an alkoxyl group are preferred.

In formula (1), L¹ represents a divalent linking group selected from the group consisting of an alkylene group, an alkenylene group, an alkynylene group, —O—, —CO— and a group consisting of the combination of these groups.

The alkylene group may have a cyclic structure. As the cyclic alkylene group, cyclohexylene is preferred, and 1,4-cyclohexylene is especially preferred. As the chain-like alkylene group, a straight chain alkylene group is preferred to a branched alkylene group.

The alkylene group preferably has from 1 to 20 carbon atoms, more preferably from 1 to 15, still more preferably from 1 to 10, still yet preferably from 1 to 8, and most preferably from 1 to 6.

As the structure of the alkenylene group and the alkynylene group, a chain-like structure is preferred to a cyclic structure, and a straight chain structure is more preferred to a branched chain structure.

The alkenylene group and the alkynylene group preferably have from 2 to 10 carbon atoms, more preferably from 2 to 8, still more preferably from 2 to 6, still yet preferably from 2 to 4, and most preferably 2 (a vinylene group or an ethynylene group).

The arylene group preferably has from 6 to 20 carbon atoms, more preferably from 6 to 16, and still more preferably from 6 to 12.

In the molecular structure of formula (1), the angle formed by Ar¹ and Ar² sandwiching L¹ is preferably 140° or more, more preferably from 140° to 220°.

As the rod-like compound, a compound represented by the following formula (2) is more preferred.

Ar¹-L²-X-L³-Ar² (2)

In formula (2), Ar¹ and Ar² each independently represents an aromatic group. The definition and examples of the aromatic group are the same as those of Ar¹ and Ar² in formula (1).

In formula (2), L² and L³ each independently represents a divalent linking group selected from the group consisting of an alkylene group, —O—, —CO— and a group consisting of the combination of these groups.

As the structure of the alkylene group, a chain-like structure is preferred to a cyclic structure, and a straight chain structure is more preferred to a branched chain structure.

The alkylene group preferably has from 1 to 10 carbon atoms, more preferably from 1 to 8, still more preferably from 1 to 6, still yet preferably from 1 to 4, and most preferably 1 or 2 (a methylene group or an ethylene group).

L² and L³ each especially preferably represents —O—CO— or —CO—O—.

In formula (2), X represents a 1,4-cyclohexylene group, a vinylene group or an ethynylene group.

The specific examples of the compounds represented by formula (1) are shown below.

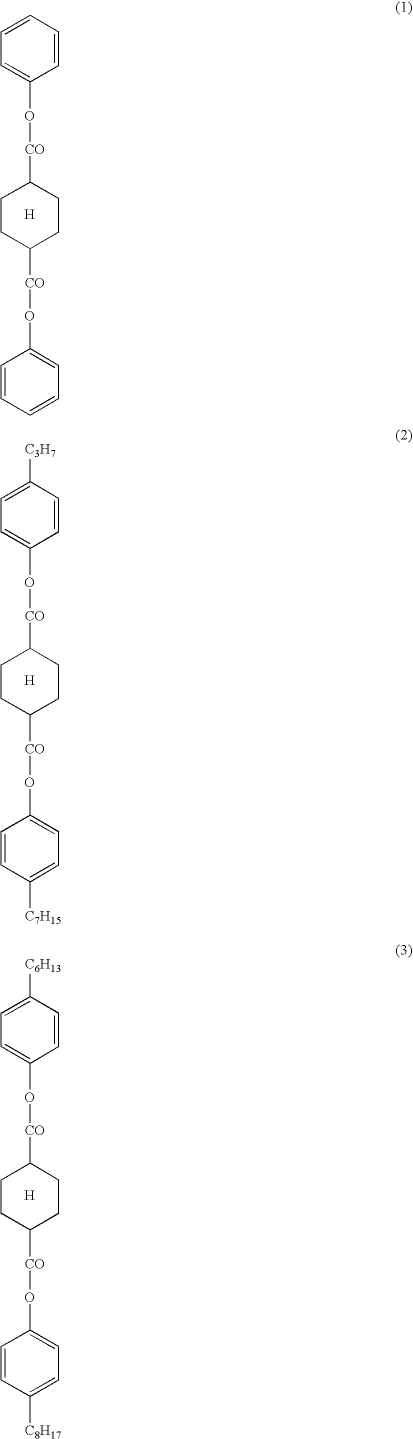

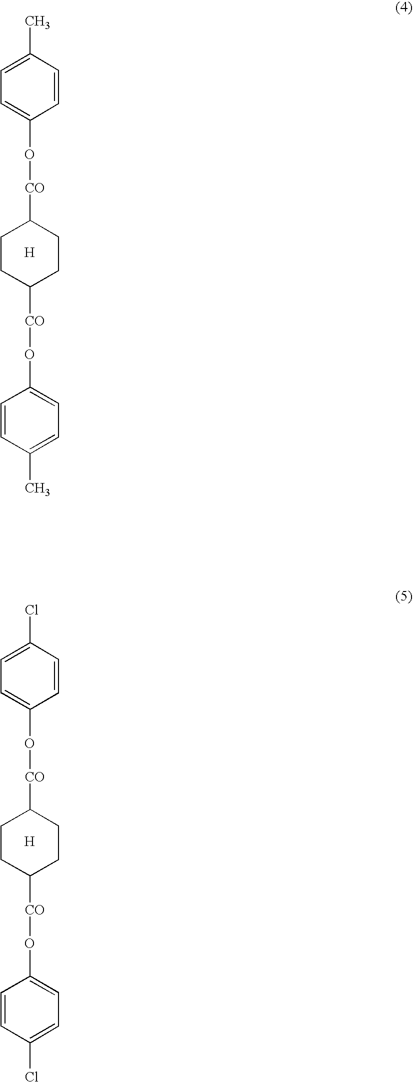

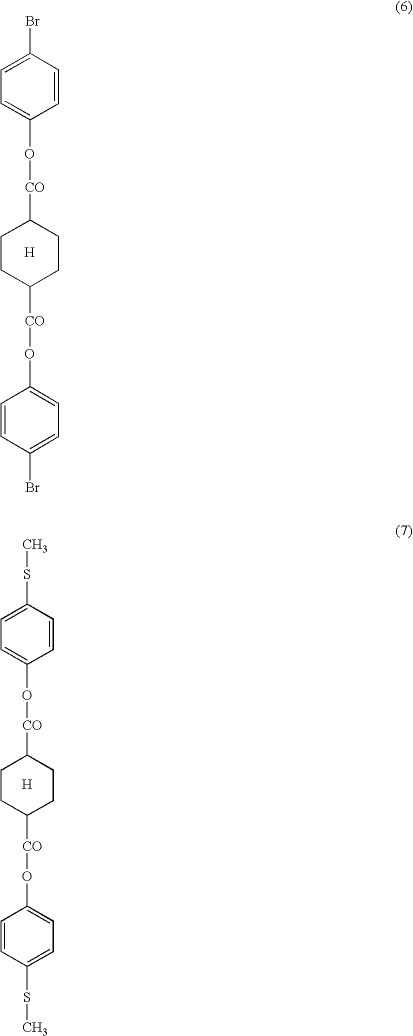

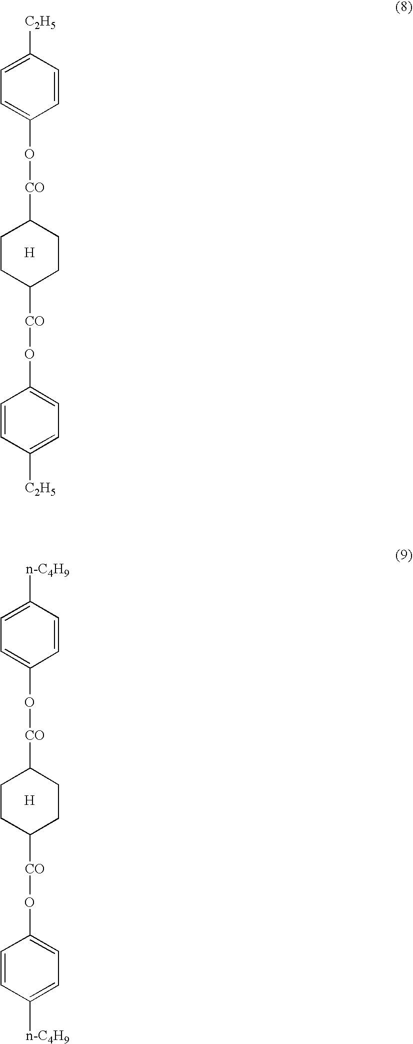

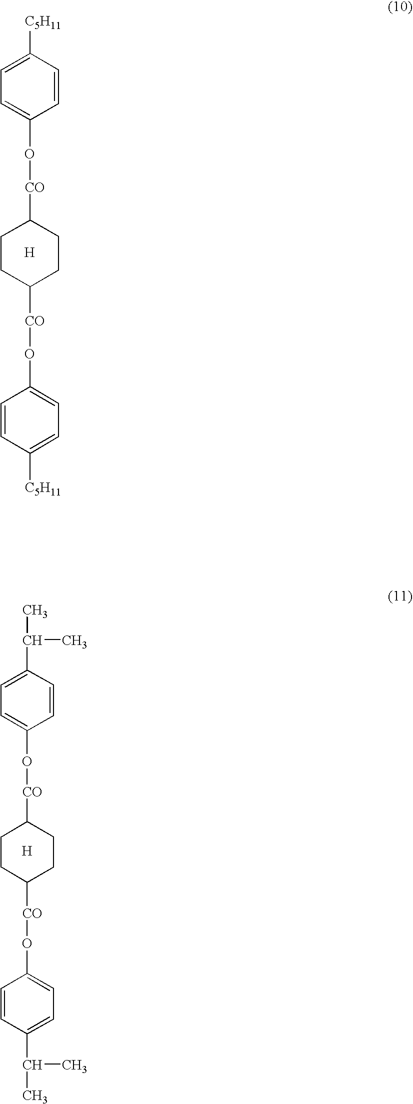

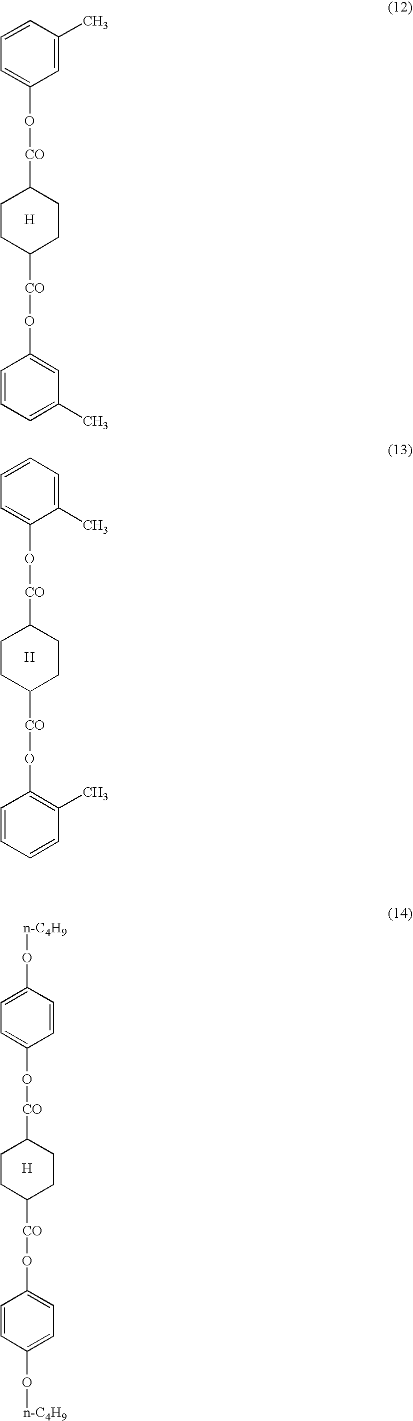

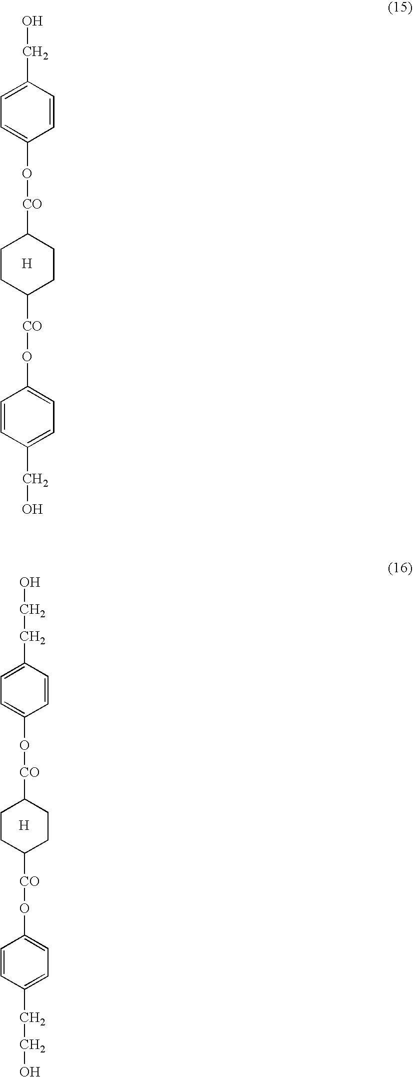

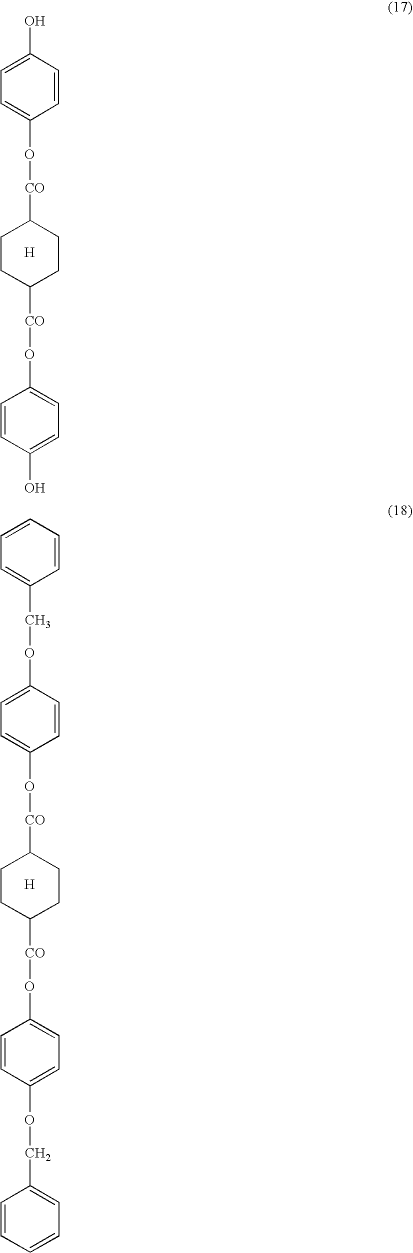

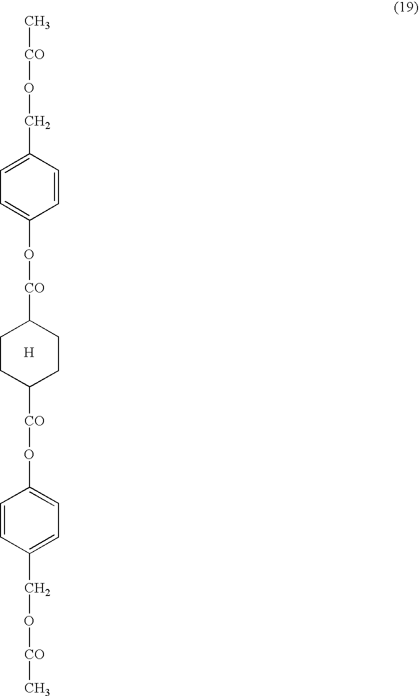

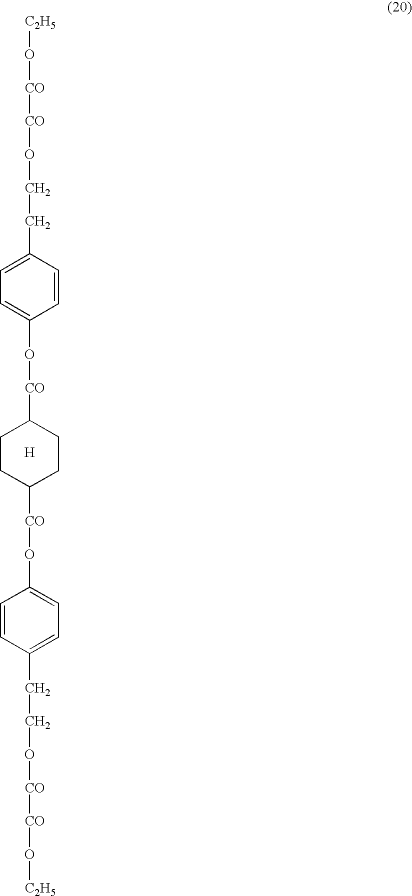

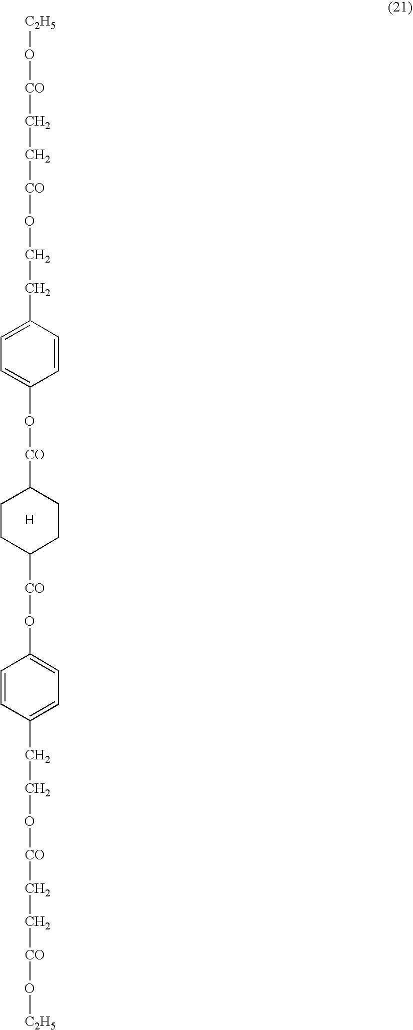

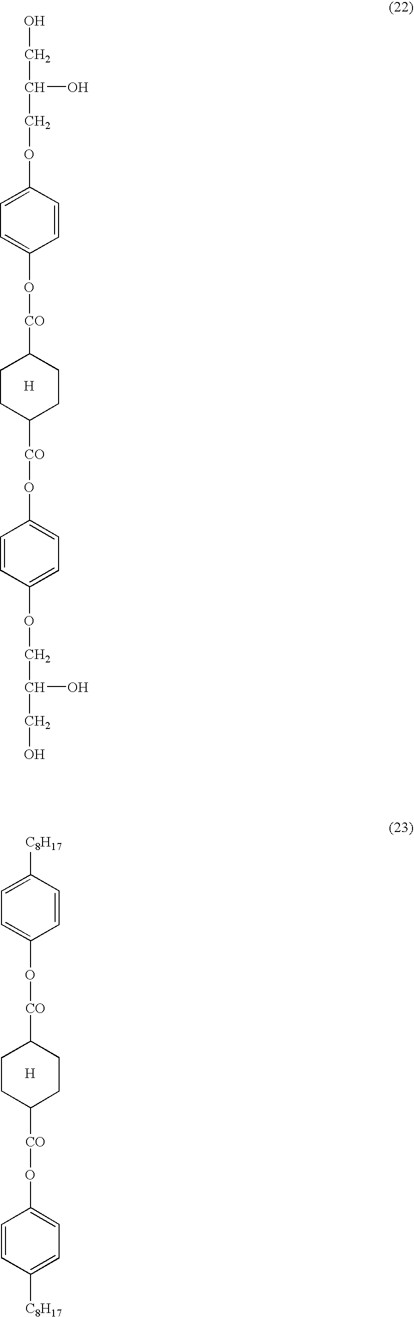

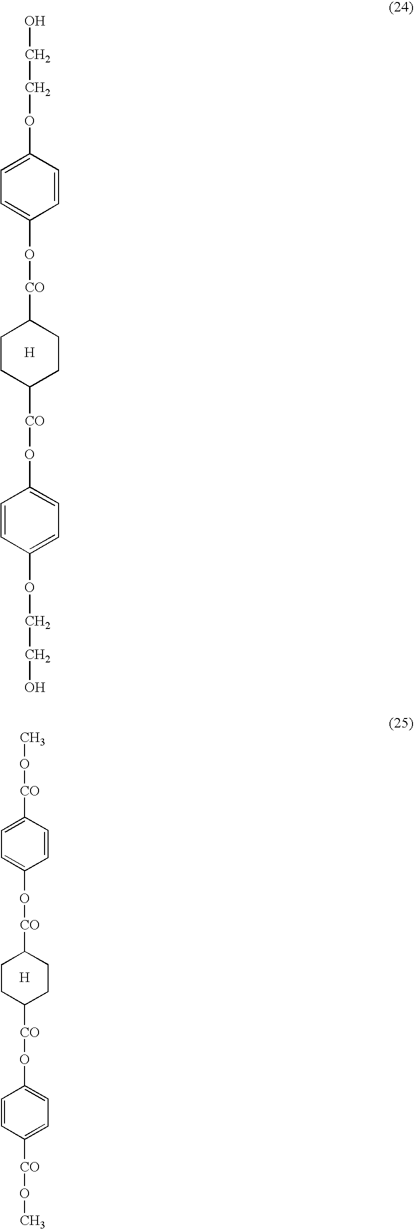

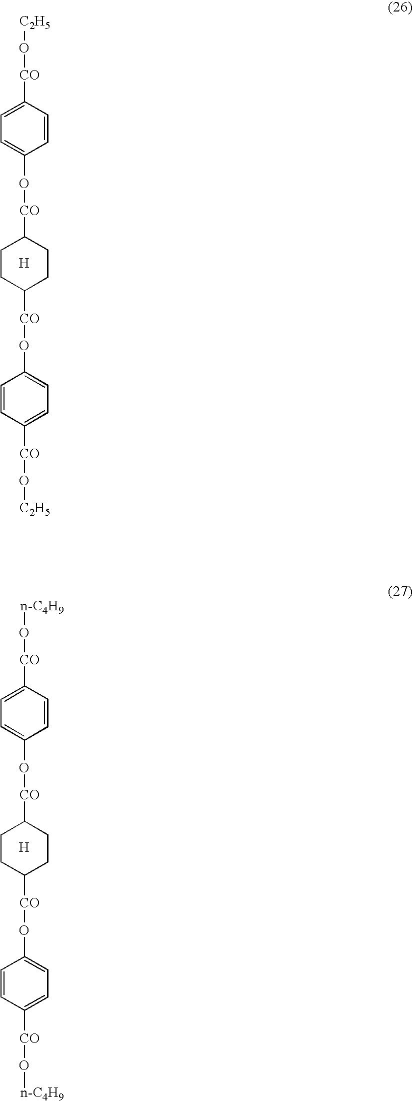

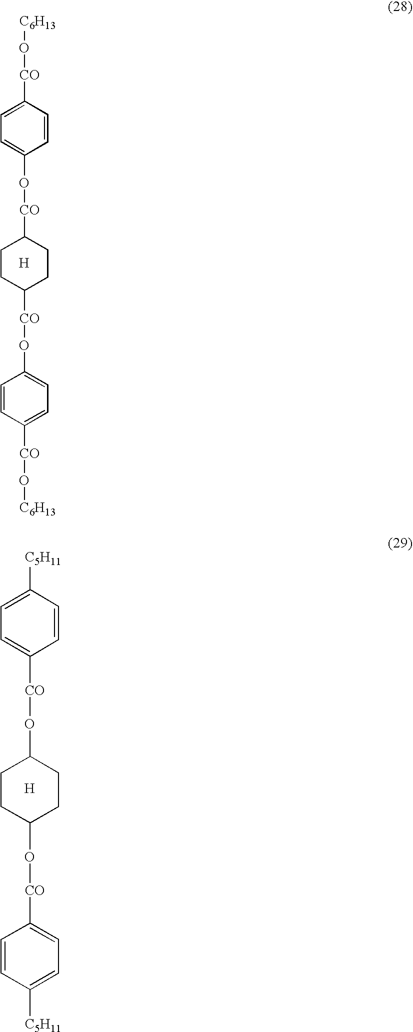

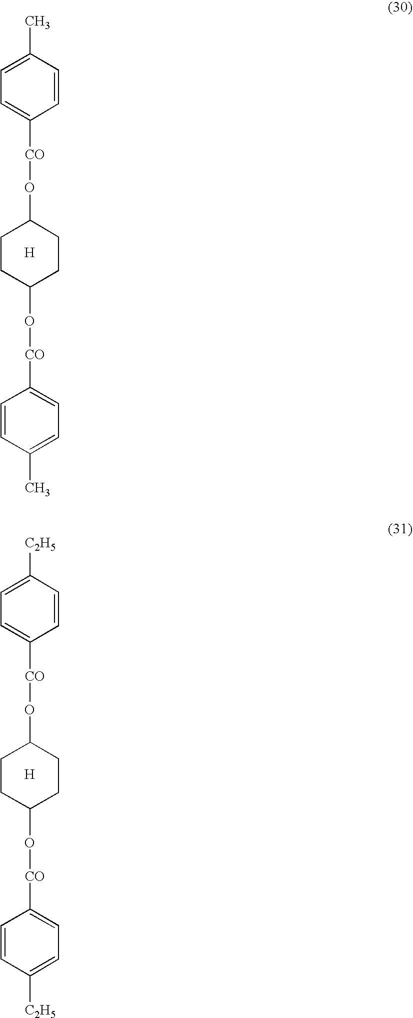

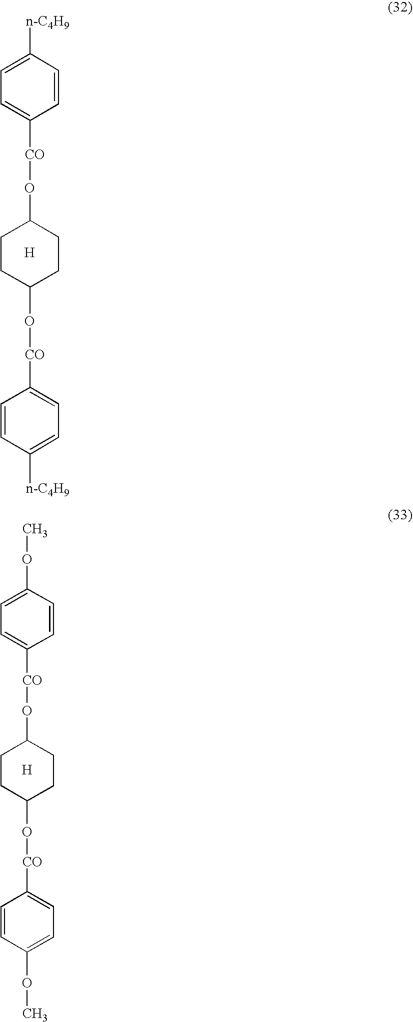

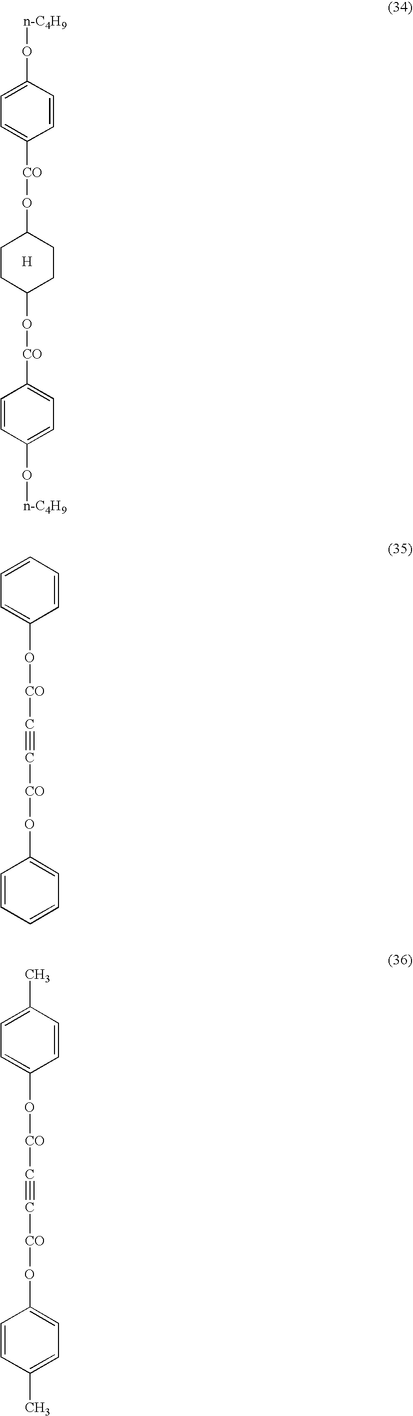

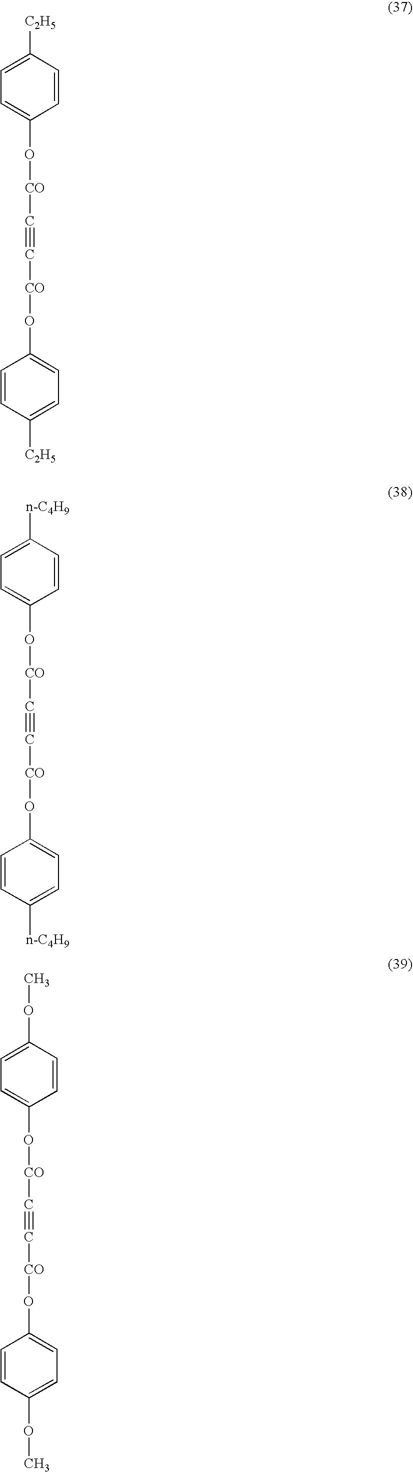

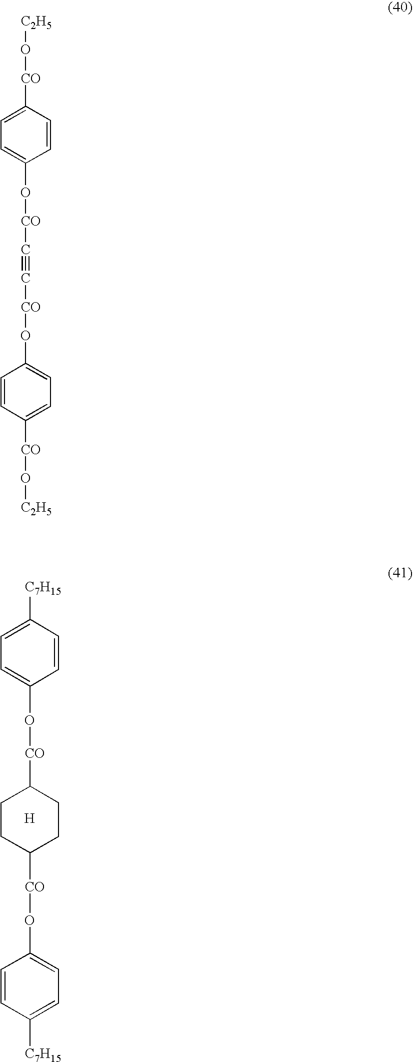

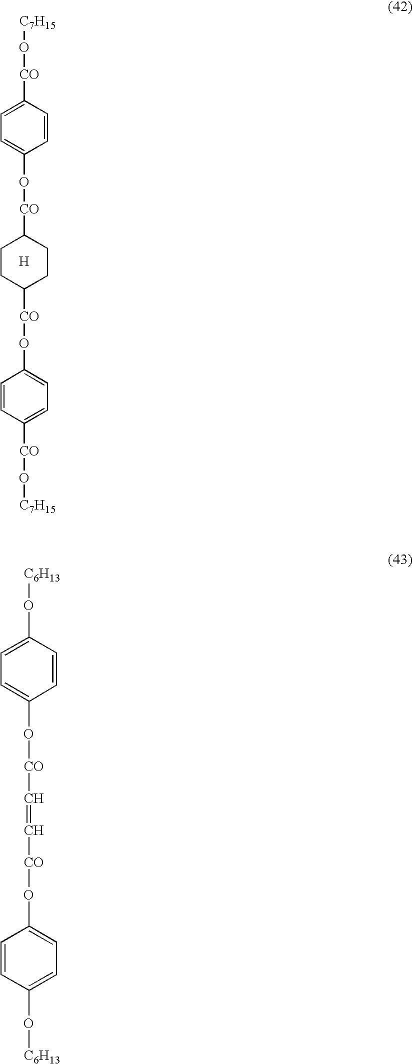

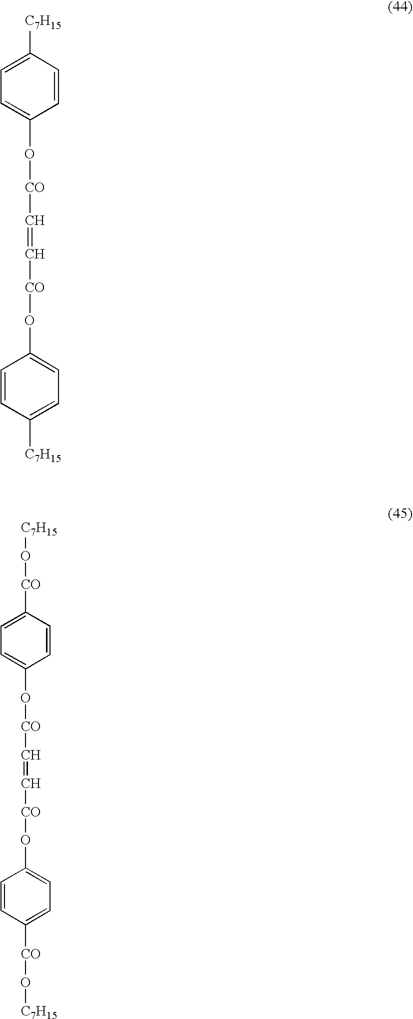

Specific examples (1) to (34), (41) and (42) have two asymmetric carbon atoms at the 1-position and 4-position of the cyclohexane ring. However, since specific examples (1), (4) to (34), (41) and (42) have a symmetric meso form molecular structure, they do not have an optical isomer (optical activity), and only a geometrical isomer (a trans form and a cis form) is present. A trans form (1-trans) and a cis form (1-cis) of specific example (1) are shown below.

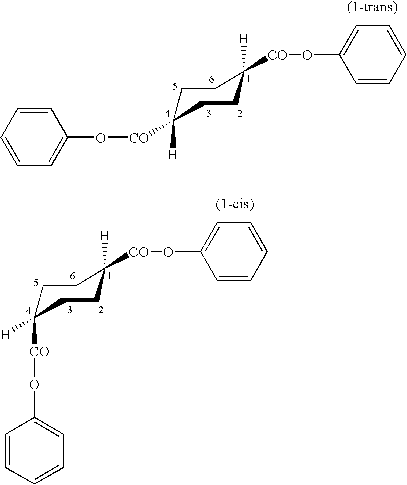

As described above, it is preferred that rod-like compounds have a linear molecular structure. Therefore, a trans form is preferred to a cis form.

Specific examples (2) and (3) have optical isomers (four kinds of isomers in total) in addition to geometrical isomers. With respect to a geometrical isomer, similarly a trans form is preferred to a cis form. There is no superiority or inferiority in optical isomers, and may be any of D, L or a racemic body.

In specific examples (43) to (45), there are a trans form and a cis form in the central vinylene bond. A trans form is preferred to a cis form for the same reason.

A compound represented by the following formula (3) is also preferred.

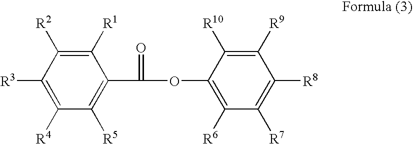

In formula (3), R¹, R², R³, R⁴, R⁵, R⁶, R⁷, R⁸, R⁹ and R¹⁰ each independently represents a hydrogen atom or a substituent, at least one of R¹, R², R³, R⁴ and R⁵ represents an electron donative group, R⁸ represents a hydrogen atom, an alkyl group having from 1 to 4 carbon atoms, an alkenyl group having from 2 to 6 carbon atoms, an alkynyl group having from 2 to 6 carbon atoms, an aryl group having from 6 to 12 carbon atoms, an alkoxyl group having from 1 to 12 carbon atoms, an aryloxy group having from 6 to 12 carbon atoms, an alkoxycarbonyl group having from 2 to 12 carbon atoms, an acylamino group having from 2 to 12 carbon atoms, a cyano group or a halogen atom.

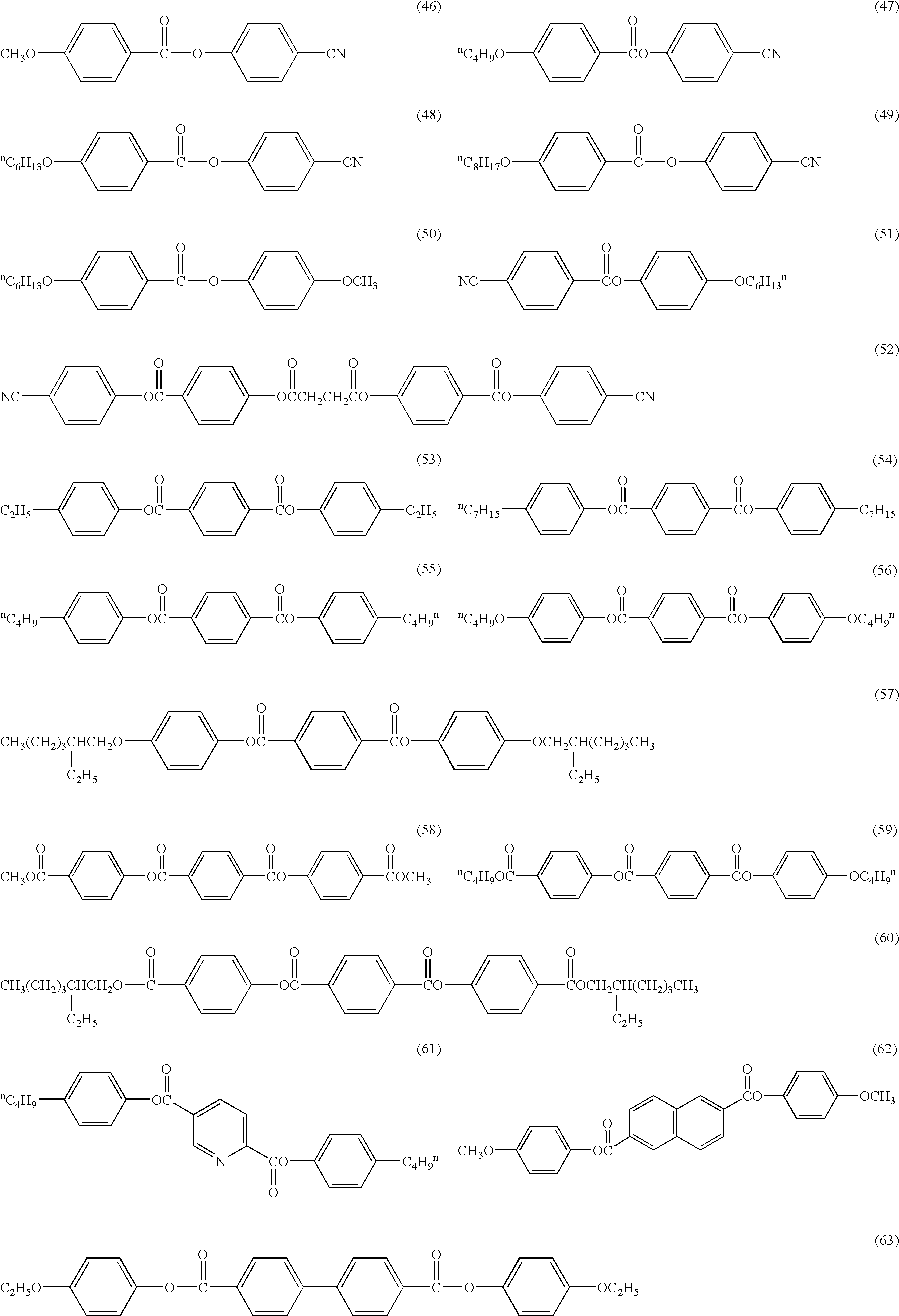

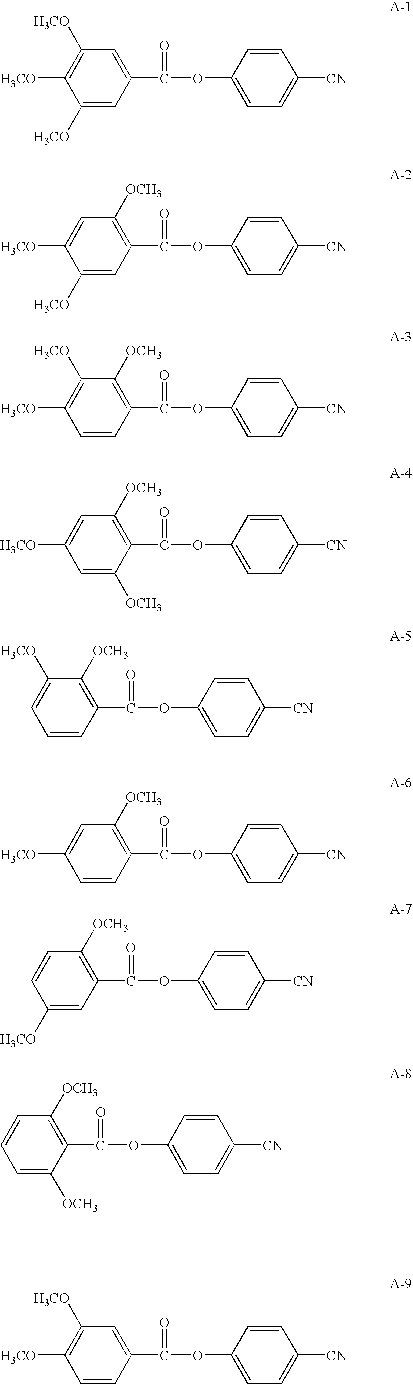

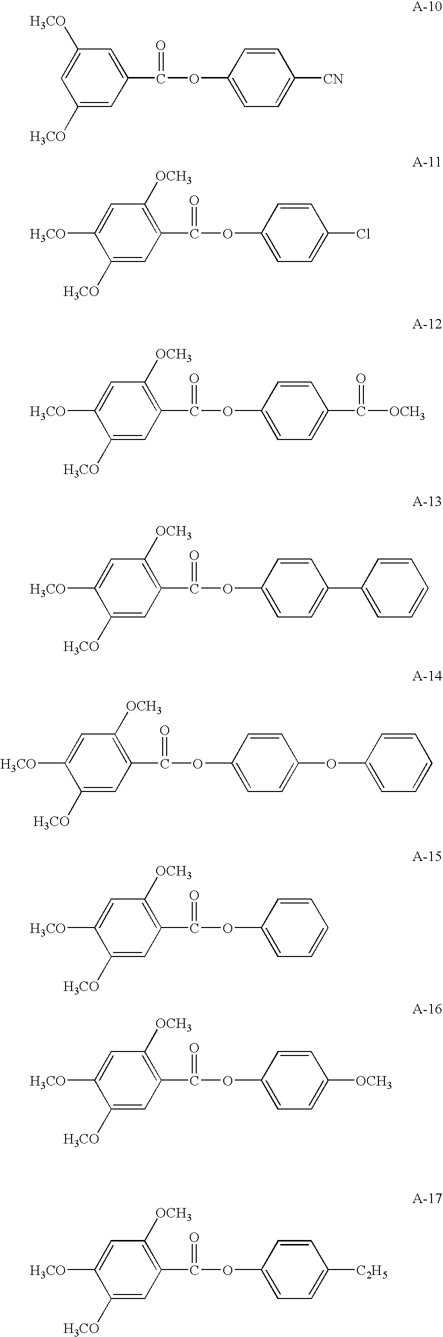

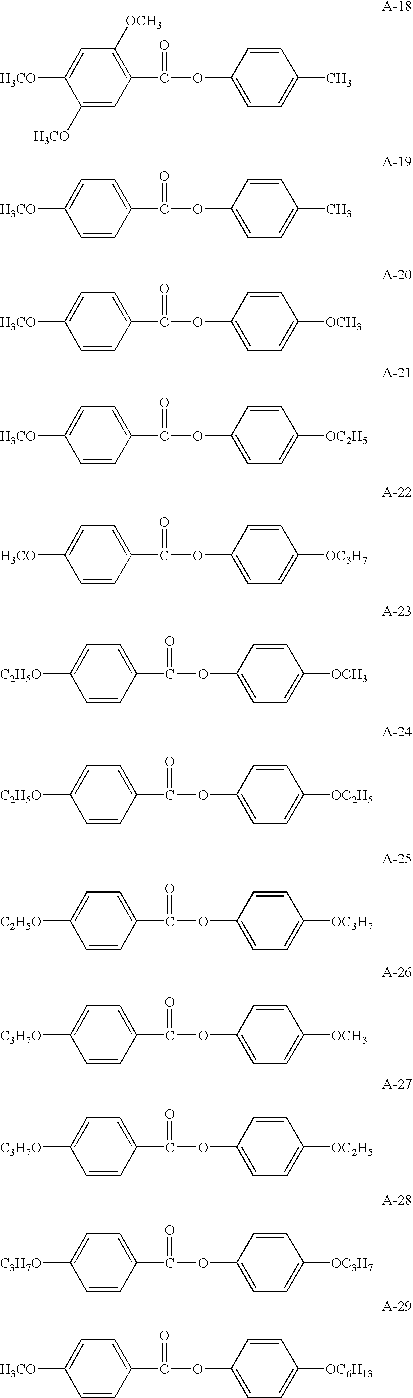

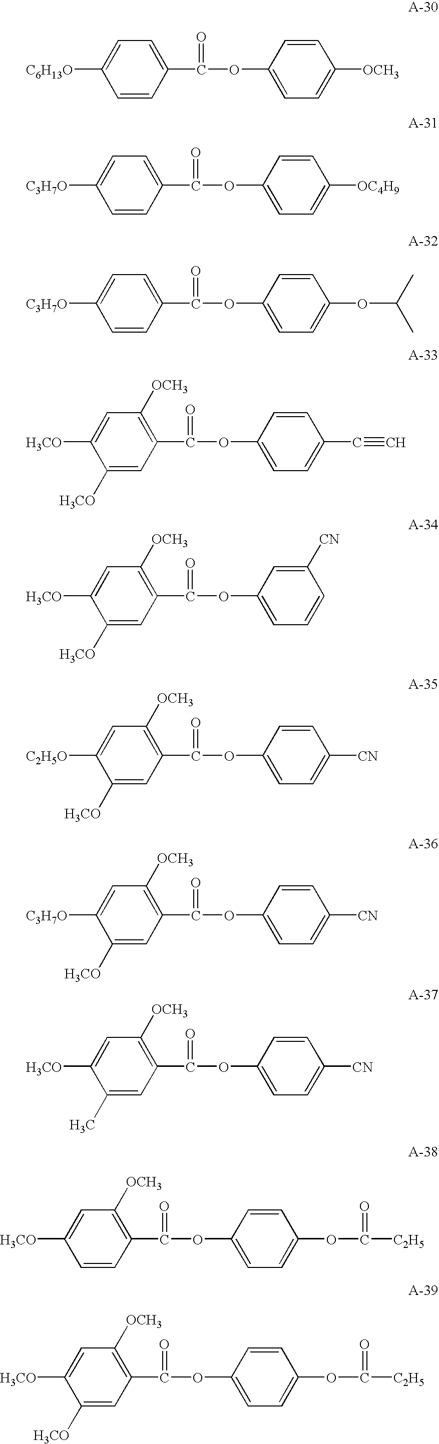

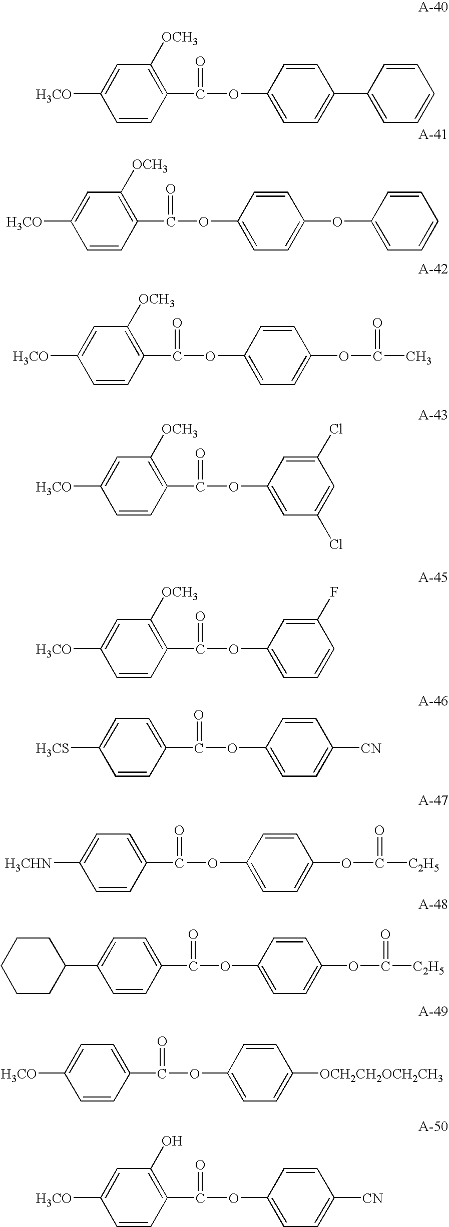

Rod-like compounds having maximum absorption (λmax) of 250 nm or shorter in UV absorption spectrum of a solution may be used in combination of two or more.

Rod-like compounds can be synthesized with reference to the methods described in various literatures, for example, Mol. Cryst. Liq. Cryst., Vol. 53, p. 229 (1979), ibid., Vol. 89, p. 93 (1982), ibid., Vol. 145, p. 111 (1987), ibid., Vol. 170, p. 43 (1989), J. Am. Chem. Soc., Vol. 113, p. 1349 (1991), ibid., Vol. 118, p. 5346 (1996), ibid., Vol. 92, p. 1582 (1970), J. Org. Chem., Vol. 40, p. 420 (1975), and Tetrahedron, Vol. 48, No. 16, p. 3437 (1992) can be exemplified.

Organic solvents for dissolving cellulose acylate in the invention are described below.

### (Chlorine Solvents)

In manufacturing a cellulose acylate solution in the invention, chlorine organic solvents are preferably used as the main solvents. The kinds of chlorine organic solvents are not especially restricted so long as cellulose acylate can be dissolved, cast to form a film to thereby achieve the object of the invention. Chlorine organic solvents are preferably dichloromethane and chloroform, and especially preferably dichloromethane. Organic solvents other than chlorine organic solvents can be blended with chlorine organic solvents with no problems. When other organic solvents are used, it is necessary to use at least 50 mass % of dichloromethane. Non-chlorine organic solvents that are used in the invention with chlorine organic solvents are described below.

As the non-chlorine organic solvents, solvents selected from ester, ketone, ether, alcohol and hydrocarbon each having from 3 to 12 carbon atoms are preferably used. The ester, ketone, ether and alcohol may have a cyclic structure. Compounds having any two or more functional groups of ester, ketone, and ether (i.e., —O—, —CO— and —COO—) can also be used as solvents, for example, other functional group, e.g., an alcoholic hydroxyl group, can be used at the same time. In the case of solvents having two or more functional groups, the carbon atom number may be in the range of the specification of the compounds having any functional groups. The examples of esters having from 3 to 12 carbon atoms include ethyl formate, propyl formate, pentyl formate, methyl acetate, ethyl acetate and pentyl acetate. The examples of ketones having from 3 to 12 carbon atoms include acetone, methyl ethyl ketone, diethyl ketone, diisobutyl ketone, cyclopentanone, cyclohexanone and methyl cyclohexanone. The examples of ethers having from 3 to 12 carbon atoms include diisopropyl ether, dimethoxymethane, dimethoxyethane, 1,4-dioxane, 1,3-dioxolan, tetrahydrofuran, anisole and phenetol. The examples of organic solvents having two or more functional groups include 2-ethoxyethyl acetate, 2-methoxyethanol and 2-butoxyethanol.

The alcohols to be used in combination with chlorine organic solvents may be straight chain, branched or cyclic, and saturated aliphatic hydrocarbons are especially preferably used. The hydroxyl groups of alcohols may be any of primary, secondary and tertiary. The examples of the alcohols include methanol, ethanol, 1-propanol, 2-propanol, 1-butanol, 2-butanol, t-butanol, 1-pentanol, 2-methyl-2-butanol and cyclohexanol. As the alcohols, fluorine alcohols can also be used. For example, 2-fluoroethanol, 2,2,2-trifluoroethanol, and 2,2,3,3-tetrafluoro-1-propanol are exemplified. The hydrocarbons may be straight chain, branched or cyclic. Both aromatic hydrocarbons and aliphatic hydrocarbons can be used. The aliphatic hydrocarbons may be saturated or unsaturated. The examples of the hydrocarbons include cyclohexane, hexane, benzene, toluene and xylene.

As the combinations of chlorine organic solvents that are preferred main solvents in the invention, the following combinations are exemplified but the invention is not limited thereto.
Dichloromethane/acetone/methanol/ethanol/butanol (75/10/5/5/5, mass parts (weight parts))
Dichloromethane/acetone/methanol/propanol (80/10/5/5, mass parts)
Dichloromethane/acetone/methanol/butanol/cyclohexane (75/10/5/5/, mass parts)
Dichloromethane/methyl ethyl ketone/methanol/butanol (80/10/5/5, mass parts)
Dichloromethane/acetone/methyl ethyl ketone/ethanol/isopropanol (75/8/5/5/7, mass parts)
Dichloromethane/cyclopentanone/methanol/isopropanol (80/7/5/8, mass parts)
Dichloromethane/methyl acetate/butanol (80/10/10, mass parts)
Dichloromethane/cyclohexanone/methanol/hexane (70/20/5/5, mass parts)
Dichloromethane/methyl ethyl ketone/acetone/methanol/ethanol (50/20/20/5/5, mass parts)
Dichloromethane/1,3-dioxolan/methanol/ethanol (70/20/5/5, mass parts)
Dichloromethane/dioxane/acetone/methanol/ethanol (60/20/10/5/5, mass parts)
Dichloromethane/acetone/cyclopentanone/ethanol/isobutanol/cyclohexane (65/10/10/5/5/5, mass parts)
Dichloromethane/methyl ethyl ketone/acetone/methanol/ethanol (70/10/10/5/5, mass parts)
Dichloromethane/acetone/ethyl acetate/ethanol/butanol/hexane (65/10/10/5/5/5, mass parts)
Dichloromethane/methyl acetoacetate/methanol/ethanol (65/20/10/5, mass parts)
Dichloromethane/cyclopentanone/ethanol/butanol (65/20/10/5, mass parts)

### (Non-Chlorine Solvents)

In the next place, non-chlorine organic solvents preferably used in manufacturing a cellulose acylate solution in the invention are described. Non-chlorine organic solvents are not especially restricted so long as cellulose acylate can be dissolved, cast to form a film to thereby achieve the object of the invention. As the non-chlorine organic solvents, solvents selected from ester, ketone and ether each having from 3 to 12 carbon atoms are preferably used. The ester, ketone and ether may have a cyclic structure. Compounds having any two or more functional groups of ester, ketone, and ether (i.e., —O—, —CO— and —COO—) can also be used as main solvents, and may have other functional group, e.g., an alcoholic hydroxyl group. In the case of main solvents having two or more functional groups, the number of carbon atoms may be in the range of the specification of the compounds having any functional groups. The examples of esters having from 3 to 12 carbon atoms include ethyl formate, propyl formate, pentyl formate, methyl acetate, ethyl acetate and pentyl acetate. The examples of ketones having from 3 to 12 carbon atoms include acetone, methyl ethyl ketone, diethyl ketone, diisobutyl ketone, cyclopentanone, cyclohexanone, and methyl cyclohexanone. The examples of ethers having from 3 to 12 carbon atoms include diisopropyl ether, dimethoxymethane, dimethoxyethane, 1,4-dioxane, 1,3-dioxolan, tetrahydrofuran, anisole and phenetol. The examples of organic solvents having two or more functional groups include 2-ethoxyethyl acetate, 2-methoxyethanol and 2-butoxyethanol.

The non-chlorine organic solvents that are used for dissolving cellulose acylate are selected from various points of view as described above, and preferably as follows. The preferred solvents for cellulose acylate in the invention are mixed solvents of three or more kinds of solvents different from each other. The first solvent is at least one solvent selected from methyl acetate, ethyl acetate, methyl formate, ethyl formate, acetone, dioxolan and dioxane, or a mixed solvent of these solvents. The second solvent is selected from ketones having from 4 to 7 carbon atoms or acetoacetate, and the third solvent is selected from alcohols having from 1 to 10 carbon atoms or hydrocarbons, more preferably alcohols having from 1 to 8 carbon atoms. When the first solvent is a mixed solvent of two or more solvents, the second solvent may not be contained. The first solvent is more preferably methyl acetate, acetone, methyl formate, ethyl formate or a mixed solvent of these solvents. The second solvent is more preferably methyl ethyl ketone, cyclopentanone, cyclohexanone, methyl acetylacetate, or a mixed solvent of these solvents.

The alcohols of the third solvent may be straight chain, branched or cyclic, and saturated aliphatic hydrocarbons are especially preferred of hydrocarbons. The hydroxyl groups of the alcohols may be any of primary, secondary and tertiary. The examples of the alcohols include methanol, ethanol, 1-propanol, 2-propanol, 1-butanol, 2-butanol, t-butanol, 1-pentanol, 2-methyl-2-butanol and cyclohexanol. As the alcohols, fluorine alcohols can also be used. For example, 2-fluoroethanol, 2,2,2-trifluoroethanol, and 2,2,3,3-tetrafluoro-1-propanol are exemplified. The hydrocarbons may be straight chain, branched or cyclic. Both aromatic hydrocarbons and aliphatic hydrocarbons can be used.

The aliphatic hydrocarbons may be saturated or unsaturated. The examples of the hydrocarbons include cyclohexane, hexane, benzene, toluene and xylene. The alcohols and hydrocarbons as the third solvents may be used alone or in combination of two or more, and there are no restrictions.

The preferred specific examples of the third solvents include, as alcohols, methanol, ethanol, 1-propanol, 2-propanol, 1-butanol, and 2-butanol, and as hydrocarbons, cyclohexanol, cyclohexane and hexane, and of these solvents, methanol, ethanol, 1-propanol, 2-propanol and 1-butanol are especially preferred.

These three kinds of solvents are preferably used in the proportion of the first solvent of from 20 to 95 mass %, the second solvent of from 2 to 60 mass %, and the third solvent of from 2 to 30 mass %. It is more preferred that the proportion of the first solvent is from 30 to 90 mass %, the second solvent is from 3 to 50 mass %, and alcohol of the third solvent is from 3 to 25 mass %. It is still more preferred that the proportion of the first solvent is from 30 to 90 mass %, the second solvent is from 3 to 30 mass %, and alcohol of the third solvent is from 3 to 15 mass %. When the first solvent is a mixed solvent and the second solvent is not used, it is preferred that the first solvent is contained in the proportion of from 20 to 90 mass %, and the third solvent is contained in the proportion of from 5 to 30 mass %, and it is more preferred that the proportion of the first solvent is from 30 to 86 mass %, and the third solvent is from 7 to 25 mass %. The non-chlorine organic solvents for use in the invention are described in Journal of Technical Disclosure issued by Japan Institute of Invention and Innovation (Journal of Technical Disclosure No. 2001-1745 issued on Mar. 15, 2001, Japan Institute of Invention and Innovation), on pages from 12 to 16 in detail. The preferred combinations of the non-chlorine organic solvents are shown below, but the invention is not limited thereto.
Methyl acetate/acetone/methanol/ethanol/butanol (75/1015/5/5, mass parts)
Methyl acetate/acetone/methanol/ethanol/propanol (75/10/5/5/5, mass parts)
Methyl acetate/acetone/methanol/butanol/cyclohexane (75/10/5/5/5, mass parts)
Methyl acetate/acetone/ethanol/butanol (81/8/7/4, mass parts)
Methyl acetate/acetone/ethanol/butanol (82/10/4/4, mass parts)
Methyl acetate/acetone/ethanol/butanol (80/10/4/6, mass parts)
Methyl acetate/methyl ethyl ketone/methanol/butanol (80/10/5/5, mass parts)
Methyl acetate/acetone/methyl ethyl ketone/ethanol/isopropanol (75/8/5/5/7, mass parts)
Methyl acetate/cyclopentanone/methanol/isopropanol (80/7/5/8, mass parts)
Methyl acetate/acetone/butanol (85/10/5, mass parts)
Methyl acetate/cyclopentanone/acetone/methanol/butanol (60/15/14/5/6, mass parts)
Methyl acetate/cyclohexanone/methanol/hexane (70/20/5/5, mass parts)
Methyl acetate/methyl ethyl ketone/acetone/methanol/ethanol (50/20/20/5/5, mass parts)
Methyl acetate/1,3-dioxolan/methanol/ethanol (70/20/5/5, mass parts)
Methyl acetate/dioxane/acetone/methanol/ethanol (60/20/10/5/5, mass parts)
Methyl acetate/acetone/cyclopentanone/ethanol/isobutanol/cyclohexane (65/10/10/5/5/5, mass parts)
Methyl formate/methyl ethyl ketone/acetone/methanol/ethanol (50/20/20/5/5, mass parts)
Methyl formate/acetone/ethyl acetate/ethanol/butanol/hexane (65/10/10/5/5/5, mass parts)
Acetone/methyl acetoacetate/methanol/ethanol (65/20/10/5, mass parts)
Acetone/cyclopentanone/ethanol/butanol (65/20/10/5, mass parts)
Acetone/1,3-dioxolan/ethanol/butanol (65/20/10/5, mass parts)
1,3-Dioxolan/cyclohexanone/methyl ethyl ketone/methanol/ethanol/butanol (55/20/10/5/5/5, mass parts)

Further, a cellulose acylate solution can also be manufactured by the following methods.

A method of preparing a cellulose acylate solution by methyl acetate/acetone/ethanol/butanol (8118/7/4, mass parts), filtering the solution to concentrate, and then adding 2 mass parts of butanol additionally to the filtrate.

A method of preparing a cellulose acylate solution by methyl acetate/acetone/ethanol/butanol (84/10/4/2, mass parts), filtering the solution to concentrate, and then adding 4 mass parts of butanol additionally to the filtrate.

A method of preparing s cellulose acylate solution by methyl acetate/acetone/ethanol (84/10/6, mass parts), filtering the solution to concentrate, and then adding 5 mass parts of butanol additionally to the filtrate.

### (Characteristics of Cellulose Acylate Solution)

In the invention it is preferred that from 10 to 30 mass % of cellulose acylate is dissolved in an organic solvent, more preferably from 13 to 27 mass %, still more preferably from 15 to 25 mass %, and especially preferably from 15 to 20 mass % of cellulose acylate is dissolved. For preparing cellulose acylate in the range of this concentration, a solution having the prescribed concentration may be prepared at the stage of dissolving cellulose acylate, or a solution having low concentration (e.g., from 9 to 14 mass %) is prepared in advance, and then the concentration may be raised to the prescribed concentration by a concentration process, or a solution having high concentration is prepared in advance, and then the concentration may be made lower to the prescribed concentration by adding various additives, and any method can be used in the invention, so long as a cellulose acylate solution can be prepared so as to reach the above concentration.

In the next place, it is preferred in the invention that the molecular weights of the aggregates of dilute cellulose acylate solutions obtained by diluting a cellulose acylate solution to 0.1 to 5 mass % with the organic solvent having the same composition are from 150,000 to 15,000,000. More preferably, the molecular weights of the aggregates are from 180,000 to 9,000,000. The molecular weight of the aggregate can be found by a static light scattering method. It is preferred to perform dissolution so that the square radius of inertia that can be found at the same time becomes from 10 to 200 nm. The more preferred square radius of inertia is from 20 to 200 nm. It is further preferred to perform dissolution so that the second viral coefficient is −2×10⁻⁴ to 4×10⁻⁴, more preferably the second viral coefficient is from −2×10⁻⁴ to 2×10⁻⁴.

The molecular weight of aggregate, the square radius of inertia, and the definition of the second viral coefficient are described. These were measured according to the following method by a static light scattering method. The measurement was performed in an attenuated region for reasons of the measuring instruments but the measured values reflect the behaviors of the dope of the invention in a high concentration region. In the first place, cellulose acylate is dissolved in a solvent for use in a dope to prepare solutions having concentrations of 0.1 mass %, 0.2 mass %, 0.3 mass % and 0.4 mass % respectively. For preventing moisture absorption, weighing was performed at 25° C. 10% RH by using cellulose acylate having been dried at 120° C. for 2 hours. Dissolution is performed according to a method adopted in the dissolution of a dope (normal temperature dissolution, cooling dissolution, high temperature dissolution). Subsequently, the solution and the solvent are filtered through a Teflon filter having a pore size of 0.2 μm. The static light scattering of the filtered solution is measured at 25° C. at angles of 30° to 1400 with the intervals of 100 with a light scattering meter (DLS-700, manufactured by OTSUKA ELECTRONICS CO., LTD.). The obtained data are analyzed according to a Berry plotting method. As the refractive indexes necessary for the analysis, the values of the solvents found with an Abbe's refractometer are used. For the concentration gradient of refractive indexes (dn/dc), a differential refractometer (DRM-1021, manufactured by OTSUKA ELECTRONICS CO., LTD.) is used, and measurement is performed with the solvent and solution used in the light scattering measurement.

### (Preparation of Dope)

Preparation of a Cellulose Acylate Solution (Dope) of the Invention is not Limited to any specific dissolution method. Preparation of a cellulose acylate solution may be performed at room temperature. Further, the cellulose acylate solution can be prepared by the cooling dissolution method, the high-temperature dissolution method, or a mixture thereof. Methods for preparing the cellulose acylate solution are described in, e.g., JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017, and JP-A-11-302388. The above-described methods of dissolving cellulose acylate into an organic solvent can be adopted as appropriate in the present invention. Details of the descriptions are implemented by the method described in detail on pp. 22 to 25 of Journal of Technical Disclosure issued by Japan Institute of Invention and Innovation (Journal of Technical Disclosure No. 2001-1745 issued on Mar. 15, 2001, Japan Institute of Invention and Innovation). The dope solution of cellulose acylate of the present invention is usually subjected to solution condensation and filtration, which is similarly described in detail on pg. 25 of Journal of Technical Disclosure issued by Japan Institute of Invention and Innovation (Journal of Technical Disclosure No. 2001-1745 issued on Mar. 15, 2001, Japan Institute of Invention and Innovation). When cellulose acylate is dissolved at high temperature, the cellulose acylate is dissolved, in most cases, at a temperature which is higher than the boiling point of an organic solvent used for dissolution. In such a case, the organic solvent is used in a pressurized state.

As mentioned previously, the density of the cellulose acylate solution is characterized in that a high-density dope is obtained. A high-density cellulose acylate solution having high stability is obtained without dependence on means, such as condensation. In order to facilitate solution of cellulose acylate, cellulose acylate may be dissolved at a low concentration, and the thus-prepared solution may be condensed through use of condensation means. No particular limitation is imposed on the condensation method. For instance, the method can be implemented according to one method (described in the specification of, e.g., JP-A-4-259511) or other methods (described in, e.g., U.S. Pat. Nos. 2,541,012, 2,858,229, 4,414,341, and 4,504,355), or like methods.

It is preferred to remove insolubles and contaminants such as dust and impurities from the solution, prior to casting, by filtration using an appropriate filter medium such as wire gauze or flannel. For the filtration of the cellulose acylate solution, a filter of from 0.1 to 100 μm, preferably from 0.5 to 25 μm, in absolute filtration accuracy is used. The thickness of the filter is preferably from 0.1 to 10 mm, more preferably from 0.2 to 2 mm. In this case, filtration is conducted under the filtration pressure of preferably 1.6 MPa or less, more preferably 1.2 MPa or less, still more preferably 1.0 MPa or less, particularly preferably 0.2 MPa or less. As the filter medium, conventionally known materials such as glass fibers, cellulose fibers, filter paper and fluorine-containing resins such as tetrafluoroethylene resin can preferably be used, with ceramics and metals being preferably used.

In the invention, the viscosity of the cellulose acylate solution is preferably adjusted to a specific range. Viscosity is determined by, for example, measuring about 1 mL of a sample solution using a stress rheometer (CVO 120) manufactured by Bohlin Instruments. The viscosity (unit: Pas) is measured under the conditions of loading 1% displacement at 33° C. in dope temperature and 1 Hz in frequency.

The viscosity is preferably from 10 to 70 Pas (measuring temperature: 33° C.). In case when the viscosity is higher than this range, there results such a poor fluidity that filtration or casting becomes difficult whereas, in case when the viscosity is lower than this range, there results such a low inside pressure of a casting die that it becomes impossible to uniformly cast in the transverse direction, which tends to cause a large change in thickness in the transverse direction. The viscosity of the dope is more preferably from 15 to 45 Pas, most preferably from 20 to 35 Pas.

When the solution viscosity is within the above-mentioned range, filtration load is so reduced that a filter medium having a smaller pore size and a higher accuracy than those of a conventional medium can be employed. As a result, the cellulose acylate film of the invention contains a less amount of contaminants, and can reduce so-called bright point defect caused by, leakage of light upon black display on a liquid display device having the film.

### (Film Formation)

A manufacturing method of a film using a cellulose acylate solution is described below. As the manufacturing method and equipment of a cellulose acylate film of the invention, solution casting film-forming methods and solution casting film-forming apparatus used for manufacturing cellulose triacetate films can be used. A prepared dope (a cellulose acylate solution) is taken out of a dissolver (kiln) and once stored in a silo, and the dope is defoamed for final preparation. The dope is delivered to a pressure type die from a dope discharge port through, e.g., a pressure type volume regulating gear pump capable of highly accurate volume regulating feeding by number of revolutions, casting the dope uniformly on the metal support of a casting part endlessly running from the slit of the pressure type die, and a damp-dry dope film (also called web) is peeled from the metal support at peeling point where the metal support almost makes a round. Both ends of the web are clasped with clips, the web is conveyed by tenter with holding the breadth and dried, subsequently conveyed by the rollers of dryer to finish drying, and wound with a winder in a prescribed length. The combination of tenter with rollers of dryer varies according to purpose. In solution casting film-forming methods used for functional protective films for electronic display, in addition to the solution casting film-forming apparatus, a coating apparatus is additionally equipped in many cases for surface processing of, e.g., a subbing layer, an antistatic layer, an annihilation layer, a protective layer, etc. Each manufacturing process is described briefly, but the invention is not limited thereto.

The prepared cellulose acylate solution (dope) is cast on a drum or a band by a solvent cast method in manufacturing a cellulose acylate film to thereby evaporate the solvent and form a film. It is preferred to adjust the concentration of a dope before casting so that the solids content is from 5 to 40 mass %. It is preferred to planish the surface of a drum or a band beforehand. It is preferred to cast a dope on the surface of a drum or a band of 30° C. or lower, and it is more preferred that a dope be cast on a metal support of a temperature of from −10 to 20° C.

Further, the techniques disclosed in the following patents can be applied to the invention: JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650.

### (Multilayer Casting)

A cellulose acylate solution may be cast on a metal support, e.g., a smooth band or a drum, as a single layer solution, or two or more cellulose acylate solutions may be cast. In the case of casting a plurality of cellulose acylate solutions, the cellulose acylate solutions may be cast from a plurality of casting heads provided with intervals in the proceeding direction of the metal support to thereby form a film while lamination, and the methods disclosed in JP-A-61-158414, JP-A-1-122419 and JP-A-11-198285 can be applied to the invention.

It is also preferred to form a film by casting cellulose acylate solutions from two casting heads and the methods disclosed, e.g., in JP-B-60-27562, JP-A-61-94724, JP-A-61-947245, JP-A-61-104813, JP-A-61-158413 and JP-A-6-134933 can be used for manufacture. Further, it is also preferred to use a cellulose acylate film casting method of wrapping the flow of a highly viscous cellulose acylate solution with a low viscous cellulose acylate solution and extruding the high and low viscous cellulose acylate solutions simultaneously as disclosed in JP-A-56-162617. As another method, it is also preferred for the outside solution to contain an alcohol component of bad solvent in larger amount than the inside solution as disclosed in JP-A-61-94724 and JP-A-61-94725. Alternatively, a method of forming a film with two casting heads and peeling a formed film on a metal support by the first casting head, and then casting by the second casting head on the side in contact with the surface of the metal support may be used, as disclosed in JP-B-44-20235. The cellulose acylate solutions may be the same solutions or different solutions and not particularly restricted. For providing functions to a plurality of cellulose acylate layers, it is effective to extrude a cellulose acylate solution corresponding to each function from each casting head. Further, other functional layers (e.g., an adhesive layer, a dye layer, an antistatic layer, an annihilation layer, a UV absorbing layer, a polarizing layer, etc.) can be cast at the same time by cellulose acylate solutions.

For obtaining a necessary film thickness by a conventional single layer solution, it is necessary to extrude a highly concentrated and highly viscous cellulose acylate solution, in that case the stability of the cellulose acylate solution is bad, solid matters are generated, and accompanied by the problems of a failure due to the solid matters and planar failure. As the measure against this problem, by casting a plurality of cellulose acylate solutions from casting heads, highly viscous solutions can be extruded at the same time on a metal support, as a result not only a planar property can be bettered and a film having a good face property can be formed, but also a drying load can be reduced by using a concentrated cellulose acylate solution and film production speed can be heightened.

In the case of co-casting, the film thickness of the outside and inside is not especially restricted, but preferably the outside thickness is from 1 to 50% of the total film thickness, more preferably from 2 to 30%. In the case of co-casting of three or more layers, the total film thickness of the layer in contact with a metal support and the layer in contact with air is defined as the outside thickness. In the case of co-casting, a cellulose acylate film of a lamination structure can be formed by co-casting cellulose acylate solutions different in the concentrations of additives such as plasticizers, UV absorbers and matting agents. For example, a cellulose acylate film having a structure of skin layer/core layer/skin layer can be formed. For instance, a large amount of a matting agent can be added to a skin layer, or only to a skin layer. A greater amount of a plasticizer and a UV absorber can be added to a core layer than the amount in the skin layer, or may be added only to a core layer. The kinds of a plasticizer and a UV absorber can be changed in a skin layer and a core layer. For instance, low volatile plasticizer and/or UV absorber can be added to a skin layer, and a plasticizer having excellent plasticizing property or a UV absorber having excellent UV-absorbing property can be added to a core layer. It is also a preferred embodiment to add a peeling accelerator only to a skin layer on the side of a metal support. It is also preferred to add a greater amount of bad solvent alcohol to a skin layer than the amount in a core layer for gelling the solution by cooling a metal support according to a cooling drum method. Tg's of a skin layer and a core layer may be different, and it is preferred that the Tg of a core layer is lower than the Tg of a skin layer. The viscosities of solutions containing cellulose acylate in casting may be different between a skin layer and a core layer, and it is preferred that the viscosity of a skin layer is smaller than that of a core layer, but the viscosity of a core layer may be smaller than that of a skin layer.

### (Casting)

As the casting methods of a solution, there are a method of uniformly extruding a prepared dope on a metal support from a pressure die, a method of adjusting the film thickness of a dope once cast on a metal support with a blade according to a doctor blade method, and a reverse roll method of adjusting the film thickness of a dope with a reverse rotating roll, and a method by a pressure die is preferred. There are a coat hanger type and a T die type in the pressure die, and both types can be preferably used. Other than the above shown methods, various conventionally known methods can be used for making films by casting cellulose triacetate solutions, and the similar effects to those described in respective patents can be obtained by setting the film-forming conditions considering the difference of the boiling points and the like of the solvents to be used. As a metal support for use in endless running for manufacturing a cellulose acylate film of the invention, a drum the surface of which is planished by chromium plating and a stainless steel belt (or band) planished by surface polishing are used. As the pressure die for use in manufacturing a cellulose acylate film in the invention, one die may be installed on the upper part of a metal support or two or more dies may be equipped, preferably one or two. When two or more dies are installed, the amount of dope to be cast may be divided into various proportions to respective dies, or the dope may be fed to respective dies in respective proportions from a plurality of precision volume regulating gear pumps. The temperature of a cellulose acylate solution used in casting is preferably from −10 to 55° C., more preferably from 25 to 50° C. Every process may be the same temperature or may be different in each process. When the temperature is different, it is sufficient that the desired temperature is secured just before casting.

### (Drying)

Drying of a dope on a metal support in cellulose acylate film manufacture is generally performed by a method of blowing hot air from the surface side of a metal support (a drum or a belt), i.e., from the surface side of a web on a metal support, a method of blowing hot air from the back surface of a drum or a belt, or a liquid heat transfer method of bringing temperature-controlled liquid into contact with the back surface of a belt or a drum opposite to the side of dope casting, heating the drum or the belt by heat transfer to thereby control the surface temperature, and a back surface liquid heat transfer method is preferred of these methods. The surface temperature of a metal support before casting may be any degree so long as it is lower than the boiling point of the solvent used in the dope. However, for expediting drying and getting rid of fluidity on a metal support, the temperature is preferably set at a temperature lower than the boiling point of the solvent having the lowest boiling point by 1 to 10° C. This rule, however, does not apply to the case where a cast dope is peeled off without cooling and drying.

In the invention, the thickness of finished (dried) cellulose acylate film is preferably from 20 to 110 μm, more preferably from 40 to 95 μm, most preferably from 45 to 75 μm, though depending upon purpose. Reduction of thickness of the film has been required by panel makers. The film thickness of the invention can meet this requirement of the panel makers. Also, reduction of the thickness leads to reduction in amount of the raw materials and therefore it serves to reduce production cost of the film. A film of less than 40 μm in thickness is too thin to provide good handling, thus not being preferred. Also, a film of more than 110 μm in thickness is not preferred because of requirement from panel makers to minimize the thickness of the film member.

Adjustment of the film thickness can be performed by adjusting content of solids contained in the dope, slit gap at the nozzle of a die, extruding pressure from the die and speed of a metal support so that a film of a desired thickness can be obtained. The width of the thus-obtained cellulose acylate film is preferably from 0.5 to 3 m, more preferably from 0.6 to 2.5 m, more preferably from 0.8 to 2.2 m. As to film length, it is preferred to wind up from 100 to 10,000 m of the film per roll. The film length per roll is more preferably rom 500 to 7,000 m, still more preferably from 1,000 to 6,000. Upon winding up the film, it is preferred to provide knurling on at least one edge with a width of from 3 mm to 50 mm, preferably from 5 mm to 30 mm, and a height of from 1 to 50 μm, preferably from 2 to 20 μm, more preferably from 3 to 10 μm. This may be one-side press or both-side press.

In order to maintain transparent appearance, the haze is preferably from 0.01 to 2%. In order to reduce the haze value, dispersion of the added fine particulate matting agent is conducted enough to reduce the number of aggregated particles, or the matting agent is used only in the skin layer in order to reduce the addition amount.

### (Polarizing Plate)

A polarizing plate includes a polarizer and two sheets of transparent protective film provided on both sides of the polarizer. A cellulose acylate film in the invention can be used as one protective film. Ordinary cellulose acetate films may be used as other protective film. As polarizers, an iodine polarizer, a dye polarizer using two-color dyes and a polyene polarizer are known. Iodine polarizers and dye polarizer are generally manufactured with polyvinyl alcohol films. When a cellulose acylate film in the invention is used as the protective film of a polarizing plate, the manufacturing method of the polarizing plate is not especially restricted and ordinary methods can be used. There is a method of alkali processing an obtained cellulose acylate film, and sticking the film on both sides of a polarizer obtained by immersing and stretching a polyvinyl alcohol film in an iodine solution by using a completely saponified vinyl alcohol aqueous solution. In place of alkali processing, easy adhesion process as disclosed in JP-A-6-94915 and JP-A-6-118232 may be used. As adhesives for use for adhering a protective film and a polarizer, polyvinyl alcohol adhesive, e.g., polyvinyl alcohol and polyvinyl butyral, and vinyl latex, e.g., butyl acrylate are exemplified. A polarizing plate consists of a polarizer and protective films to protect both sides of the polarizer. Further, a protective film is stuck on one side of the polarizing plate, and a separate film on the other. The protective film and separate film are used for the purpose of protecting the polarizing plate at the time of shipping and inspection of the polarizing plate. In this case, the protective film is stuck for the purpose of protecting the surface of the polarizing plate, and the protective film is stuck on the side opposite to the side to be adhered with a liquid crystal plate. The separate film is used for the purpose of covering an adhesive layer to be adhered to a liquid crystal plate, and is adhered to the side of the polarizing plate to be adhered to a liquid crystal plate.

A sticking method of a cellulose acylate film in the invention to a polarizer is preferably such that the polarizer and the cellulose acylate film are stuck so that the transmission axis of the polarizer and the retardation axis of the cellulose acylate film coincide with each other. As a result of evaluation of a polarizing plate manufactured under polarizing plate crossed nicols, it was found that when the crossed accuracy of the retardation axis of the cellulose acylate film and the absorption axis (axis crossed to transmission axis) of the polarizer is greater than 1°, polarizing property under polarizing plate crossed nicols lowers and light missing occurs. In this case, sufficient black level and contrast cannot be obtained by the combination with a liquid crystal cell. Accordingly, it is preferred that the deviation of the direction of the main refractive index nx of a cellulose acylate film in the invention from the direction of the transmission axis of the polarizing plate is 1° or less, more preferably 0.5° or less.

Single plate transmittance TT, parallel transmittance PT and right-angle crossed transmittance CT of a polarizing plate are measured with UV3100PC (manufactured by Shimadzu Corporation). Measurement was performed at wavelength region of from 380 to 780 nm of each of single plate transmittance, parallel transmittance and right-angle crossed transmittance, and an average value of the measurement of 10 times was taken. Durability tests of a polarizing plate were two kinds of (1) a polarizing plate alone, and (2) a polarizing plate adhered to a glass plate with an adhesive. In the measurement of a polarizing plate alone, an optical compensation film was sandwiched between two polarizers, and two same samples were prepared. A sample (about 5 cm×5 cm) of test (2) was prepared by adhering a polarizing plate on a glass plate so that an optical compensation film was on the side of the glass plate, and two same samples were prepared. In the measurement of single plate transmittance, the sample was set with the film side to a light source. Two samples were measured and the average value was taken as single plate transmittance. As preferred ranges of a polarizing property, single plate transmittance TT, parallel transmittance PT and right-angle crossed transmittance CT are respectively 40.0≦TT≦45.0, 30.0≦PT≦40.0, CT≦2.0, and more preferably 41.0≦TT≦44.5, 34≦PT≦39.0, CT≦1.3 (unit is %). In a durability test of a polarizing plate, the variation is preferably as small as possible.

When a polarizing plate in the invention is allowed to stand at 60° C. 95% RH for 500 hours, the variation ΔCT (%) of crossed single plate transmittance and the variation ΔP of polarization degree satisfy at least one of the following equations (a) and (b):

−6.0≦ΔCT≦6.0 (a)

−10.0≦ΔP≦0.0 (b)

Here, the variation means a value obtained by subtracting the measured value before test from the measured value after test.

By satisfying the requisite, stability of the polarizing plate during use or preservation is secured.

### (Moisture-Proofed Bag)

In the invention, “moisture-proofed bag (bag having been subjected to the treatment for imparting moisture-proof properties)” is specified in terms of the moisture permeability measured based on the cup method (JIS-Z208). It is preferred to use a material which has a moisture permeability of 30 g/(m²·Day) at 40° C. and 90% RH or less. When the moisture permeability of the bag exceeds 30 g/(m²·Day), the bag fails to prevent influence of the environmental humidity outside the bag. The moisture permeability is more preferably 10 g/(m²·Day) or less, most preferably 5 g/(m²·Day) or less.

The material of the moisture-proofed bag is not particularly limited as long as it has the above-mentioned level of moisture permeability, and known materials can be used. (See, for example, “Hoso Zairyo Binran” (Shadan Hojin Nihon Hoso Gijutsu Kyokai (1995)); and “Kinosei Hoso Nyumon” (21 Seiki Hoso Kenkyukai, Feb. 28, 2002 (the first edition, first print).) In the invention, materials which have low moisture permeability and a light weight and which are easy to handle are desirable. Composite materials such as films comprising a plastic film having vacuum deposited thereon silica, alumina or a ceramic material and laminate films of a plastic film having laminated thereon an aluminum foil are particularly preferably used. The thickness of the aluminum foil is not particularly limited as long as humidity within the bag does not change depending upon the environmental humidity, and is preferably from several μm to several 100 μm, more preferably from 10 μm to 500 μm. The cellulose acylate film of the invention has such a high retardation value that it undergoes a large change in retardation value when humidity is changed. Since large difference in temperature and humidity between the moisture-conditioned state of the polarizing plate and the state upon sticking of the polarizing plate leads to a serious change in retardation value after sticking of the plate, and hence the difference be preferably smaller. The humidity in a moisture-proofed bag to be used in the invention preferably satisfies either of the following:

43% RH to 70% RH, preferably 45% to 65%, more preferably 45% to 63%, in a state of packaging the polarizing plate; or

the humidity in a state of packaging the polarizing plate is within 15% RH based on the humidity upon sticking the polarizing plate onto a liquid crystal panel.

### (Surface Treatment)

By treating the surface of a cellulose acylate film in the invention, the adhesion of the cellulose acylate film and other functional layers (e.g., an undercoat layer and a backing layer) can be improved. As the surface treatment, e.g., glow discharge treatment, UV irradiation treatment, corona treatment, flame treatment, and acid or alkali treatment can be used. The glow discharge treatment may be low temperature plasma treatment in low-pressure gas of 10⁻³ to 20 Torr, or may be plasma treatment in the atmospheric pressure. Plasma exciting gas is gas capable of plasma excitation under the above condition, e.g., argon, helium, neon, krypton, xenon, nitrogen, carbon dioxide and fluorocarbons, e.g., tetrafluoromethane, and mixtures of these gases are exemplified. These treatments are described in detail in Journal of Technical Disclosure issued by Japan Institute of Invention and Innovation (Journal of Technical Disclosure No. 2001-1745 issued on Mar. 15, 2001, Japan Institute of Invention and Innovation), pp. 30-32. Plasma treatment in the atmospheric pressure now attracting public attention uses irradiation energy of from 20 to 500 kGy at 10 to 1,000 keV, preferably from 20 to 300 kGy at 30 to 500 keV. Alkali saponification treatment is especially preferred for the surface treatment of cellulose acylate film.

Alkali saponification treatment is preferably performed by a method of directly immersing a cellulose acylate film in a saponification solution tank, or a method of coating a saponification solution on a cellulose acylate film.

Dip coating, curtain coating, extrusion coating, bar coating, and E-type coating can be used as coating methods. For coating a saponification on a transparent support, it is preferred that the solvent of an alkali coating solution for saponification treatment has a good wetting property, does not form unevenness on the surface of a transparent support, and is capable of maintaining a good face property. Specifically, alcohol solvents are preferred, and isopropyl alcohol is especially preferred. It is also possible to use an aqueous solution of surfactant as the solvent. The alkali of an alkali saponification coating solution is preferably alkali soluble in the above solvents, and KOH and NaOH are more preferred. The pH of an alkali saponification coating solution is preferably 10 or higher, more preferably 12 or higher. The reaction conditions in alkali saponification are preferably room temperature and from 1 second to 5 minutes, more preferably from 5 seconds to 5 minutes, and especially preferably from 20 seconds to 3 minutes. After alkali saponification reaction, it is preferred that a surface coated with a saponification solution is washed with water, or acid and then water.

### (Antireflection Layer)

It is preferred to provide a functional film, e.g., an antireflection layer, on a transparent protective film of a polarizing plate arranged on the side opposite to the side on which a liquid crystal cell is provided. In particular in the invention, an antireflection layer comprising a light scattering layer and a low refractive index layer on a transparent protective film in this order, or an antireflection layer comprising a middle refractive index layer, a high refractive index layer and a low refractive index layer on a transparent protective film in this order is preferably used. The preferred examples of antireflection layers are described below.

Preferred examples of the antireflection layer comprising a light scattering layer and a low refractive index layer provided on a transparent protective film are described.

Matting particles are dispersed in the light scattering layer in the invention, and the refractive index of the components other than matting particles in the light scattering layer is preferably in the range of from 1.50 to 2.00, and the refractive index of the low refractive index layer is preferably in the range of from 1.35 to 1.49. In the invention, the light scattering layer doubles as glare-proof and hard coat properties, and may comprise one layer, or a plurality of layers, e.g., two to four layers.

As the surface unevenness of the antireflection layer, it is preferred to design to provide central line average roughness Ra of from 0.08 to 0.40 μm, ten point average roughness Rz of 10 times Ra or less, average peak and valley distance Sm of from 1 to 100 μm, the standard deviation of the height of convexity from the deepest point of the unevenness is 0.5 μm or less, the standard deviation of average peak and valley distance Sm with the central line as standard is 20 μm or less, and the surface having inclination angle of from 0 to 5° of 10% or more, whereby sufficient glare-proofing property and uniform matte feeling by visual observation can be achieved.

By making the tint of reflected light under C light source a* value of −2 to 2, a b* value of −3 to 3, and the ratio of the minimum value and the maximum value of the reflectance in the range of from 380 to 780 nm of from 0.5 to 0.99, the tint of reflected light becomes neutral and preferred. Further, by making a b* value of reflected light of from 0 to 3, a yellowish color in white display is reduced when the anti-reflection layer is applied to an image display and preferred.

When a lattice of 120 μm×40 μm is inserted between a surface light source and the antireflection film of the invention and the standard deviation of luminance distribution measured on the film is 20 or less, glare at the time when a film of the invention is applied to a high precision panel is preferably reduced.

When the antireflection layer in the invention has optical characteristics such as mirror reflectivity of 2.5% or less, transmittance of 90% or more, and 60° glossiness of 70% or less, the reflectance of outer light can be restrained and visibility is improved. Mirror reflectivity is more preferably 1% or less, and most preferably 0.5% or less. By making a haze value of from 20 to 50%, the ratio of inside haze value/total haze value of from 0.3 to 1, the reduction of the haze value from the haze value at the time of providing a light scattering layer after the time of providing a low refractive index layer of 15% or less, the visibility of transmitted image at the time of comb breadth of 0.5 mm of from 20 to 50%, and the ratio of transmittance of the transmitted light perpendicular to the antireflection layer and the transmitted light in the direction inclined by 2° from perpendicularity of from 1.5 to 5.0, glare on a high precision LCD panel can be prevented and the reduction of halation of letters and the like can be achieved.

### (Low Refractive Index Layer)

The refractive index of the low refractive index layer of the antireflection film in the invention is preferably from 1.20 to 1.49, more preferably from 1.30 to 1.44. It is preferred for the low refractive index layer to satisfy the following equation (XI) for reducing the refractive index.

(m/4)×0.7<n1d1<(m/4)×1.3 (XI)

In the equation, m represents a positive odd number, n1 represents a refractive index of a low refractive index layer, and d1 represents a layer thickness (nm) of a low refractive index layer. λ is wavelength, which is in the range of from 500 to 550 nm.

The materials for forming the low refractive index layer are described below.

The low refractive index layer in the invention contains a fluorine-containing polymer as the low refractive index binder. As the fluorine polymers, fluorine-containing polymers having a dynamic friction coefficient of from 0.03 to 0.20, a contact angle to water of from 90 to 120°, and capable of crosslinking by heat or ionizing radiation of the falling angle of pure water of 70° or less are preferably used. When the antireflection film of the invention is mounted on an image display, the lower the peeling force from commercially available adhesive tapes, the more easily is the peeling of a sticker, a memo pad and the like after sticking them, preferably 5N or less, more preferably 3N or less, and most preferably 1N or less. Further, the harder the surface hardness measured with a micro-hardness tester, the more hardly scratched is the surface, preferably 0.3 GPa or more, more preferably 0.5 GPa or more.

As the fluorine-containing polymers for use in the low refractive index layer, hydrolyzed products and dehydrated and condensed products of perfluoroalkyl group-containing silane compounds (e.g., (heptadecafluoro-1,1,2,2-tetrahydrodecyl)-triethoxysilane), and fluorine-containing copolymers comprising a fluorine-containing monomer unit and a constitutional unit for providing crosslinking reactivity are exemplified.

The examples of the fluorine-containing monomers include fluoroolefins (e.g., fluoroethylene, vinylidene fluoride, tetrafluoroethylene, perfluorooctylethylene, hexafluoro-propylene, perfluoro-2,2-dimethyl-1,3-dioxole, etc.), partially or completely fluorinated alkyl ester derivatives of (meth)acrylic acid (e.g., Viscoat 6FM (manufactured by Osaka Organic Chemical Industry Ltd.), M-2020 (manufactured by Daikin Industries Ltd.), etc.), and completely or partially fluorinated vinyl ethers, preferably fluoroolefins, and especially preferably hexafluoropropylene for refractive index, solubility, transparency and availability.

As the constitutional units for providing crosslinking reactivity, constitutional units obtainable by the polymerization of monomers having a self-crosslinkable functional group in the molecule in advance, e.g., glycidyl(meth)acrylate and glycidyl vinyl ether, constitutional units obtainable by the polymerization of monomers having a carboxyl group, a hydroxyl group, an amino group, or a sulfo group (e.g., (meth)acrylic acid, methylol (meth)acrylate, hydroxyalkyl(meth)acrylate, allyl acrylate, hydroxyethyl vinyl ether, hydroxybutyl vinyl ether, maleic acid, crotonic acid, etc.), and constitutional units obtained by introducing a cross-linking reactive group such as (meth)acryloyl group to these constitutional units by polymer reaction (e.g., a crosslinking reactive group can be introduced by a technique of reacting acrylic acid chloride to a hydroxyl group) are exemplified.

From the viewpoint of solubility in solvents and for providing transparency to films, besides the above fluorine-containing monomer units and constitutional units for providing crosslinking reactivity, monomers not containing fluorine can also be arbitrarily copolymerized. Monomer units usable in combination are not especially restricted, e.g., olefins (ethylene, propylene, isoprene, vinyl chloride, vinylidene chloride, etc.), acrylates (e.g., methyl acrylate, ethyl acrylate, 2-ethylhexyl acrylate, etc.), methacrylates (e.g., methyl methacrylate, ethyl methacrylate, butyl methacrylate, ethylene glycol dimethacrylate, etc.), styrene derivatives (e.g., styrene, divinylbenzene, vinyltoluene, α-methylstyrene, etc.), vinyl ethers (e.g., methyl vinyl ether, ethyl vinyl ether, cyclohexyl vinyl ether, etc.), vinyl esters (e.g., vinyl acetate, vinyl propionate, vinyl cinnamate, etc.), acrylamides (e.g., N-tert-butylacrylamide, N-cyclohexyl-acrylamide, etc.), methacrylamides, and acrylonitrile derivatives can be exemplified.

Curing agents may be arbitrarily used in these polymers as disclosed in JP-A-10-25388 and JP-A-10-147739.

### (Light Scattering Layer)

A light scattering layer is formed for the purpose of providing light diffusibility by light scattering at the surface and/or light scattering in the inner part, and a hard coat property to improve scratch resistance of the film. Accordingly, the light scattering layer is formed by containing a binder for providing a hard coat property, matting particles for providing light diffusibility and, if necessary, inorganic fillers for increasing refractive index, preventing shrinkage by crosslinking, and increasing strength.

The thickness of the light scattering layer is preferably from 1 to 10 μm, more preferably from 1.2 to 6 μm, from the viewpoints of providing a hard coat property, preventing the generation of curling, and restraining the deterioration of brittleness.

As the binders of the light scattering layer, polymers having a saturated hydrocarbon chain or a polyether chain as the main chain are preferred, and polymers having a saturated hydrocarbon chain as the main chain are more preferred. Further, it is preferred for the binder polymers to have a crosslinking structure. As the binder polymers having a saturated hydrocarbon chain as the main chain, polymers of ethylenic unsaturated monomers are preferred. As the binder polymers having a saturated hydrocarbon chain as the main chain and also having a crosslinking structure, (co)polymers of monomers having two or more ethylenic unsaturated groups are preferred. For making the binder polymers high refractive index, it is effective to use monomers having at least one kind of atom selected from a halogen atom other than a fluorine atom, a sulfur atom, a phosphorus atom, and a nitrogen atom.

The examples of the monomers having two or more ethylenic unsaturated groups include esters of polyhydric alcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)-acrylate, pentaerythritol tri(meth)acrylate, trimethylol-propane tri(meth)acrylate, trimethylolethane tri(meth)-acrylate, dipentaerythritol tetra(meth)acrylate, dipenta-erythritol penta(meth)acrylate, dipentaerythritol hexa-(meth)acrylate, pentaerythritol hexa(meth)acrylate, 1,2,3-cyclohexane tetra(meth)acrylate, polyurethane polyacrylate, and polyester polyacrylate), ethylene oxide-modified products of the above monomers, vinylbenzene and derivatives thereof (e.g., 1,4-divinylbenzene, 4-vinylbenzoic acid-2-acryloyl-ethyl ester, and 1,4-divinylcyclohexanone), vinyl sulfone (e.g., divinyl sulfone), acrylamide (e.g., methylenebis-acrylamide), and methacrylamide. These monomers may be used in combination of two or more kinds.

As the specific examples of high refractive index monomers, bis(4-methacryloylthiophenyl) sulfide, vinyl-naphthalene, vinylphenyl sulfide, and 4-methacryloxyphenyl-4-methoxyphenyl thioether are exemplified. These monomers may also be used in combination of two or more kinds.

Polymerization of these monomers having an ethylenic unsaturated group can be performed by irradiation with ionizing radiation or heating in the presence of a photo-radical polymerization initiator or a thermal radical polymerization initiator.

Accordingly, an antireflection film can be formed by preparing a coating solution containing a monomer having an ethylenic unsaturated group, a photo-radical polymerization initiator or a thermal radical polymerization initiator, matting particles and an inorganic filler, coating the coating solution on a transparent support, and then performing polymerization reaction by irradiation with ionizing radiation or heating to thereby cure the coated layer. Well-known photo-radical polymerization initiators can be used.

As polymers having a polyether chain as the main chain, ring opening polymers of polyfunctional epoxy compounds are preferred. Ring opening polymerization of a polyfunctional epoxy compound can be effected by irradiation with ionizing radiation or by heating in the presence of a photo-acid generator or a heat-acid generator.

Accordingly, an antireflection film can be formed by preparing a coating solution containing a polyfunctional epoxy compound, a photo-acid generator or a heat-acid generator, matting particles and an inorganic filler, coating the coating solution on a transparent support, and then performing polymerization reaction with ionizing radiation or heating to thereby cure the coated layer.

In place of or in addition to a monomer having two or more ethylenic unsaturated groups, crosslinkable functional groups may be introduced into a polymer by using a monomer having crosslinkable functional groups, and a crosslinking structure may be introduced to a binder polymer by the reaction of the crosslinkable functional groups.

The examples of the crosslinkable functional groups include an isocyanate group, an epoxy group, an aziridine group, an oxazoline group, an aldehyde group, a carbonyl group, a hydrazine group, a carboxyl group, a methylol group and an active methylene group. Vinylsulfonic acid, acid anhydride, cyano acrylate derivative, melamine, etherified methylol, ester and urethane, and metal alkoxide, such as tetramethoxy-silane, can also be used as monomers for introducing a crosslinking structure. A functional group showing a crosslinking property as a result of decomposition reaction, such as a block isocyanate group, can also be used as a crosslinkable functional group. That is, in the invention, crosslinkable functional groups may be those that show reactivity as a result of decomposition even if they do not show reactivity at once.

By coating binder polymers having these crosslinkable functional groups and then heating, a crosslinking structure can be formed.

For the purpose of imparting a glare-proof property, matting particles having an average particle size of from 1 to 10 μm, preferably from 1.5 to 7.0 μm, which are greater than filler particles, e.g., particles of inorganic compounds or resin particles, are contained in a light scattering layer.

As the specific examples of the matting particles, such as particles of inorganic compounds, e.g., silica particles and TiO₂ particles, and resin particles, e.g., acrylic particles, crosslinked acrylic particles, polystyrene particles, crosslinked styrene particles, melamine resin particles, and benzoguanamine resin particles are preferably exemplified. Of these particles, crosslinked styrene particles, crosslinked acrylic particles, crosslinked acrylstyrene particles, and silica particles are preferred. The matting particles may be spherical or amorphous.

Further, two or more matting particles each having different particle size may be used together. It is possible to give a glare-proof property by larger size matting particles and give other optical properties by smaller size matting particles.

The particle size distribution of the matting particles is most preferably monodispersion. The particle sizes of all the particles are preferably equivalent as far as possible. Taking the particles having particle sizes greater than the average particle size by 20% or more as coarse particles, the proportion of the coarse particles is preferably 1% or less of all the particle number, more preferably 0.1% or less, and still more preferably 0.01% or less. Matting particles having such particle size distribution are obtained by classification after ordinary synthesizing reaction. By increasing the number of times of classification or raising the degree of classification, matting particles having more preferred particle size distribution can be obtained.

The matting particles are added so that the amount contained in a formed light scattering layer is preferably from 10 to 1,000 mg/m², more preferably from 100 to 700 mg/m².

The particle size distribution of matting particles is measured with a coulter counter method and the measured particle size distribution is converted to particle number distribution.

For increasing the refractive index of the layer, it is preferred to add an inorganic filler to the light scattering layer in addition to the matting particles. For example, inorganic fillers comprising at least one oxide of metal selected from titanium, zirconium, aluminum, indium, zinc, tin and antimony, and having an average particle size of 0.2 μm or less, preferably 0.1 μm or less, and more preferably 0.06 g/m or less are preferably used.

Contrary to this, in a light scattering layer containing high refractive index matting particles for the purpose of increasing the refractive index difference between the matting particles, it is also preferred to use a silicon oxide for maintaining the refractive index of the layer lowish. The preferred particle size is the same as that of the above inorganic fillers.

The specific examples of the inorganic fillers for use in a light scattering layer include TiO₂, ZrO₂, Al₂O₃, In₂O₃, ZnO, SnO₂, Sb₂O₃, ITO and SiO₂. TiO₂ and ZrO₂ are especially preferred for increasing a refractive index. It is also preferred for the surfaces of inorganic fillers to be treated with a silane coupling agent or a titanium coupling agent, and surface treating agents having functional groups capable of reacting with the binder are preferably used on the surfaces of fillers.

The addition amount of these inorganic fillers is preferably from 10 to 90% of the entire mass of the light scattering layer, more preferably from 20 to 80%, and especially preferably from 30 to 75%.

These particle sizes of these fillers are sufficiently smaller than the wavelength of light, so that light scattering does not occur and a dispersion comprising a binder polymer having dispersed therein these fillers behaves as an optically uniform material.

The total refractive index of the mixture of a binder and an inorganic filler in a light scattering layer in the invention is preferably from 1.48 to 2.00, more preferably from 1.50 to 1.80. The above range of refractive index can be reached by the selection of the ratio of the kind and amount of the binder and the inorganic filler. The selection can be easily known experimentally in advance.

For securing uniform face properties, e.g., resistance to coating unevenness, drying unevenness and point defects, a light scattering layer contains surfactants, e.g., fluorine surfactants or silicone surfactants, or both of them, in a coating composition for forming a glare-proof layer. Fluorine surfactants are especially preferably used for the reason that fluorine surfactants have the effect of improving face defects such as coating unevenness, drying unevenness and point defects of the antireflection film of the invention with a smaller addition amount. The object of the addition of fluorine surfactants is to increase productivity by high speed coating aptitude while increasing the uniformity of face property.

In the next place, an antireflection layer comprising a transparent protective film having laminated thereon a middle refractive index layer, a high refractive index layer, and a low refractive index layer in this order is described below.

An antireflection layer comprising a layer constitution of a substrate having thereon at least a middle refractive index layer, a high refractive index layer, and a low refractive index layer (the outermost layer) in this order is designed so as to have refractive indexes satisfying the relationship shown below.

The refractive index of a high refractive index layer> the refractive index of a middle refractive index layer > the refractive index of a transparent support> the refractive index of a low refractive index layer.

A hard coat layer may be provided between a transparent support and a middle refractive index layer. Further, the antireflection layer may comprise a middle refractive index hard coat layer, a high refractive index layer, and a low refractive index layer. (Refer to JP-A-8-122504, JP-A-8-110401, JP-A-10-300902, JP-A-2002-243906 and JP-A-2000-111706.) Each layer may have other function and as such examples, e.g., an antifouling low refractive index layer and an antistatic high refractive index layer (e.g., JP-A-10-206603 and JP-A-2002-243906) are exemplified.

The haze value of an antireflection layer is preferably 5% or less, more preferably 3% or less. The film strength is preferably H or higher by a pencil hardness test according to JIS K5400, more preferably 2H or higher, and most preferably 3H or higher.

### (High Refractive Index Layer and Middle Refractive Index Layer)

A layer having a high refractive index of an antireflection film comprises a hard film containing at least super fine particles of a high refractive index inorganic compound having an average particle size of 100 nm or less and a matrix binder.

As the inorganic compound fine particles having a high refractive index, inorganic compounds having a refractive index of 1.65 or more, preferably a refractive index of 1.9 or more, are exemplified. For example, oxides of Ti, Zn, Sb, Sn, Zr, Ce, Ta, La, In, etc., and compound oxides containing these metal atoms are exemplified.

For obtaining such super fine particles, treating the surfaces of particles with a surface treating agent (e.g., with a silane coupling agent as disclosed in JP-A-11-295503, JP-A-11-153703 and JP-A-2000-9908, with an anionic compound or an organic metal coupling agent as disclosed in JP-A-2001-310432), taking a core/shell structure with high refractive index particles as core (JP-A-2001-166104 and JP-A-2001-310432), and using a specific dispersant in combination (JP-A-11-153703, U.S. Pat. No. 6,210,858 and JP-A-2002-2776069) are exemplified.

As the materials forming the matrix, well-known thermoplastic resins and thermosetting resins are exemplified.

Further, at least one kind of composition selected from a composition containing a polyfunctional compound having at least two polymerizable groups of radical polymerizable and/or cationic polymerizable groups, and a composition containing an organic metal compound having a hydrolyzable group and a partial condensation product of the compound is preferred. For example, the compositions disclosed in JP-A-2000-47004, JP-A-2001-315242, JP-A-2001-31871 and JP-A-2001-296401 are exemplified.

Further, cured films obtainable from colloidal metal oxide obtained from hydrolyzed and condensed products of metal alkoxide and metal alkoxide composition are also preferred, as disclosed, e.g., in JP-A-2001-293818.

The refractive index of a high refractive index layer is generally from 1.70 to 2.20. The thickness of a high refractive index layer is preferably from 5 nm to 10 μm, more preferably from 10 nm to 1 μm.

The refractive index of a middle refractive index layer is adjusted to be between the refractive index of a low refractive index layer and the refractive index of a high refractive index layer. The refractive index of a middle refractive index layer is preferably from 1.50 to 1.70. The thickness of a middle refractive index layer is preferably from 5 nm to 10 μm, more preferably from 10 nm to 1 μm.

### (Low Refractive Index Layer)

A low refractive index layer is laminated on a high refractive index layer. The refractive index of a low refractive index layer is from 1.20 to 1.55, preferably from 1.30 to 1.50.

A low refractive index layer is preferably formed as the outermost layer having scratch resistance and an antifouling property. As a means to conspicuously improve scratch resistance, it is effective to provide a sliding property to the surface, and providing a thin layer comprising the introduction of well-known silicone and the introduction of fluorine can be applied as this means.

The refractive index of the fluorine-containing compounds is preferably from 1.35 to 1.50, more preferably from 1.36 to 1.47. As the fluorine-containing compounds, compounds having crosslinkable or polymerizable functional groups containing fluorine atoms from 35 to 80 mass % are preferred.

For example, as such compounds, the compounds disclosed in JP-A-9-222503, paragraphs (0018) to (0026), JP-A-11-38202, paragraphs (0019) to (0030), JP-A-2001-40284, paragraphs (0027) and (0028), and JP-A-2000-284102 are exemplified.

Silicone compounds are compounds having a polysiloxane structure, and those having a curable functional group or a polymerizable functional group in the polymer chain, and a crosslinking structure in the film are preferred. For example, reactive silicone (e.g., Silaplane, manufactured by Chisso Corporation), and polysiloxane containing silanol groups at both terminals (e.g., JP-A-11-258403) are exemplified.

It is preferred that the crosslinking reaction or polymerization reaction of fluorine-containing and/or siloxane polymers having a crosslinkable group or a polymerizable group is performed simultaneously with or immediately after coating a coating composition containing a polymerization initiator and a sensitizer for forming the outermost layer with light irradiation or heating.

A cured film by sol gel conversion of curing by condensation reaction of an organic metal compound such as a silane coupling agent and a silane coupling agent containing a specific fluorine-containing hydrocarbon in the presence of a catalyst is also preferred.

For example, polyfluoroalkyl group-containing silane compound or partially hydrolysis condensates of the compound (the compounds disclosed in JP-A-58-142958, JP-A-58-147483, JP-A-58-147484, JP-A-9-157582 and JP-A-11-106704), and silyl compounds containing a poly(perfluoroalkyl ether) group, i.e., a fluorine-containing long chain group (the compounds disclosed in JP-A-2000-117902, JP-A-2001-48590 and JP-A-2002-53804) are exemplified.

Besides the above additives, a low refractive index layer can contain low refractive index inorganic compounds having an average particle size of primary particles of from 1 to 150 nm such as fillers (e.g., silicon dioxide (silica)), fluorine-containing particles (e.g., magnesium fluoride, calcium fluoride, barium fluoride), the organic fine particles disclosed in JP-A-11-3820, paragraphs from (0020) to (0038), silane coupling agents, sliding agents and surfactants.

When a low refractive index layer is formed as the lower layer of the outermost layer, the low refractive index layer may be formed by gaseous phase methods (e.g., a vacuum deposition method, a sputtering method, an ion plating method, a plasma CVD method). Coating methods are preferred in the point of capable of manufacturing inexpensively.

The thickness of a low refractive index layer is preferably from 30 to 200 nm, more preferably from 50 to 150 nm, and most preferably from 60 to 120 nm.

Further, a hard coat layer, a forward scattering layer, a primer layer, an antistatic layer, an undercoat layer and a protective layer may be provided.

### (Hard Coat Layer)

A hard coat layer is provided on the surface of a transparent support for the purpose of giving physical strength to a transparent protective film having provided an antireflection layer. It is particularly preferred to provide a hard coat layer between a transparent support and a high refractive index layer. A hard coat layer is preferably provided by a crosslinking reaction or a polymerization reaction of a photo- and/or thermo-curable compound. As the curable functional groups, photo-polymerizable functional groups are preferred, and as the organic metal compounds containing a hydrolysis decomposable functional group, organic alkoxysilyl compounds are preferred.

The specific examples of these compounds, the same compounds as shown in the high refractive index layer can be exemplified. The specific constitutional compositions of a hard coat layer are disclosed, e.g., in JP-A-2002-144913, JP-A-2000-9908 and WO 00/46617.

A high refractive index layer can double as a hard coat layer. When a high refractive index layer doubles as a hard coat layer, it is preferred to form the hard coat layer by adding fine particles to the hard coat layer as fine dispersion according to the method as described in the high refractive index layer.

A hard coat layer can double as a glare-proof layer (described later) having a glare-proof function by containing particles having an average particle size of from 0.2 to 10 μm.

The thickness of a hard coat layer can be appropriately designed according to purposes. The thickness of a hard coat layer is preferably from 0.2 to 10 μm, more preferably from 0.5 to 7 μm.

The strength of a hard coat layer is preferably H or higher by a pencil hardness test according to JIS K5400, more preferably 2H or higher, and most preferably 3H or higher. In a taper test according to JIS K5400, the abrasion loss of a sample piece before and after the test is preferably as small as possible.

### (Antistatic Layer)

When an antistatic layer is provided, it is preferred to give electric conductivity of volume resistivity of 10⁻⁸ (Ωcm⁻³) or less. It is possible to provide volume resistivity of 10⁻⁸ (Ωcm⁻³) or less by the use of moisture-absorbing materials, water-soluble inorganic salts, certain kinds of surfactants, cationic polymers, anionic polymers and colloidal silica, but there is a problem that the temperature and moisture-dependency is great and sufficient electric conductivity cannot be obtained at low moisture. Therefore, metal oxides are preferred as the electric conductive materials. There are colored metal oxides, but when such colored metal oxides are used as electric conductive materials, the film at large is colored, so that not preferred. As the metals forming metal oxides not colored, Zn, Ti, Al, In, Si, Mg, Ba, Mo, W and V can be exemplified, and it is preferred to use metal oxides comprising these metals as the main component.

As the specific examples, ZnO, TiO₂, SnO₂, Al₂O₃, In₂O₃, SiO₂, MgO, BaO, MoO3, V₂O₅, or compound oxides of them are preferred, and ZnO, TiO₂ and SnO₂ are especially preferred. As the examples containing other kinds of atoms, e.g., the addition of Al and In to ZnO, Sb, Nb and halogen atoms to SnO₂, and Nb and TA to TiO₂ are effective. Further, as disclosed in JP-B-59-6235, materials obtained by adhering the above metal oxides to other crystalline metal particles or fibrous substances (e.g., titanium oxide) may be used.

Although a volume resistive value and a surface resistive value are different physical values and they cannot be easily compared, for securing electric conductivity of volume resistivity of 10⁻⁸ (Ωcm⁻³) or less, it is sufficient that the electric conductive layer has in general a surface resistive value of 10⁻¹⁰ (Ω/□) or less, more preferably 10⁻⁸ (Ω/□) or less. It is necessary that the surface resistive value of an electric conductive layer is measured as the value of the time with an antistatic layer as the outermost layer, and this value can be measured in the midway of forming the lamination film described in this specification.

### (Liquid Crystal Display)

The cellulose acylate film, an optical compensation sheet comprising the film, and a polarizing plate using the film can be used in various liquid crystal cells of display modes and liquid crystal displays, and various display modes are proposed, e.g., TN (Twisted Nematic), IPS (In-Plane Switching), FLC (Ferroelectric Liquid Crystals), AFLC (Anti-Ferroelectric Liquid Crystal), OCB (Optically Compensatory Bend), STN (Super Twisted Nematic), VA (Vertical Alignment), and HAN (Hybrid Aligned Nematic). Of these modes, the optics of the invention can be preferably used for OCB mode or VA mode, most preferably used for VA mode.

OCB mode liquid crystal cell is a liquid crystal display using liquid crystal cell of bend orientation mode of orientating rod-like liquid crystal molecules substantially reverse directions (symmetrically) at the upper and lower of the liquid crystal cell, and disclosed in U.S. Pat. Nos. 4,583,825 and 5,410,422. Since rod-like liquid crystal molecules are orientated symmetrically at the upper and lower of the liquid crystal cell, the liquid crystal cell of bend orientation mode has a self-optical compensation function. Therefore, this liquid crystal mode is also called OCB (Optically Compensatory Bend) liquid crystal mode. The liquid crystal display of bend orientation mode has the advantage that response speed is quick.

In VA mode liquid crystal cell, rod-like liquid crystal molecules are substantially perpendicularly orientated when no voltage is applied.

VA mode liquid crystal cell includes (1) VA mode liquid crystal cell in a narrow sense of substantially perpendicularly orientating rod-like liquid crystal molecules when no voltage is applied, and substantially horizontally orientating when voltage is applied (e.g., JP-A-2-176625), (2) liquid crystal cell having multi-domains of VA mode (MVA mode) for widening angle of visibility (SID97, described in Digest of Tech. Papers, (drafts) 28, 845 (1997)), (3) liquid crystal cell of a mode of substantially perpendicularly orientating rod-like liquid crystal molecules when no voltage is applied, and twisted multi-domain orientating when voltage is applied (n-ASM mode) (described in the drafts of Liquid Crystal Forum, Japan, 58-59 (1998)), and (4) SURVIVAL mode liquid crystal cell (released at LCD International 98).

VA mode liquid crystal display comprises a liquid crystal cell and two sheets of polarizing plates arranged both sides of the liquid crystal cell. The liquid crystal cell carries liquid crystal between two electrodes. In one embodiment of a transmission type liquid crystal display of the invention, one sheet of optical compensation sheet of the invention is arranged between the liquid crystal cell and one polarizing plate, or two sheets of optical compensation sheets are arranged between the liquid crystal cell and two polarizing plates.

In another embodiment of a transmission type liquid crystal display of the invention, an optical compensation sheet comprising cellulose acylate film of the invention is used as the transparent protective film of the polarizing plates arranged between the liquid crystal cell and the polarizer. The optical compensation sheet may be used as the protective film of the polarizing plate of only one side (the polarizing plate between the liquid crystal cell and the polarizer), or may be used for two sheets of transparent protective films of both polarizing plates (the polarizing plates between the liquid crystal cell and the polarizer). When the optical compensation sheet is used for the polarizing plate of only one side, it is particularly preferred to use the sheet as the protective film of the liquid crystal cell side of the polarizing plate on the back light side of the liquid crystal cell. It is preferred in sticking to make the cellulose acylate film of the invention on VA cell side. Protective film may be ordinary cellulose acylate films, but preferably thinner than the cellulose acylate film of the invention. For example, a thickness of from 40 to 80 μm is preferred, and commercially available KC4UX2M (40 μm, manufactured by Konica Opto, Inc.), KC5UX (60 μm, manufactured by Konica Opto Co.), and TD80 (80 μm, manufactured by Fuji Photo Film Co., Ltd.) are exemplified, but the invention is not limited thereto.

### EXAMPLES

It was intended to prepare a film having a high Re value and a high Rth value wherein the in-plane retardation Re(λ) is 40≦Re(590)≦200, the retardation in the thickness thickness Rth(λ) is 70≦Rth₍590)≦350.

The invention will be specifically described below by reference to examples which, however, are not to be construed as limiting the invention.

### (Measuring Method)

Various properties of the cellulose acylate film were measured according to the following methods. (Retardation value, Re and Rth)

These were calculated according to the methods described in the specification of the invention.

### (Water Content)

A 7 mm×35 mm sample was conditioned at 25° C. and 80% RH for 2 hours, and then its water content was measured by means of an apparatus for measuring a very small quantity of water according to Karl Fischer's method, LE-20S (manufactured by Hiranuma Sangyo Co., Ltd.). The amount (g) of water in the sample was divided by the weight (g) of the sample to calculate the water content. RSA was used as an anode solution, and CN was used as a cathode solution.

### (Stretching Temperature)

The temperature of film surface was measured in the stretching step using a radiation thermometer (for a thin film).

### (Thermal Shrinkage Ratio)

A 30 mm×120 mm sample was kept at 25° C. and 60% RH for 2 hours, 6-mmφ holes were punched on both sides at 100 mm intervals, and the original length (L1) between the holes was measured to the minimum division of 1/1000 mm using an automatic pin gauge (manufactured by Shinto Kagaku K.K.). Further, the sample was allowed to sand for 24 hours at 60° C. and 90% RH or at 90° C. and 3% RH, and again kept at 25° C. and 60% RH for 2 hours, followed by measuring the length (L²) between the holes. The thermal shrinkage ratio was determined according to the formula of {(L1-L²)/L1}×100.

### (Glass Transition Temperature Tg)

A 5 mm×30 mm film sample (non-stretched) was conditioned at 25° C. and 60% RH for 2 hours or longer, and measurement was conducted using a dynamic viscoelasticity measuring device (Vibron DVA-225 (manufactured by IT Keisoku Seigyo K.K.) with a grip-to-grip distance of 20 mm, a temperature-raising rate of 2° C./min, a measuring temperature range of from 30° C. to 200° C. and a frequency of 1 Hz. The data were plotted, with storage modulus of elasticity as logarithmic ordinate and temperature (° C.) as linear abscissa. With a sharp reduction in storage modulus of elasticity observed when the film sample moves from a solid region to a glass transition region, a line 1 was drawn in the solid region, and a line 2 was drawn in the glass transition region. An intersection point of lines 1 and 2 corresponds to the temperature at which the storage elasticity of modulus sharply decreases upon increasing temperature and the film initiates to soften and at which the film initiates to migrate to the glass transition region. Thus, the temperature was taken as the glass transition temperature Tg (dynamic viscoelasticity).

### (Modulus of Elasticity)

A 10 mm×200 mm sample was conditioned at 25° C. and 60% RH for 2 hours, and measurement was conducted with an initial sample length of 100 mm and drawing speed of 100 mm/min using a tensile tester (Strograph-R2 manufactured by Toyo Seiki). Modulus of elasticity was calculated from the stress and elongation at initial-stage drawing.

### (Change in Weight)

A 100 mm×100 mm sample was cut out, and weight change thereof was measured while the sample was allowed to stand for 48 hours under the thermostatic condition of 80° C. and 90% RH. Measurement was conducted after conditioning the sample at 25° C. and 60% RH for 2 hours before and after the thermostatic condition.

### (Optical Elasticity Coefficient)

A tensile stress was applied to a 10 mm×100 mm film sample in the longitudinal direction, and Re retardation of the film was measured thereupon using an elipsometer (M150; manufactured by Nihon Bunko K.K.). The optical elasticity coefficient was calculated from the variation amount of retardation for the stress.

### (Haze)

Haze of a 40 mm×80 mm sample was measured at 25 C and 60% RH according to JIS K6714 using a haze meter (HGM-2DP; manufactured by SUGA TEST INSTRUMENTS CO., LTD.).

### Example 1

### Formation of Cellulose Acylate Film

### (1) Cellulose Acylate

Cellulose acylates having different acyl substitution degrees as described in Table 1 were prepared. The acylation reaction was conducted by adding sulfuric acid (7.8 parts by mass per 100 parts by mass of cellulose) as a catalyst and carboxylic acids and heating to 40° C. Thereafter, the total substitution degree and the 6-position substitution degree were adjusted by adjusting the amount of sulfuric acid catalyst, the amount of water and the ripening time. The ripening temperature was 40° C. Further, low molecular components of the cellulose acylate were removed by washing with acetone.

TABLE 1

| | | | | | 6-Position |
|---|---|---|---|---|---|
| | Acetyl | Propionyl | Butyryl | 6-Position | Substitution |
| Raw | Substi- | Substi- | Substi- | Substi- | Degree/Total |
| Cotton | tution | tution | tution | tution | Substitution |
| No. | Degree | Degree | Degree | Degree | Degree |
| CA1 | 1.920 | 0.000 | 0.000 | 0.601 | 0.313 |
| CA2 | 1.429 | 0.701 | 0.234 | 0.947 | 0.396 |
| CA3 | 2.785 | 0.000 | 0.000 | 0.910 | 0.327 |
| CA4 | 2.753 | 0.000 | 0.000 | 0.903 | 0.328 |
| CA5 | 2.745 | 0.000 | 0.000 | 0.882 | 0.321 |
| CA6 | 1.952 | 0.808 | 0.000 | 0.897 | 0.325 |
| CA7 | 0.998 | 0.625 | 0.000 | 0.887 | 0.547 |
| CA8 | 2.794 | 0.000 | 1.700 | 0.902 | 0.323 |

The total substitution degree is a sum of acyl substitution degrees at 2-, 3- and 6-positions, respectively. Also, the total substitution degree equals to the value calculated by adding the acetyl substitution degree and the propionyl substitution degree.

### (2) Preparation of Dope

### <1-1> Cellulose Acylate Solution

The following composition was placed in a mixing tank and stirred to dissolve the components. Further, after heating for about 10 minutes at 90° C., the solution was filtered through a filter paper of 34 μm in average pore size and a sintered metal filter of 10 μm in average pore size.

(Cellulose acylate solution)

| | | |
|---|---|---|
| Cellulose acylate described in Table 1 | 100.0 | parts by mass (weight) |
| Triphenyl phosphate | 8.0 | parts by mass |
| Biphenyldiphenyl phosphate | 4.0 | parts by mass |
| Methylene chloride | 403.0 | parts by mass |
| Methanol | 60.2 | parts by mass |

### <1-2> Matting Agent Dispersion

Then, the following composition containing the cellulose acylate solution prepared in the above-described manner was placed in a dispersing machine to prepare a matting agent dispersion.

(Matting agent dispersion)

| | | |
|---|---|---|
| Silica particles of 16 nm in average | 2.0 | parts by mass |
| particle size (aerosol R972; manu- | | |
| factured by Nippon Aerosil Co., Ltd.) | | |
| Methylene chloride | 72.4 | parts by mass |
| Methanol | 10.8 | parts by mass |
| Cellulose acylate solution | 10.3 | parts by mass |

### <1-3> Retardation Increasing Agent Solution A

Then, the following composition containing the cellulose acylate solution prepared in the above-described manner was placed in a mixing tank, followed by stirring under heating to dissolve. Thus, a retardation increasing agent solution A was prepared.

(Retardation increasing agent solution A)

| | | |
|---|---|---|
| Retardation increasing agent A | 20.0 | parts by mass |
| Methylene chloride | 58.3 | parts by mass |
| Methanol | 8.7 | parts by mass |
| Cellulose acylate solution | 12.8 | parts by mass |

100 Parts by mass of the above-mentioned cellulose acylate solution, 1.35 parts by mass of the matting agent dispersion and, further, the retardation increasing agent solution A were mixed so that the proportion thereof became that shown in Table 2 to thereby prepare a dope for forming a film. The dopes were used for preparing films F1 to F5 and F8 to F14, respectively.

Retardation increasing agent A

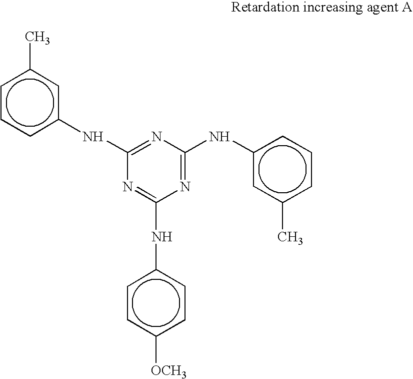

<1-4> Retardation increasing agent solution B

Then, the following composition containing the cellulose acylate solution prepared in the above-described manner was placed in a mixing tank, followed by stirring under heating to dissolve. Thus, a retardation increasing agent solution B was prepared.

(Retardation increasing agent solution B)

| | | |
|---|---|---|
| Retardation increasing agent A | 8.0 | parts by mass |
| Retardation increasing agent B | 12.0 | parts by mass |
| Methylene chloride | 58.3 | parts by mass |
| Methanol | 8.7 | parts by mass |
| Cellulose acylate solution | 12.8 | parts by mass |

100 Parts by mass of the above-mentioned cellulose acylate solution, 1.35 parts by mass of the matting agent dispersion and, further, the retardation increasing agent solution B were mixed so that the proportion thereof became that shown in Table 2 to thereby prepare a dope for forming a film. The dopes were used for preparing films F6 and F7, respectively.

The addition proportion of the retardation increasing agent is shown in Table 2 in terms of parts by mass per 100 parts by mass of cellulose acylate. Viscosity of each dope at 33° C. is also shown in Table 2.

### Retardation Increasing Agent B

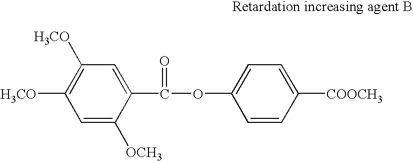

### (Casting)

Each dope was cast using a band casting machine. The content of volatile components contained in the film at the initiation of stretching step can be varied by adjusting process conditions upon casting such as temperature, humidity and amount of air. As is shown in Table 2, the content of volatile components of each of F1 to F 11 was within the range of from 0 mass % to 30 mass %, whereas the content was 30 mass % or more with F12 to F15.

In a tenter, the film was stretched in a transverse direction while applying thereto a hot air to dry, and then shrunk about 5%. Subsequently, the tenter conveyance of the film was shifted to roll conveyance, and the film was further dried and subjected to knurling, followed by winding up with a width of 1500 mm. The stretching ratio is shown in Table 2 in terms of a value calculated from the film width at the inlet of the tenter and the film width at the outlet of the tenter. With the thus-prepared cellulose acylate films (optical compensatory sheets), Re retardation value and Rth retardation value at a wavelength of 590 nm were measured at 25° C. and 60% RH using KOBRA 21ADH (Ohji Measurement Co., Ltd.).

TABLE 2

| | | | | | | Content of | |
|---|---|---|---|---|---|---|---|
| | | | Addition | | | Volatile | |
| | | Retardation | Amount of | | | Components | |
| | | increasing | Retardation | | | Upon | Average |
| | Raw | Agent | increasing | Stretching | | Initiation of | Film |
| Film | Cotton | Solution | Agent | Temperature | Stretching | Stretching | Thickness |
| No. | No. | Used | (mass %) | (° C.) | Ratio (%) | Step (mass %) | (μm) |
| F1 | CA6 | A | 3.0 | 150 | 35 | 15 | 90 |
| F2 | CA3 | A | 5.0 | 145 | 30 | 26 | 40 |
| F3 | CA3 | A | 5.0 | 145 | 25 | 21 | 75 |
| F4 | CA3 | B | 5.0 | 155 | 23 | 14 | 65 |
| F5 | CA8 | A | 4.0 | 142 | 31 | 25 | 75 |
| F6 | CA4 | A | 6.5 | 140 | 16 | 29 | 92 |
| F7 | CA2 | A | 8.0 | 150 | 29 | 5 | 20 |
| F8 | CA6 | A | 6.0 | 165 | 25 | 0 | 50 |
| F9 | CA2 | A | 6.0 | 150 | 28 | 5 | 30 |
| F10 | CA5 | A | 6.5 | 160 | 33 | 9 | 70 |
| F11 | CA3 | A | 5.0 | 170 | 25 | 0 | 95 |
| F12 | CA7 | A | 3.0 | 125 | 23 | 42 | 50 |
| F13 | CA1 | A | 2.0 | 130 | 10 | 35 | 40 |
| F14 | CA3 | B | 6.5 | 130 | 20 | 40 | 70 |
| F15 | CA3 | A | 6.5 | 105 | 25 | 52 | 75 |

| | | | | Re | Rth | | |
|---|---|---|---|---|---|---|---|
| | | | Water | Variation | Variation | | |
| Film | Re | Rth | Content | Ratio | Ratio | | |
| No. | (nm) | (nm) | (%) | (%) | (%) | Haze | Note |
| F1 | 41 | 200 | 2.1 | 15 | 12 | 0.4 | Example |
| F2 | 43 | 205 | 2.6 | 18 | 16 | 0.8 | Example |
| F3 | 62 | 220 | 2.3 | 17 | 14 | 0.7 | Example |
| F4 | 64 | 210 | 2.1 | 15 | 11 | 0.4 | Example |
| F5 | 60 | 210 | 2.5 | 17 | 13 | 0.7 | Example |
| F6 | 55 | 180 | 2.8 | 18 | 15 | 0.8 | Example |
| F7 | 52 | 182 | 1.8 | 13 | 11 | 0.3 | Example |
| F8 | 59 | 201 | 1.7 | 13 | 10 | 0.2 | Example |
| F9 | 60 | 190 | 1.8 | 13 | 11 | 0.3 | Example |
| F10 | 80 | 260 | 2 | 14 | 10 | 0.4 | Example |
| F11 | 74 | 256 | 1.6 | 11 | 10 | 0.2 | Example |
| F12 | 36 | 150 | 3.4 | 26 | 23 | 1.5 | Comparative |
| | | | | | | | Example |
| F13 | 32 | 146 | 3.6 | 20 | 18 | 1.2 | Comparative |
| | | | | | | | Example |
| F14 | 43 | 195 | 3.2 | 22 | 18 | 1.3 | Comparative |
| | | | | | | | Example |
| F15 | 22 | 128 | 3.6 | 25 | 21 | 2.0 | Comparative |
| | | | | | | | Example |

*Re variation ratio = (Re₍₅₉₀₎10% RH—Re₍₅₉₀₎80% RH) × 100/Re₍₅₉₀₎60% RH
Rth variation ratio = (Rth₍₅₉₀₎10% RH—Rth₍₅₉₀₎80% RH) × 100/Rth₍₅₉₀₎60% RH

As is shown in Table 2, it is seen that samples F1 to F11 according to the invention acquired a higher retardation value than comparative samples F12 to F15 in spite of their smaller thickness.

Also, in comparison with the comparative samples, the samples of the invention showed less Re variation ratio and less Rth variation ratio, and are therefore found to be films which difficulty suffer change in performance by changes of ambient conditions. Further, every sample of the invention was found to have a haze value as low as 0.8% or less which is less than that of the comparative samples.

The glass transition temperature (Tg) of the formed films were between 138° C. and 147° C. Also, water transmittance at 60° C. and 95% RH for 24 hours thereof was from 800 to 2,000 g/m²/day. Further, the secondary average particle size of the matting agent in these films was 1.0 μm or less, the tensile modulus of elasticity thereof was 4 GPa or more, and weight change when allowed to stand at −80° C. and 90% RH for 48 hours was from 0 to 3%. Dimensional change when allowed to stand at 60° C. and 90% RH or at 90° C. and 3% RH for 24 hours was from −1.2 to 0.2%. Further, every sample had an optical elasticity coefficient of 50×10⁻¹³ cm²/dyn (5×10⁻¹¹ m²/N) or less.

### Example 2

### 2-1-1>

### (Preparation of Polarizing Plate-1)

A polarizer was prepared by adsorbing iodine into a stretched polyvinyl alcohol film.

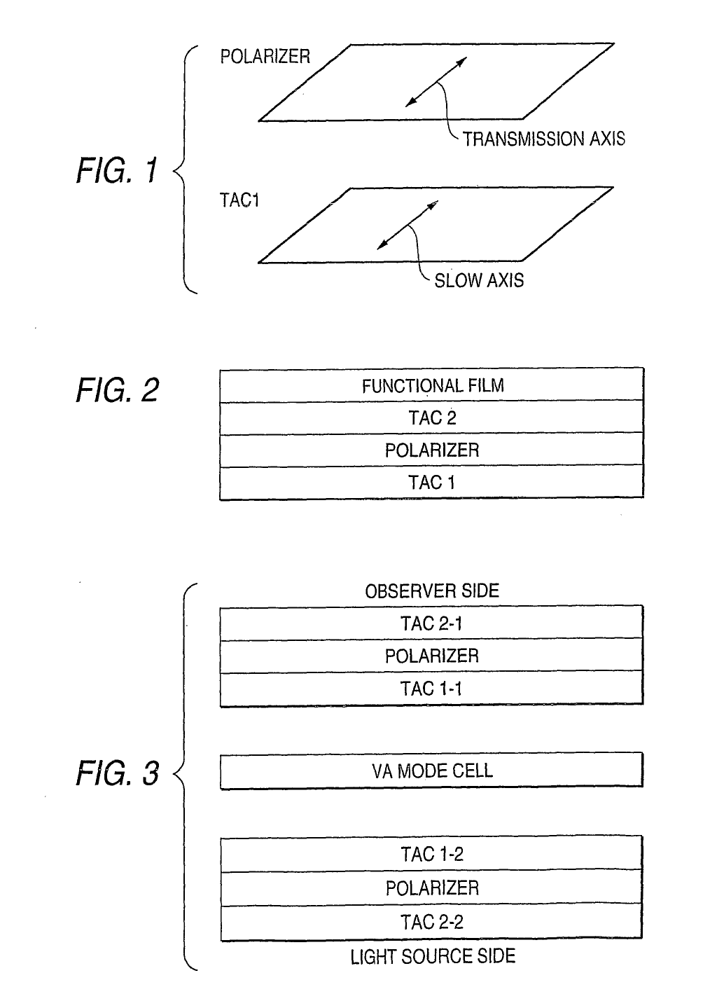

The cellulose acylate film (F1 to F15; corresponding to TAC1 in FIGS. 1 and 2 or TAC1-1 or TAC1-2 in FIG. 3) prepared in Example 1 was stuck onto one side of the polarizer using a polyvinyl alcohol series adhesive. Additionally, saponification treatment was conducted under the following conditions.

A 1.5N sodium hydroxide aqueous solution was prepared and kept at 55° C. A 0.01N dilute sulfuric acid aqueous solution was prepared and kept at 35° C. The prepared cellulose acylate film was dipped in the sodium hydroxide aqueous solution for 2 minutes, and then in water to sufficiently wash away the sodium hydroxide aqueous solution. Subsequently, the film was dipped in the dilute sulfuric acid aqueous solution for 1 minute, and then in water to sufficiently wash away the dilute sulfuric acid aqueous solution. Finally, the sample film was sufficiently dried at 120° C.

A commercially available cellulose triacylate film (Fuji TAC TD80UF; manufactured by Fuji Photo Film Co., Ltd.; corresponding to functional film TAC2 in FIG. 2, or TAC2-1 or 2-2 in FIG. 3) was subjected to the saponification treatment, and then stuck to the opposite side of the polarizer using a polyvinyl alcohol series adhesive, followed by drying at 70° C. for 10 minutes.

The polarizer and the cellulose acylate film were disposed so that the transmission axis of the polarizer became parallel to the transverse direction of the cellulose acylate film prepared in Example 1 (FIG. 1). The commercially available cellulose triacylate film was disposed so that the transmission axis became parallel to the transverse direction of the commercially available cellulose triacylate film.

The single plate transmittance TT, parallel transmittance PT and right-angle crossed transmittance (CT) of the polarizing plate were measured at 380 nm to 780 nm using a spectrophotometer (UV3100PC) with combining so that the cellulose acylate film prepared in Example 1 was disposed inside of the polarizer. The values obtained between 400 and 700 nm were averaged. Thus, TT, PT and CT were found to be 40.8 to 44.7, 34 to 38.8 and 1.0 or less, respectively. Also, in the durability test on the polarizing plate conducted at 60° C. and 95% RH for 500 hours, the variation fell within the range of −0.1≦ΔCT≦0.2 and −2.0≦ΔP≦0 and, in the durability test at 60° C. and 90% RH, −0.05≦ΔCT≦0.15 and −1.5≦ΔP≦0.

One of each of the thus-prepared polarizing plates A1 to A15 (optical compensatory films in the form of FIG. 2 except for the functional film not being provided) was stored directly in a moisture-proofed bag, and the other one was stored in a moisture-proofed bag after conditioning at 25° C. and 60% RH for 2 hours. The moisture-proofed bags were packaging members having a laminated structure of polyethylene terephthalate/aluminum/polyethylene and had a water vapor permeability of 0.01 mg/m² (24 hours) or less.

<2-2-1>

### (Preparation of a Coating Solution for Forming a Light Scattering Layer)

50 g of a mixture of pentaerythritol triacrylate and pentaerythritol tetraacrylate (PETA; manufactured by Nippon Kayaku) was diluted with 38.5 g of toluene. Further, 2 g of a polymerization initiator (Irgacure 184; manufactured by Ciba Specialty Chemicals) was added thereto, and the mixture was stirred. A coat film obtained by coating this solution and curing by UV rays had a refractive index of 1.51.

Further, to this solution were added 1.7 g of a 30% toluene dispersion of cross-linked polystyrene particles (refractive index: 1.60; SX-350; manufactured by Soken Kagaku K.K.) of 3.5 μm in average particle size and 13.3 g of a 30% toluene dispersion of cross-linked acryl-styrene particles (refractive index: 1.55; manufactured by Soken Kagaku K.K.) of 3.5 μm in average particle size, having been dispersed for 20 minutes in a polytron dispersing machine at 10,000 rpm. Finally, 0.75 g of a fluorine-containing surface modifier (FP-1) and 10 g of a silane coupling agent (KBM-5103; manufactured by Shin-Etsu Chemical Co., Ltd.) were added thereto to prepare a complete solution.

The resultant mixed solution was filtered through a polypropylene-made filter of 30 μm in pore size to prepare a coating solution for forming an optical scattering layer.

<2-2-2>

### (Preparation of a Coating Solution for Forming a Low Refractive Index Layer)

First, a sol solution a was prepared in the following manner. To a reaction vessel equipped with a stirrer and a reflux condenser were added 120 parts of methyl ethyl ketone, 100 parts of acryloyloxypropyltrimethoxysilane (KBM5103; manufactured by Shin-Etsu Chemical Co., Ltd.) and 3 parts-of diisopropoxyaluminum ethyl acetoacetate and, after mixing, 30 parts of ion-deionized water was added, followed by reacting at 60° C. for 4 hours. The reaction mixture was cooled to room temperature to obtain a sol solution a. The weight-average molecular weight was 1600 and, of the oligomer components and components having a larger molecular weight, components of 1,000 to 20,000 in molecular weight accounted for 100%. Also, analysis by gas chromatography revealed that absolutely no starting acryloyloxypropyltrimethoxysilane remained. 13 g of a thermally cross-linkable, fluorine-containing polymer (JN-7228; solid content: 6%; manufactured by JSR) having a refractive index of 1.42, 1.3 g of silica sol (silica; same as MEK-ST except for particle size; average particle size: 45 nm; solid content: 30%; manufactured by Nissan Kagaku K.K.), 0.6 g of the above-described sol solution a, 5 g of methyl ethyl ketone and 0.6 g of cyclohexanone were mixed and, after stirring, filtered through a polypropylene-made filter of 1 μm in pore size to thereby prepare a coating solution for forming a low refractive index layer.

<2-2-3>

### (Preparation of a Transparent Protective Film 01 Having a Light Scattering Layer)

A 80-μm thick triacetyl cellulose film (FUJI TAC TD80UF; manufactured by Fuji Photo Film Co., Ltd.) was wound off from a roll, and the coating solution forming the functional layer (light scattering layer) was coated thereon under the conditions of 30 rpm in gravure roll rotation number and 30 m/min in conveying speed using a gravure roll of 50 mm in diameter having a gravure pattern of 180 lines/inch and 40 μm in depth and using a doctor blade. After drying at 60° C. for 150 seconds, the coated layer was cured by irradiating with UV rays with a illuminance of 400 mW/cm² and an irradiation amount of 250 mJ/cm² using a 160 W/cm air-cooled metal halide lamp (manufactured by EYEGRAPHICS Co., Ltd.) while purging with nitrogen. Thus, a 6-μm thick functional layer was formed and wound up.

The triacetyl cellulose film having provided thereon the functional layer (light scattering layer) was again wound off, and the above-prepared coating solution for forming a low refractive index layer was coated on the light scattering layer-coated side of the film under the conditions of 30 rpm in gravure roll rotation number and 15 ml/min in conveying speed using a gravure roll of 50 mm in diameter having a gravure pattern of 180 lines/inch and 40 μm in depth and using a doctor blade. After drying at 120° C. for 150 seconds then at 140° C. for 8 minutes, the coated layer was cured by irradiating with UV rays with a illuminance of 400 mW/cm² and an irradiation amount of 900 mJ/cm² using a 240 W/cm air-cooled metal halide lamp (manufactured by EYEGRAPHICS Co., Ltd.) while purging with nitrogen. Thus, a 100-nm thick low refractive index layer was formed and wound up (corresponding to the functional film TAC2 in FIG. 2 or TAC2-1 in FIG. 3).

<2-3-1>

### (Preparation of Polarizing Plate-2)

A polarizer was prepared by adsorbing iodine into a stretched polyvinyl alcohol film.

The prepared transparent protective film 01 having a light scattering layer was subjected to the same saponification treatment as is described in <2-1-1>, and then the functional film-free side of the protective film 01 was stuck to one side of the polarizer using a polyvinyl alcohol series adhesive.

The transparent protective film 01 with a light scattering layer prepared in <2-2-3> and a 80-μm thick triacetyl cellulose film (FUJI TAC TD80UF; manufactured by Fuji Photo Film Co., Ltd.) not having the functional layer were subjected to the same saponification treatment as described hereinbefore, and each of them was stuck onto the opposite side of the polarizer, followed by drying at 70° C. for 10 minutes or longer.

The polarizer and the cellulose acylate film were disposed so that the transmission axis of the polarizer became parallel to the transverse direction of the cellulose acylate film prepared in <2-2-3> (FIG. 1). The polarizer and the transparent protective film 01 with a light scattering layer were disposed so that the transmission axis of the polarizer became parallel to the transverse direction of the protective film 01. As in preparation of polarizing plate <2-1-1>, one sample was placed in a moisture-proofed bag after conditioning the sample at 25° C. and 60% RH and the other sample was placed without conditioning.

The spectral reflectance with an incident angle of 5° was measured from the functional film side in the range of from 380 to 780 nm using a spectrophotometer (manufactured by Nihon Bunko K.K.). The integrating sphere-average reflectance in the range of from 450 to 650 nm was determined to be 2.3%.

<2-4-1>

### (Preparation of a Coating Solution for Forming a Hard Coat Layer)

To 750.0 parts by mass of trimethylolpropane triacrylate (TMPTA; manufactured by Nippon Kayaku) were added 270.0 parts by mass of poly(glycidyl methacrylate) having a weight-average molecular weight of 3,000, 730.0 g of methyl ethyl ketone, 500.0 g of cyclohexanone and 50.0 g of a photo polymerization initiator (Irgacure 184; Nihon Ciba Geigy K.K.), and the mixture was stirred. The mixture was then filtered through a polypropylene-made filter of 0.4 μm in pore size to prepare a coating solution for forming a hard coat layer.

<2-4-2>

### (Preparation of a Dispersion of Titanium Dioxide Fine Particles)

As titanium dioxide fine particles, titanium dioxide fine particles (MPT-129; manufactured by Ishihara Sangyo K.K.) containing cobalt and having been subjected to surface treatment with aluminum hydroxide and zirconium hydroxide were used.

To 257.1 g of the particles were added 38.6 g of the following dispersing agent and 704.3 g of cyclohexanone, followed by dispersing in a dynomil to thereby prepare a dispersion of titanium dioxide of 70 nm in weight-average size.

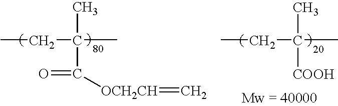

### (Preparation of a Coating Solution for Forming a Middle Refractive Index Layer)

To 88.9 g of the titanium dioxide dispersion were added 58.4 g of a mixture of dipentaerythritol pentaacrylate and dipentaerythritol hexaacrylate (DPHA), 3.1 g of a photo polymerization initiator (Irgacure 907), 1.1 g of a photo sensitizer (Kayacure DETX; manufactured by Nippon Kayaku), 482.4 g of methyl ethyl ketone and 1869.8 g of cyclohexanone, followed by stirring. After sufficient stirring, the solution was filtered through a polypropylene-made filter of 0.4 μm in pore size to thereby prepare a coating solution for forming a middle index layer.

<2-4-4>

### (Preparation of a Coating Solution for Forming a High Refractive Index Layer)

To 586.8 g of the titanium dioxide dispersion were added 47.9 g of a mixture of dipentaerythritol pentaacrylate and dipentaerythritol hexaacrylate (DPHA), 4.0 g of a photo polymerization initiator (Irgacure 907), 1.3 g of a photo sensitizer (Kayacure DETX; manufactured by Nippon Kayaku), 455.8 g of methyl ethyl ketone and 1427.8 g of cyclohexanone, followed by stirring. The solution was filtered through a polypropylene-made filter of 0.4 μm in pore size to thereby-prepare a coating solution for forming a high index layer.

### (Preparation of a Coating Solution for Forming a Low Refractive Index Layer)

A copolymer of the following structure was dissolved in methyl isobutyl ketone so that the concentration became 7 mass %, and 3 mass %, based on solid components, of a terminal methacrylate group-containing silicone resin X-22-164C (Shin-Etsu Chemical Co., Ltd.) and 5 mass %, based on solid components, of a photo radical generator Irgacure 907 (trade name) were added thereto to thereby prepare a coating solution for forming a low refractive index layer.

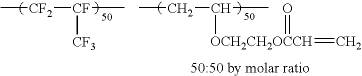

<2-4-6>

### (Preparation of Transparent Protective Film 02 Having an Antireflection Layer)

On a 80-μm thick triacetyl cellulose film (FUJI TAC TD80UF; manufactured by Fuji Photo Film Co., Ltd.) was coated a coating solution forming a hard coat layer using a gravure coater. After drying at 100° C., the coated layer was cured by irradiating with UV rays with a illuminance of 400 mW/cm² and an irradiation amount of 300 mJ/cm² using a 160 W/cm air-cooled metal halide lamp (manufactured by EYEGRAPHICS Co., Ltd.) while purging with nitrogen so that the oxygen concentration in the atmosphere became 1.0% by volume or less. Thus, a 8-μm thick hard coat layer was formed.

On the hard coat layer were consecutively coated the coating solution for forming a middle refractive index layer, the high refractive index layer and the low refractive index layer using a gravure coater having three coating stations.

The drying conditions for the middle refractive index layer were 100° C. and 2 minutes, and curing with UV rays was conducted under the conditions of 400 mW/cm² in illuminance and 400 mJ/cm² in irradiation amount using a 180 W/cm air-cooled metal halide lamp (manufactured by EYEGRAPHICS Co., Ltd.) while purging with nitrogen so that the oxygen concentration in the atmosphere became 1.0% by volume or less. After curing, the middle refractive index layer had a refractive index of 1.630 and a film thickness of 67 nm.

The drying conditions for the high refractive index layer and the low refractive index layer were 90° C. and 1 minutes, then 100° C. and 1 minute. Curing with UV rays was conducted under the conditions of 600 mW/cm² in illuminance and 600 mJ/cm² in irradiation amount using a 240 W/cm air-cooled metal halide lamp (manufactured by EYEGRAPHICS Co., Ltd.) while purging with nitrogen so that the oxygen concentration in the atmosphere became 1.0% by volume or less. After curing, the high refractive index layer had a refractive index of 1.905 and a film thickness of 107 nm, and the low refractive index layer had a refractive index of 1.440 and a film thickness of 85 nm. Thus, there was prepared a transparent protective film 02 having an antireflection layer (corresponding to the functional film TAC2 shown in FIG. 2 or TAC2-1 in FIG. 3).

<2-5-1>

### (Preparation of Polarizing Plate-3)

Polarizing plates (C1 to C14; polarizing plates wherein a functional film and an optical compensatory film are integrated (FIG. 2)) in the same manner as in <2-3-1> except for using the transparent protective film 02 having a antireflection layer in place of the transparent protective film 01 having a light scattering layer. Likewise, a polarizing plate (CO) comprising the transparent protective film 02 having the antireflection layer, the polarizer and a 80-μm thick triacetyl cellulose film (FUJI TAC TD80UF; manufactured by Fuji Photo Film Co., Ltd.) not having the functional layer was prepared. The integrating sphere-average reflectance in the range of from 450 to 650 nm was determined to be 0.4%.

### Example 3

### Mounting on a Panel

### Example 3-1

### Mounting on a VA Panel

### (One-Sheet Type)

A liquid crystal display shown in FIG. 3 was prepared. That is, the upper polarizing plate (TAC2-1 (having/not having the functional film), the polarizer, TAC1-1), a VA mode liquid crystal cell and the lower polarizing plate (TAC1-2, the polarizer, TAC2-2) were disposed in this order from the viewing direction (from above). Further, a backlight source was disposed.

### <Preparation of Liquid Crystal Cell>

A liquid crystal cell was prepared by adjusting the cell gap between the substrates to 3.6 μm, dropwise injecting a liquid crystal material having a negative dielectric anisotropy (C6608, manufactured by Merck), and sealing the cell to thereby form a liquid crystal layer between substrates. The retardation of the liquid crystal layer (i.e., the product of the thickness d (μm) and the refractive index anisotropy Δn, Δn•d) was adjusted to 300 nm. Additionally, the liquid crystal material was vertically aligned.

As the upper polarizing plate (on the viewer's side) in a liquid crystal display (FIG. 3) using the above-described vertically aligned liquid crystal cell, a commercially available super-high contrast product (e.g., HLC2-5618 manufactured by Sanritz CCorp.) was used. As the lower polarizing plate (on the backlight side), polarizing plates (A1 to A5, A7 to A9, A11 to A12) prepared in Example 2, <2-1-1>, using the optical compensatory sheets F1 to F5, F7 to F9, F11 to F12 prepared in Example 1 were disposed so that the cellulose acylate film (corresponding to TAC1-2 in FIG. 3) prepared in Example 1 faced the liquid crystal cell side. The upper polarizing plate and the lower polarizing plate were stuck onto the liquid crystal cell using an adhesive. They were disposed in a cross-Nicol position so that the transmission axis of the upper polarizing plate was in the vertical direction and the transmission axis of the lower polarizing plate was in the horizontal direction. As the polarizing plates to be used, two polarizing plates were prepared for each plate: one polarizing plate had been stored in a sealed moisture-proofed bag after being conditioned at 25 C and 60% RH for 2 hours; and the other polarizing plate had been stored in a sealed moisture-proofed bag without conditioning. The liquid crystal displays were prepared by using the thus-conditioned polarizing plates and the non-conditioned polarizing plates.

Additionally, although a commercially available product was used as the upper polarizing plate and the integrated polarizing plate of the invention as the lower polarizing plate, observation of the thus-prepared liquid crystal displays revealed that neutral black display was realized in both the frontal direction and the viewing angle direction. Also, viewing angle (a range wherein a contrast ratio of 10 or more is obtained and gradation reversal on the black side does not take place) was measured in 8 grades of from black display (L1) to white display (L8) using a measuring machine (EZ-Contrast 160D; manufactured by ELDIM).

Next, tint of black display in the direction of 45 ° in azimuth angle with respect to the horizontal direction of the liquid crystal display screen or in the direction of 600° in polar angle with respect to the direction of the normal of the screen surface was measured using a measuring machine (EZ-Contrast 160D; manufactured by ELDIM), and the obtained values were taken as initial values. Then, the panel was left for 1 week in a room of ordinary temperature and ordinary humidity (about 25° C. and 60% RH without controlling humidity), and again tint upon black display was measured. Also, the panel was left for 1 week at 25° C. and 10% RH, and then the tint upon black display was measured. Further, the same panel was left for 1 week at 25° C. and 10% RH, and then the tint upon black display was measured.

As a result of viewing the thus-prepared liquid crystal display, it was found that neutral black display was realized in both the front direction and the viewing angle direction. Viewing angle and tint change were measured, and the results are shown in Table 3.

### Example 3-2

Onto the lower polarizing plate of the liquid crystal display (FIG. 3) using the above vertically aligned liquid crystal cell was stuck the polarizing plates (A1 to A5, A7 to A9, A11 to A12) prepared in Example 2, <2-1-1>, using the optical compensatory sheets F1 to F5, F7 to F9, F11 to F12 prepared in Example 1 and, onto the upper polarizing plate was stuck the polarizing plate (B0) prepared in Example 2, <2-3-1>, through an adhesive. They were disposed in a cross-Nicol position so that the transmission axis of the polarizing plate on the viewer's side was in the vertical direction and the transmission axis of the polarizing plate on the backlight side was in the horizontal direction. In this occasion, the working room was air-conditioned so that that the temperature was in the range of from 20 to 25° C. and the humidity was in the range of from 50 to 70% RH. As the polarizing plates to be used, two polarizing plates were prepared for each plate: one polarizing plate had been stored in a sealed moisture-proofed bag after being conditioned at 25° C. and 60% RH for 2 hours; and the other polarizing plate had been stored in a sealed moisture-proofed bag without conditioning. The liquid crystal displays were prepared by using the thus-conditioned polarizing plates and the non-conditioned polarizing plates.

As a result of viewing the thus-prepared liquid crystal display, it was found that neutral black display was realized in both the frontal direction and the viewing angle direction. Viewing angle and tint change were also measured in the same manner as in Example 3-1, and the results are shown in Table 3.

### Example 3-3

Onto the lower polarizing plate of the liquid crystal display (FIG. 3) using the same vertically aligned liquid crystal cell as in Example 3-1 except for changing the cell gap to 4.2 mm and adjusting the Δn·value to 350 nm was stuck the polarizing plates (A13 to A14) prepared in Example 2, <2-1-1>, using the optical compensatory sheets F13 to F14 prepared in Example 1. Onto the upper polarizing plate was stuck the polarizing plate (C0) prepared in Example 2, <2-5-1>, through an adhesive. They were disposed in a cross-Nicol position so that the transmission axis of the polarizing plate on the viewer's side was in the vertical direction and the transmission axis of the polarizing plate on the backlight side was in the horizontal direction. In this occasion, the working room was air-conditioned so that that the temperature was in the range of from 20 to 25° C. and the humidity was in the range of from 50 to 70% RH. As the polarizing plates to be used, two polarizing plates were prepared for each plate: one polarizing plate had been stored in a sealed moisture-proofed bag after being conditioned at 25° C. and 60% RH for 2 hours; and the other polarizing plate had been stored in a sealed moisture-proofed bag without conditioning. The liquid crystal displays were prepared by using the thus-conditioned polarizing plates and the non-conditioned polarizing plates.

As a result of viewing the thus-prepared liquid crystal display, it was found that neutral black display was realized in both the frontal direction and the viewing angle direction. Viewing angle and tint change were also measured in the same manner as in Example 3-1, and the results are shown in Table 3.

### Comparative Example 3-1

The same procedures as in Example 3-1 were conducted except for changing the lower polarizing plate of Example 3-1 to A6, B6, A10 or B10. Additionally, the polarizing plates used here were not conditioned. Viewing angle and tint change were measured in the same manner as in Example 3-1, and the results are shown in Table 3.

TABLE 3

| | | Black Tint Change (ΔE*) | | | |
|---|---|---|---|---|---|
| | Viewing | 1 Week After Assembly | | | |
| | Angle | Direction | | | |
| | Direction | of 45° | | | |
| Liquid | of Trans- | From Trans- | | | |
| crystal | mission | mission | 25° C., | 25° C., | 25 C., |
| display | Axis | Axis | 60% | 10% | 80% |
| Example | >80° | >80° | Without | 0.015 | 0.017 |
| 3-1 | | | conditioning: | | |
| | | | 0.010-0.013; | | |
| | | | With | — | |
| | | | Conditioning: | | |
| | | | 0.002 | | |
| Example | ″ | ″ | Without | 0.015 | ″ |
| 3-2 | | | conditioning: | | |
| | | | 0.010-0.013; | | |
| | | | With | | |
| | | | Conditioning: | | |
| | | | 0.002 | | |
| Example | ″ | ″ | Without | ″ | ″ |
| 3-3 | | | conditioning: | | |
| | | | 0.010-0.013; | | |
| | | | With | | |
| | | | Conditioning: | | |
| | | | 0.002 | | |
| Compar- | ″ | <50 | Without | 0.038 | 0.052 |
| ative | | | Conditioning: | | |
| Example | | | 0.020-0.032 | | |
| 3-1 | | | | | |

*Data at 25 C. and 10% and at 25 C. and 80% are data upon using a polarizing plate not having previously been conditioned.

In table 3, each sample of Examples 3-1 to 3-3 of the invention had a sufficiently wide viewing angle and stability of tint with time and, thus, it was found that they are remarkably excellent in this point.

When the same investigation was conducted with an OCB mode liquid crystal display as with the VA mode liquid crystal display, remarkable advantages were observed with respect to viewing angle and tint change.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application Nos. JP2005-67904, JP2005-226791 and JP2005-365123, filed Mar. 10, Aug. 4 and Dec. 19 of 2005, respectively, the contents of which are incorporated herein by reference.

1. A method for producing a cellulose acylate film, comprising:
casting a cellulose acylate solution onto a support to form a cellulose acylate film;
peeling the cellulose acylate film from the support; and
stretching the cellulose acylate film,
wherein the cellulose acylate film in the stretching has a temperature of 140 to 250° C.

2. The method for producing a cellulose acylate film according to claim 1, wherein an amount of a solvent remaining in the cellulose acylate film upon initiation of the stretching is from 0 to 30 mass %.

3. The method for producing a cellulose acylate film according to claim 1, wherein the stretching is performed at a stretch ratio of from 1.01:1 to 3:1.

4. A cellulose acylate film produced by a method according to claim 1.

5. The cellulose acylate film according to claim 4, which satisfies:
40≦Re₍₅₉₀₎≦200; and
70≦Rth₍₅₉₀₎≦350,
wherein Re_{(λ)} represents a retardation in a plane of the cellulose acylate film at wavelength λ; Rth_{(λ)} represents a retardation in a direction perpendicular to the plane at wavelength λ.

6. The cellulose acylate film according to claim 4, which has a water content of 0 to 2.8 mass % after being conditioned at 25° C. and 80% RH for 2 hours.

7. The cellulose acylate film according to claim 4, which satisfies formulae (V) and (VI):
0<(Re₍₅₉₀₎10% RH−Re₍₅₉₀₎80% RH)×100/Re₍₅₉₀₎60% RH<20 (V)
0<(Rth₍₅₉₀₎10% RH−Rth₍₅₉₀₎80% RH)×100/Rth₍₅₉₀₎60% RH<20 (VI)
wherein Re₍₅₉₀₎10% RH, Re₍₅₉₀₎60% RH and Re₍₅₉₀₎80% RH represent Re₍₅₉₀₎ at 25° C. and 10% RH, Re₍₅₉₀₎ at 25° C. and 60% RH and Re₍₅₉₀₎ at 25° C. and 80% RH, respectively;
Rth₍₅₉₀₎10% RH, Rth₍₅₉₀₎60% RH and Rth₍₅₉₀₎80% RH represent Rth₍₅₉₀₎ at 25° C. and 10% RH, Rth₍₅₉₀₎ at 25° C. and 60% RH and Rth₍₅₉₀₎ at 25° C. and 80% RH, respectively; and
Re_{(λ)} represents a retardation in a plane of the cellulose acylate film at wavelength λ, and Rth_{(λ)} represents a retardation in a direction perpendicular to the plane at wavelength λ.

8. The cellulose acylate film according to claim 4, which has a haze value of 0 to 1.0%.

9. The cellulose acylate film according to claim 4, which comprises a mixed fatty acid ester of cellulose in which a hydroxyl group of the cellulose is substituted with an acetyl group or an acyl group containing 3 or more carbon atoms, the cellulose acylate film satisfying formulae (I) and (II):
2.0≦A+B≦3.0 (I)
0≦B (II)
wherein A represents a substitution degree of the hydroxyl group by the acetyl group, and B represents a substitution degree of the hydroxyl group by the acyl group containing 3 or more carbon atoms.

10. The cellulose acylate film according to claim 9, wherein the acyl group is a butanoyl group.

11. The cellulose acylate film according to claim 9, wherein the acyl group is a propionyl group, and the substitution degree B is 0.6 or more.

12. The cellulose acylate film according to claim 9, which comprises cellulose acylate in which a hydroxyl group of a glucose unit in the cellulose acylate is substituted with an acyl group containing 2 or more carbon atoms, the cellulose acylate film satisfying formulae (III) and (IV):
2.0≦DS2+DS3+DS6≦2.85 (III)
DS6/(DS2+DS3+DS6)≦0.315 (IV)
wherein DS2 represents a substitution degree of the hydroxyl group at 2-position of the glucose unit by the acyl group, DS3 represents the substitution degree of hydroxyl group at 3-position of the glucose unit by the acyl group, and DS6 represents a substitution degree of the hydroxyl group at 6-position of the glucose unit by the acyl group.

13. The cellulose acylate film according to claim 4, which comprises a retardation increasing agent.

14. The cellulose acylate film according to claim 4, which has a content of the retardation increasing agent of from 0 mass % to 10 mass % with respect to the cellulose acylate of 100 mass %.

15. The cellulose acylate film as described in claim 4, which comprises at least one of a plasticizer, a UV absorber and a peeling accelerator.

16. The cellulose acylate film according to claim 4, which has a thickness of 20 to 110 μm.

17. A retardation film comprising a cellulose acylate film according to claim 4.

18. A polarizing plate comprising: a polarizer; and a protective film of a cellulose acylate film according to claim 4.

19. The polarizing plate according to claim 18, wherein the protective film has at least one of a hard coat layer, a glare-reducing layer and an antireflection layer.

20. The polarizing plate according to claim 18, which is packaged in a moisture-proofed bag having an inner humidity of 43% RH to 70% RH at 25° C.

21. The polarizing plate according to claim 18, which is packaged in a moisture-proofed bag having an inner humidity within 15% RH with respect to an ambient humidity in sticking the polarizing plate to a liquid crystal panel.

22. A liquid crystal display comprising a cellulose acylate film according to claim 4.

23. The liquid crystal display according to claim 22, which is of VA mode.

24. The liquid crystal display according to claim 22, which is of VA mode and includes only one cellulose acylate film.

25. The liquid crystal display according to claim 22, which is of VA mode, wherein at least one of the cellulose acylate film and the polarizing plate is between a liquid crystal cell and a backlight.
